(19) United States
(12) Patent Application Publication
(10) Pub. No.: US 2026/0287111 A1
(43) Pub. Date: Sep. 24, 2026

(54) SUPPORT ASSEMBLIES AND COMPONENTS FOR SUCH ASSEMBLIES

(71) Applicant: Archi Enterprises Inc., North Vancouver (CA)

(72) Inventors: Christian Alexander LeBlanc, Vancouver (CA); Michael Foster, Vancouver (CA)

(73) Assignee: Archi Enterprises Inc., North Vancouver, BC (CA)

(21) Appl. No.: 19/683,517

(22) Filed: May 20, 2026

Related U.S. Application Data
(63) Continuation-in-part of application No. 18/955,208, filed on Nov. 21, 2024.

(51) Int. Cl. F16M 11/04; F16M 11/08; F16M 11/20; F16M 11/24; F16M 11/42

(52) U.S. Cl. CPC F16M 11/046; F16M 11/08; F16M 11/2014; F16M 11/24; F16M 11/42; F16M 11/425

(57) ABSTRACT

An assembly includes a vertical adjustment assembly comprising one or more vertical posts and a device mount assembly comprising one or more arms fastened to the one or more vertical posts and configured for mounting a device to the vertical adjustment assembly. The assembly further includes a turntable having at least a portion rotatable relative to the vertical adjustment assembly. The one or more arms are height-adjustable relative to the ground to allow the device mount assembly to be vertically repositioned. In some embodiments, the assembly further comprises a horizontal base, wheels, diagonal supporting members, one or more connectors for fastening the one or more arms to the one or more vertical posts, one or more extension members, legs extending from a cylindrical mount component, and feet connected to ends of the legs.

### TECHNICAL FIELD

The present disclosure relates to the field of support assemblies and components for such assemblies. In particular, the present disclosure relates to modular stand components, track components, track roller components, turntable components, and pulley components for demountable engagement into various configurations of track, dolly, and/or stand assemblies for use in operation and/or conveyance of devices such as cameras, lighting equipment, sound recording equipment, audio/visual equipment, sensors, robotic gimbals, robotic arms, power tools, and other equipment.

### BACKGROUND

Support apparatuses of various types are required in every industry and range in both size and complexity in order to meet the specific needs of a particular industry or worksite. Irrespective of the industry, most support apparatuses are designed to have a single function. Consequently, a variety of apparatuses are required to meet various needs.

The film and video production industry is one example of such an industry requiring various specialized support apparatuses. Techniques in production including cinematography, videography, lighting, sound capture, and motion capture, for example, depend on a wide range of support apparatuses that provide technicians with the means to do their work. Additionally, given the regularly changing worksites of film and video productions, ease of portability is essential.

Various types of support apparatuses are available and widely used. Some commonly used apparatuses include, for example, jibs or cranes which allow for vertical and sideways movement from low to high angles. Various types of dollies ranging in size from large to more compact allow for smooth rolling movements along the ground or on track assemblies. Sliders which are essentially a condensed, mountable version of a dolly on a supported track also provide smooth movement along a straight path.

Each type of support apparatus is designed to allow cameras and other devices to reach certain angles and/or to perform specific motions, often with consideration of the potential challenges or limitations that may exist in various working locations. The versatility of each type of support apparatus is therefore limited and often results in the need to employ multiple apparatuses depending on the work requirements despite being often for generally similar functions.

Although current technologies attempt to address limitations in portability configurability of support apparatuses, in various industries there continues to be a need for apparatuses that are easy to transport and to assemble, while also offering functional versatility.

### SUMMARY

The present disclosure generally relates to support assemblies and apparatuses for engagement, manipulation, and operation of devices such as cameras, lighting equipment, sound recording equipment, audio/visual equipment, sensors, robotic gimbals, robotic arms, power tools, and other equipment. More specifically, according to some embodiments of the disclosure, components may be assembled into support apparatuses for providing stable and moveable engagement of various devices having a range of operational requirements and which may be for temporary use on a worksite or location, wherein the apparatuses can be configured and quickly assembled by interconnecting and securely engaging a plurality of modular structural support components along with a selection of modules designed for mounting, moving, and operating of various devices and equipment. The support apparatuses may comprise dolly assemblies with wheels or track roller assemblies for controlled movement along straight or curved track assemblies. After the need for a support apparatus is completed on a worksite or location, it can be quickly and easily disassembled into the individual modular elements that can be collected for transport or storage.

Some embodiments of the present disclosure relate to dolly apparatuses comprising a turntable base and rollers or wheels for rolling along the ground or on track assemblies. Track roller assemblies are configured for engagement along cylindrical rails or square rails or rectangular rails of various track assemblies which may comprise a single or parallel pair of elongate rail components of a type, or a single series or two parallel series of elongate rail components of a type assembled end to end where extended travelling distance on a track assembly is required. A track assembly may be supported by a base comprising a plurality of cylindrical structural components and other components such as weight components as well as foot components or wheel components on which the track assembly can be adjustably levelled.

According to some embodiments, the turntable dolly base may be upwardly engaged by a vertical track assembly for vertical motion or a vertical adjustment assembly for static vertical positioning of a device mount assembly whereon various devices or equipment may be demountably engaged. A vertical track assembly may comprise pulley components for controlling movement of roller carriage assemblies and supported device mount components along vertical rails of the vertical track assembly. The weight of the supported equipment, mount assembly and its supporting roller carriage(s) may be nearly or equally matched at the opposite end of the pulley assembly's cable by a roller carriage with demountable weight components so that the assemblies and supported equipment will remain static at any position along the vertical rails until moved by the operator. Optionally, one or more clamping mechanisms may apply adjustable pressure of a friction pad against the vertical rail component(s) to slow the movement or be fully engaged to temporarily lock the carriage assembly and supported device or equipment at any position along the vertical rail.

Alternatively a turntable dolly base may be upwardly engaged with a tiltable jib arm assembly for positioning and moving a device along any axis and, like a vertical track assembly, may provide a range of positioning and motion of a device from very low to high angles. A jib arm assembly may be rotatable centrally where it is mounted to a vertical support structure above the turntable dolly base, and may comprise at one end counterbalance weight components and at the opposite end a self-levelling device mount assembly whereon the device is mounted.

According to further embodiments, several of the modular components of the present disclosure relate to portable stands whereon various devices or a table component may be mounted and positioned and the device stand may be optionally reconfigured for a change of position or function.

According to a first aspect of the disclosure, there is provided an assembly for moving a device, comprising: roller elements for allowing the assembly to be moved by rolling the roller elements; a vertical track assembly comprising a device mount assembly for mounting the device to the vertical track assembly; a counterbalanced pulley system for allowing the device mount assembly to be controllably translated along the vertical track assembly; and a turntable, at least a portion of which is rotatable relative to the vertical track assembly.

The assembly may further comprise roller assemblies comprising the roller elements, and the roller assemblies may be connected by one or more connecting members to the turntable and positioned to allow the roller elements to contact rails of a track along which the assembly is to be moved.

Each roller assembly may have a portion that is pivotable relative to the one or more connecting members to thereby assist the assembly in moving along a curved portion of the track.

Each roller assembly may comprise at least a pair of the roller elements a roller element mount plate to which are fastened the pair of roller elements. The roller element mount plate may comprise multiple spaced apertures for allowing the pair of roller elements to be spaced apart by different offsets to accommodate rails of different widths.

The assembly may comprise one or more cylindrical structural components, each cylindrical structural component having one or more channels formed in an outer surface thereof and extending along the length of the cylindrical structural component.

At least one of the one or more cylindrical structural components may have only four channels, and the four channels may be positioned symmetrically around the cylindrical structural component.

The assembly may further comprise a track along which the assembly is to be moved, and the track may comprise at least one of the one or more cylindrical structural components.

The vertical track assembly may comprise at least one of the one or more cylindrical structural components.

The assembly may further comprise roller assemblies comprising the roller elements, and the roller assemblies may be connected by one or more connecting members to the turntable and positioned to contact rails of a track along which the assembly is to be moved. The one or more connecting members may comprise at least one of the one or more cylindrical structural components.

The assembly may comprise multiple cylindrical structural components, and at least two adjacent cylindrical structural components of the multiple cylindrical structural components may be joined using a brace positioned in a respective channel of each of the two adjacent cylindrical structural components.

The turntable may define a first axis of rotation, and the device mount assembly may comprise a device mount plate for mounting the device at a mounting location on the device mount plate. The mounting location may be aligned with the first axis of rotation.

The vertical track assembly may comprise one or more vertical rails along at least one of which the device mount assembly is controllably and vertically translatable using the pulley system. The one or more vertical rails may be offset from a center of the turntable by one or more extension members to align the first axis of rotation with the mounting location.

The vertical track assembly may comprise one or more vertical rails along at least one of which the device mount assembly is controllably and vertically translatable using the pulley system. The one or more vertical rails may be attached to the turntable.

The vertical track assembly may comprise vertical rails, and the device mount assembly may be attached to at least one of the vertical rails using at least one first roller carriage assembly configured to be controllably translated along the at least one vertical rail. The pulley system may comprise a counterweight secured to at least one of the vertical rails by at least one second roller carriage assembly, and may be connected to the at least one first roller carriage assembly and the at least one second roller carriage assembly.

The vertical track assembly may comprise first, second, and third vertical rails, and the device mount assembly may be controllably and vertically translatable, using the pulley system, along the first and second vertical rails. The pulley system may comprise a counterbalance that is controllably and vertically translatable along the third vertical rail.

The pulley system may comprise a pulley plate and one or more pulleys mounted to the pulley plate, and the vertical track assembly may further comprise one or more vertical rails to which is secured the pulley plate.

The vertical track assembly may further comprise at least one corner brace contacting the pulley plate and one of the one or more vertical rails to provide increased support to the pulley plate.

The assembly may further comprise the track, and the track may comprise at least one rail connecting member interconnecting the rails. One or more wheels may be attached to the rail connecting member for allowing the track to be rolled along the ground.

Each wheel may be attached to a respective vertical post comprised in the rail connecting member, and each vertical post may be spaced from one of the rails to provide clearance for the rolling assemblies when the assembly is being moved along the track.

Each vertical post may be attached to one of the rails using a respective connector comprised in the rail connecting member. Each connector may be configured to be attached to the one of the rails using a fastener received in a first channel formed within the one of the rails, and each connector may be configured to be attached to the vertical post using a fastener received in a second channel formed within the vertical post.

The first and second channels may be perpendicular.

The rail connecting member may be height-adjustable relative to each wheel for allowing the track to be levelled.

The assembly may further comprise the track, and at least one of the rails may be fastened to a vertical post of the track. A wheel may be attached to the vertical post for allowing the track to be rolled along the ground, and the height of the rail relative to the wheel may be adjustable by adjusting the location at which the rail is fastened to the vertical post.

The rail may be fastened to the vertical post using at least one connector, and the height of the rail relative to the wheel may be adjustable by unfastening the at least one connector, adjusting the location at which the rail is fastened to the vertical post, and fastening the at least one connector to the vertical post and the rail.

The at least one connector may be at least one corner brace connector.

At least one of the one or more connecting members may comprise a cylindrical structural component, and at least one of the rolling assemblies may be attached to the at least one cylindrical structural component using a connector having: a first end that is fastened to the rolling assembly; and a second end that covers an open end of the cylindrical structural component.

The roller elements may be wheels for wheeling the assembly over the ground.

The assembly may further comprise a horizontal base extending from a front of the assembly to a rear of the assembly, and the vertical track assembly may be attached to the horizontal base at the front of the assembly.

One or more diagonal supporting members may extend from proximally the rear of the assembly to proximally a top of the vertical track assembly.

The vertical track assembly may comprise a pair of vertical rails along which the device mount assembly is controllably and vertically translatable using the pulley system, and the one or more diagonal supporting members may be attached to the pair of vertical rails.

The wheels may include at least one rear wheel, and the turntable may be coupled to the at least one rear wheel such that a user of the assembly may rotate the turntable and thereby pivot the at least one rear wheel to steer the assembly.

The turntable may comprise a first plate rotatable relative to a second plate.

The turntable may further comprise one or more rollers between the first and second plates for allowing the first plate to rotate relative to the second plate.

The turntable may further comprise a bearing positioned between the first and second plates.

The turntable may further comprise rollers between the first and second plates and arranged in a circumferential direction for allowing the first plate to rotate relative to the second plate.

The turntable may further comprise: a first movable disc on top of the first plate, and a second movable disc between the first and second plates; and a threaded fastener extending through the first movable disc, the first plate, the second movable disc, and the second plate, and for allowing a user to control the resistance to rotation, or prevent rotation, of the first plate relative to the second plate by selectively tightening or loosening the fastener.

The turntable may further comprise: a bearing retainer positioned between the bearing and one of the first plate and the second plate; and a threaded fastener extending through the other of the first plate and the second plate, into the bearing retainer, and for allowing a user to control the resistance to rotation, or prevent rotation, between the first and second plates by selectively tightening or loosening the fastener.

According to a further aspect of the disclosure, there is provided a roller assembly for moving along a rail, comprising: an upper mount component; an upper body component pivotable relative to the upper mount component; a lower body component fixed to the upper body component; and a roller element mount plate to which are secured roller elements for allowing the assembly to be moved by rolling the roller elements along the rail, wherein the roller element mount plate is: pivotable relative to the lower body component; and translatable along a slot formed in the lower body component.

According to a further aspect of the disclosure, there is provided a connector for connecting first and second cylindrical structural components, comprising: a first connector portion for fastening to the first cylindrical structural component; and a second connector portion for fastening to the second cylindrical structural component, and wherein: the first and second connector portions are fastened together using a threaded fastener; and the connector further comprises a resiliently compressible material provided between the first and second connector portions to provide increased tension to a user when fastening the first and second cylindrical structural components together using the threaded fastener.

The resiliently compressible material may be a single resiliently compressible ring received in a corresponding recess in one of the first and second connector portions.

The single resiliently compressible ring may be received in a corresponding recess in the first connector portion and a corresponding recess in the second connector portion.

The resiliently compressible material may comprise a pair of resiliently compressible rings received in corresponding recesses in the first and second connector portions.

Each resiliently compressible ring may protrude from its respective recess.

The resiliently compressible material may be adhered to one or both of the first and second connector portions.

One of the first and second connector portions may comprise a recess, and the other of the first and second connector portions may comprise a locking member movable through an aperture in the other of the first and second connector portions and into the recess to prevent the first and second connector portions from being unfastened by rotation of the first and second connector portions relative to one another.

Each of the first and second connector portions may comprise a respective threaded aperture for receiving the threaded fastener when fastening together the first and second connector portions.

According to a further aspect of the disclosure, there is provided an assembly comprising: a vertical adjustment assembly comprising: one or more vertical posts; and a device mount assembly comprising one or more arms fastened to the one or more vertical posts and for mounting a device to the vertical adjustment assembly; and a turntable, at least a portion of which is rotatable relative to the vertical adjustment assembly, and wherein the one or more arms are height-adjustable relative to the ground to allow the device mount assembly to be vertically repositioned.

The assembly may further comprise a horizontal base extending from a front of the assembly to a rear of the assembly, and the vertical adjustment assembly may be attached to the horizontal base at the front of the assembly.

One or more diagonal supporting members may extend from proximally the rear of the assembly to proximally a top of the vertical adjustment assembly.

The vertical adjustment assembly may comprise a pair of vertical posts along which the device mount assembly is vertically adjustable, and the one or more diagonal supporting members may be attached to the pair of vertical posts.

The assembly may further comprise wheels, including at least one rear wheel, for allowing the assembly to be moved over the ground, and the turntable may be coupled to the at least one rear wheel such that a user of the assembly may rotate the turntable and thereby pivot the at least one rear wheel to steer the assembly.

Each of the one or more arms may be attached to one of the one or more posts using at least one connector, and the height of each arm relative to the ground may be adjustable by unfastening the at least one connector, adjusting the location at which the arm is fastened to the vertical post, and fastening the at least one connector to the vertical post and the arm.

The at least one connector may be at least one corner brace connector.

The turntable may define a first axis of rotation, and the device mount assembly may comprise a device mount plate for mounting the device at a mounting location on the device mount plate. The mounting location may be aligned with the first axis of rotation.

The vertical adjustment assembly may comprise one or more vertical posts along at least one of which the device mount assembly is height-adjustable, and the one or more vertical posts may be offset from a center of the turntable by one or more extension members to align the first axis of rotation with the mounting location.

According to a further aspect of the disclosure, there is provided a stand for a device, comprising: a base; an upright support fastened to the base; and an arm fastened to the upright support and comprising a mount for receiving the device, wherein: one or any combination of the base, the upright support, and the arm comprises one or more cylindrical structural components, each cylindrical structural component having one or more channels formed in an outer surface thereof and extending along the length of the cylindrical structural component; at least one of the one or more cylindrical structural components has only four channels; and the four channels are positioned symmetrically around the cylindrical structural component.

The base may comprise one or more wheels for moving the stand.

The base may comprise: a first member; and a second member fastened perpendicularly to: the first member; and the upright support.

The second member may be fastened to the first member using one or more first connectors. The second member may be fastened to the upright support using one or more second connectors.

The one or more first connectors and/or the one or more second connectors may be one or more corner braces.

The base may further comprise two wheels connected to the first member.

The base may further comprise a single wheel connected to the second member.

The upright support may comprise at least two interconnected cylindrical structural components of the one or more cylindrical structural components.

The two interconnected cylindrical structural components may be interconnected using a connector comprising: a first connector portion fastened to one of the two cylindrical structural components; and a second connector portion fastened to the other of the two cylindrical structural components. The first and second connector portions may be fastened together using a threaded fastener.

The connector may further comprise a resiliently compressible material provided between the first and second connector portions to provide increased control to a user when fastening the first and second connector portions together using the threaded fastener.

The arm may be height-adjustable relative to the ground by adjusting a location at which the arm is fastened to the upright support.

The stand may further comprise a clamp clamped to the upright support and to which is fastened the arm.

The clamp may be configured to be repositionable on the upright support by unfastening a single fastener to loosen the clamp and then translating the clamp along the upright support.

The mount may comprise a ball-and-socket joint.

The stand may further comprise a clamp clamped to the arm and to which is fastened the mount.

The clamp may be configured to be repositionable on the arm by unfastening a single fastener to loosen the clamp and then translating the clamp along the arm.

Each of the base, the upright support, and the arm may comprise at least one cylindrical structural component of the one or more cylindrical structural components.

According to a further aspect of the disclosure, there is provided a stand for a device, comprising: a base; an upright support fastened to the base; an arm fastened to the upright support and comprising a mount for receiving the device; and a clamp clamped to the upright support and to which is fastened the arm.

The clamp may be configured to be repositionable on the upright support by unfastening a single fastener to loosen the clamp and then translating the clamp along the upright support.

According to a further aspect of the disclosure, there is provided an adjustable-level track assembly comprising: vertical posts; a pair of spaced-apart rails connected to the vertical posts; at least two rail-connecting members interconnecting the rails; and ground-contacting elements connected to the vertical posts and the rail-connecting members, wherein the height of the ground-contacting elements relative to the rails is adjustable by adjusting the locations at which the rails are connected to the vertical posts.

For at least one of the rails, the rail may be fastened to one of the vertical posts using at least one connector. The height of the rail relative to at least one of the ground-contacting elements may be adjustable by unfastening the at least one corner brace, adjusting the location at which the rail is fastened to the vertical post, and fastening the at least one corner brace to the vertical post and the rail.

The at least one connector may be at least one corner brace.

The ground-contacting elements may be wheels or static feet.

For at least one of the vertical posts, the height of the at least one vertical post relative to the ground-contacting element to which it is connected is adjustable using a threaded connector.

According to a further aspect of the disclosure, there is provided a base for a vertical adjustment assembly, comprising: legs extending from a cylindrical mount component; feet connected to ends of the legs; and a plate rotatable relative to the legs and connected to the cylindrical mount component by a threaded fastener extending through the plate and into the cylindrical mount component, and for allowing a user to control the resistance to rotation of the plate by selectively tightening or loosening the fastener.

The threaded fastener may further extend through the cylindrical mount component and a locking nut is engaged with the threaded fastener to lock the plate.

Three or four legs may extend from the cylindrical mount component.

The legs may be height-adjustable relative to the feet.

The feet may be threadably engaged to cylindrical mount portions at ends of the legs.

The legs may be height-adjustable relative to the feet by threadably adjusting positions of the feet relative to the cylindrical mount portions.

The feet may comprise caster wheels.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

These and other features of the disclosure will become more apparent in the following detailed description in which reference is made to the appended drawings, wherein:

FIG. 1 is a perspective view of a vertical track dolly comprising a 3-rail vertical track assembly with pulley and counterweighted device mount components supported on a turntable dolly base and adjustable-level horizontal track assembly, according to an embodiment of the disclosure;

FIG. 2 is a partially exploded perspective view of the 3-rail vertical track assembly shown in FIG. 1;

FIG. 3 is a partially exploded perspective view of the pulley component assembly shown in FIG. 1;

FIG. 4 is a partially exploded perspective view of the turntable dolly base with four track roller assemblies shown in FIG. 1;

FIG. 5 is a partially exploded perspective view of the lockable turntable assembly of the turntable dolly base shown in FIG. 1;

FIG. 6 is a partially exploded perspective view of one of the track roller assemblies of the turntable dolly base shown in FIG. 1 configured on the cylindrical rail track assembly;

FIG. 7 is a partially exploded perspective view of the cylindrical rail track assembly shown in FIG. 1;

FIG. 8 is a perspective view of a vertical track dolly with a turntable dolly base on a rectangular rail track assembly, according to an embodiment of the disclosure;

FIG. 9 is a top perspective view of the turntable dolly base with four track roller assemblies shown in FIG. 8 configured on the rectangular rail track assembly;

FIG. 10 is a partially exploded bottom perspective view of the turntable dolly base and four track roller assemblies shown in FIG. 9;

FIGS. 11A and 11B are a whole perspective view and a partially exploded perspective view of one of the track roller assemblies shown in FIG. 8 configured for a rectangular or square rail;

FIG. 12 is a perspective view of a height-adjustable dolly comprising three vertical posts and device mount components supported on a turntable dolly base on standard straight and curved horizontal track components, according to an embodiment of the disclosure;

FIG. 13 is a partially exploded perspective view of the turntable dolly base shown in FIG. 12 with a lockable turntable assembly and four cylindrical rail track roller assemblies;

FIG. 14 is a partially exploded perspective view of the vertical adjustment assembly shown in FIG. 12 with three vertical posts mounted on three turntable extension plates;

FIG. 15 is a perspective view of an adjustable-level tripod stand supporting a vertical track assembly on a rotation plate assembly, according to an embodiment of the disclosure;

FIG. 16 is a partially exploded perspective view of the adjustable-level tripod stand and rotation plate assembly shown in FIG. 15;

FIG. 17 is a perspective view of a steerable vertical track dolly with a vertical track assembly supported on a horizontal chassis assembly mounted to a fixed front axle assembly and rotating rear axle assembly;

FIG. 18 is a partially exploded perspective view of the steerable vertical track dolly shown in FIG. 17, according to an embodiment of the disclosure;

FIG. 19 is a partially exploded perspective view of the horizontal chassis assembly, fixed front axle assembly, and rotating rear axle assembly shown in FIG. 17;

FIGS. 20A and 20B are a whole perspective view and an exploded perspective view of one of four of an adjustable angle connector shown in FIG. 17 configured for reinforcing the vertical track assembly;

FIG. 21 is a perspective view of a rotating jib dolly with a vertically pivotable jib arm assembly and self-levelling device mount assembly on a vertical support assembly and turntable dolly base configured for straight and curved track components, according to an embodiment of the disclosure;

FIG. 22 is a partially exploded perspective view of the jib arm assembly, self-levelling device mount assembly, and vertical support assembly shown in FIG. 21;

FIG. 23 is a partially exploded perspective view of the turntable dolly base shown in FIG. 21;

FIG. 24 is a perspective view of a device stand with a demountable laptop bracket and cup holder component supported by structural tube modules with a first example of twist-on end assemblies, according to an embodiment of the disclosure;

FIG. 25 is a partially exploded perspective view of the device stand in FIG. 24;

FIG. 26 is a perspective view of a table stand with a demountable table assembly, according to an embodiment of the disclosure;

FIG. 27 is a partially exploded perspective view of the table stand in FIG. 26;

FIGS. 28A and 28B are a whole perspective view and an exploded perspective view of a second example of twist-on end assemblies, according to an embodiment of the disclosure.

FIG. 29 is a perspective view of a vertical track dolly comprising a 3-rail vertical track assembly with pulley and counterweighted device mount components supported on a turntable dolly base with four cylinder-mount track roller assemblies on an adjustable-level track assembly, according to an embodiment of the disclosure;

FIG. 30 is a partially exploded perspective view of the turntable dolly base with four cylinder-mount track roller assemblies shown in FIG. 29;

FIG. 31 is a partially exploded perspective view of the lockable turntable assembly with adjustable tension components of the turntable dolly base shown in FIGS. 29 and 30;

FIGS. 32A and 32B are a bottom view and a side section view of the lockable turntable assembly with adjustable tension components of the turntable dolly base shown in FIGS. 29 and 30;

FIGS. 33A and 33B are a whole perspective view and a partially exploded perspective view of one of the cylinder-mount track roller assemblies of the turntable dolly base shown in FIG. 29 configured on the cylindrical rail track assembly;

FIGS. 34A and 34B are a partially exploded bottom view and a side section view of the cylinder-mount track roller assembly shown in FIGS. 29 and 33;

FIG. 35 is a partially exploded perspective view of the adjustable-level track assembly shown in FIG. 29;

FIGS. 36A and 36B are a whole perspective view and a partially exploded perspective view of a first embodiment of a side-mount track roller assembly mounted to the underside of a tube component;

FIGS. 37A and 37B are a top view and a side section view of the side-mount track roller assembly shown in FIG. 36;

FIGS. 38A and 38B are a whole perspective view and a partially exploded perspective view of a second embodiment of a side-mount track roller assembly mounted to the underside of a tube component;

FIGS. 39A and 39B are a top view and a side section view of the side-mount track roller assembly shown in FIG. 38;

FIGS. 40A and 40B are a whole perspective view and a partially exploded perspective view of a first embodiment of a double side-mount track roller assembly with a double side-mount component mounted to the undersides of two tube components;

FIGS. 41A and 41B are a whole perspective view and a partially exploded perspective view of a third embodiment of a side-mount track roller assembly, with a secondary component-mount hole with a threaded foot component, mounted to the underside of a tube component;

FIGS. 42A and 42B are a whole perspective view and a partially exploded perspective view of a second embodiment of a double side-mount track roller assembly, with a secondary component-mount hole with a threaded foot component, mounted to the underside of a tube component;

FIGS. 43A and 43B are a whole perspective view and a partially exploded perspective view of a fourth embodiment of two side-mount track roller assemblies each with two side-mount holes mounted to the underside of a tube component;

FIGS. 44A and 44B are a top view and a side section view of the side-mount track roller assembly shown in FIG. 43;

FIGS. 45A and 45B are a whole perspective view and a partially exploded perspective view of a tube end-mount track roller assembly mounted to the end of a tube component;

FIGS. 46A and 46B are a whole perspective view and a partially exploded perspective view of a fifth embodiment of a side-mount track roller assembly mounted to the underside of a rectangular framing component with roller elements shown on a square framing component;

FIGS. 47A and 47B are a top view and a side section view of the side-mount track roller assembly shown in FIG. 46;

FIGS. 48A and 48B are a whole perspective view and a partially exploded perspective view of a sixth embodiment of a side-mount track roller assembly mounted to the underside of a square framing component with roller elements shown on a rectangular framing component;

FIGS. 49A and 49B are a top view and a side section view of the side-mount track roller assembly shown in FIG. 48;

FIGS. 50A and 50B are a whole perspective view and a partially exploded perspective view of a seventh embodiment of a side-mount track roller assembly mounted to the underside of a square framing component with roller elements shown on a square framing component;

FIGS. 51A and 51B are a whole perspective view and a partially exploded perspective view of a pipe fitting mount track roller assembly mounted to a pipe component with roller elements shown on a rail pipe component, according to an embodiment of the disclosure;

FIGS. 52A and 52B are a side view and a section view of the pipe fitting mount track roller assembly shown in FIG. 51;

FIG. 53 is a perspective view of a rotating hub dolly with a height-adjustable device mount rod assembly and bowl/ball mount assembly supported on a rotating hub dolly base with a rotating hub assembly, with three of the first side-mount track roller assemblies shown in FIG. 36, on a standard curved track assembly, according to an embodiment of the disclosure;

FIG. 54 is a partially exploded perspective view of the rotating hub dolly shown in FIG. 53;

FIGS. 55A and 55B are a whole perspective view and an exploded perspective view of the rotating hub assembly with adjustable tension components shown in FIG. 53, according to an embodiment of the disclosure;

FIGS. 56A and 56B are a top view and a side section view of the rotating hub assembly with adjustable tension components shown in FIG. 55;

FIGS. 57A and 57B are a partially exploded perspective view of the height-adjustable device mount rod assembly shown in FIGS. 53 and 54, in a lowered configuration, and a top view of the height-adjustable device mount rod assembly with the bowl/ball mount assembly removed;

FIG. 58 is a perspective view of a rotating hub stand with a height-adjustable device mount arm assembly supported on a rotating hub assembly and four threaded foot components, according to an embodiment of the disclosure;

FIG. 59 is a partially exploded perspective view of the rotating hub stand shown in FIG. 58;

and

FIGS. 60A and 60B are a whole perspective view and an exploded perspective view of a second embodiment of a rotating hub assembly with adjustable tension components, according to an embodiment of the disclosure.

### DETAILED DESCRIPTION

The present disclosure seeks to provide novel support assemblies and components for such assemblies. While various embodiments of the disclosure are described below, the disclosure is not limited to these embodiments, and variations of these embodiments may well fall within the scope of the disclosure which is to be limited only by the appended claims.

The support assemblies and apparatuses of the present disclosure may comprise a plurality of modules that may be demountably engaged into a wide assortment of combinations to form assemblies that can be used in various stationary and moveable equipment support applications. The assemblies may be easily disassembled into individual modular subassemblies and/or components to facilitate ease of transport and storage. The modular components may enable multi-functionality in that the various modules can be easily configured to form a unique apparatus and then quickly broken down for transport and/or storage and may be reconfigured into additional forms with alternative functionalities and ranges of motion. For the purposes of illustrating the versatility and configurability of these components and assemblies, the following non-limiting description will refer to examples of support assemblies that are useful for demountable engagement with devices such as cameras, lighting equipment, sound recording equipment, audio/visual equipment, sensors, robotic gimbals, robotic arms, power tools, and other equipment.

Embodiments of the present disclosure generally relate to modular components which, to configure modular support apparatuses of various types and utility, may be configured and sized for compatibility with the modular components as previously disclosed in U.S. Pat. No. 11,384,898 B2, U.S. Pat. No. 12,398,841 B2, U.S. Pat. Nos. 11,535,288 B2, and 11,987,280 B2, all of which are incorporated herein by reference in their entireties.

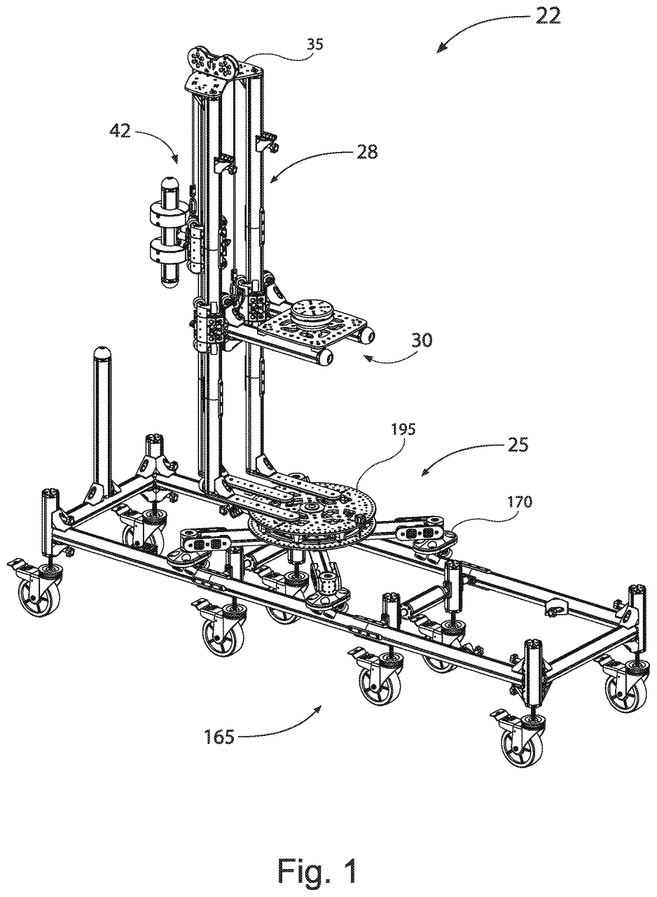

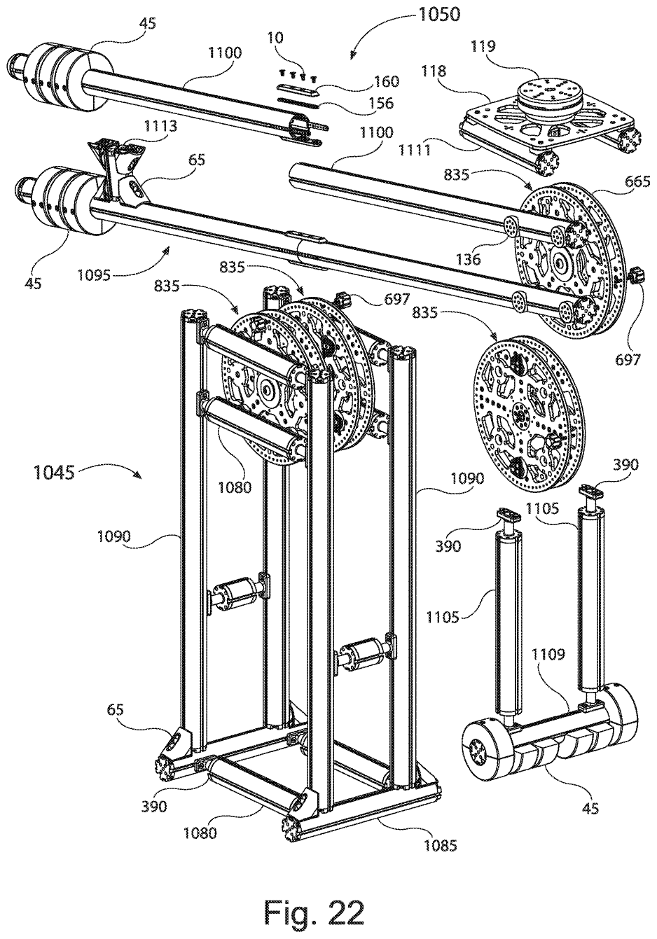

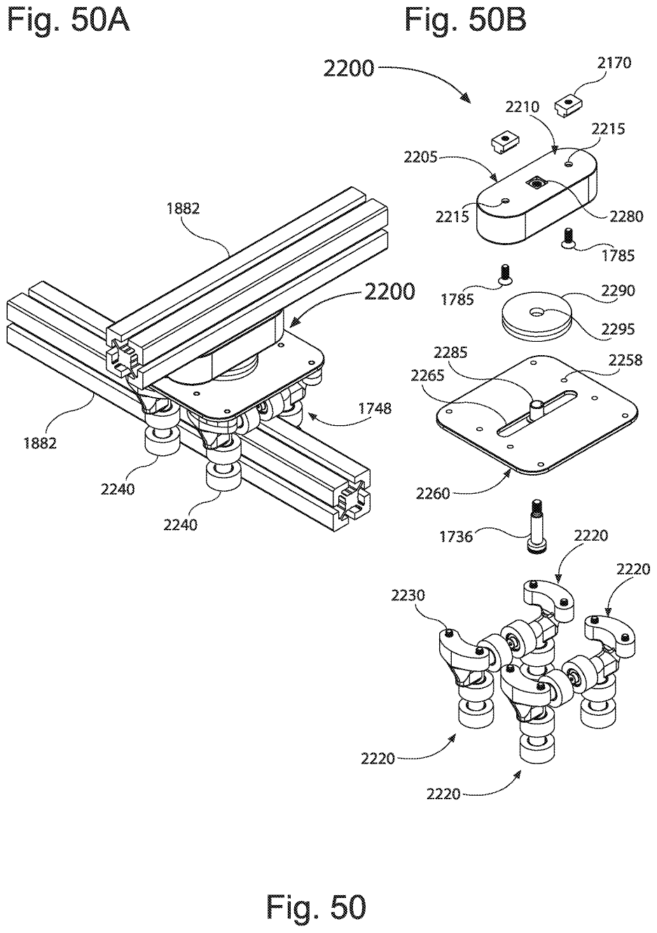

Embodiments of the modular components and support assemblies disclosed herein are described with reference to FIGS. 1-60 to illustrate various types of demountably engageable modules that may be securely and stably interconnected and assembled into a range of configurations for engaging, supporting, and conveying various types of devices or equipment in and around a film set or a production studio or a photography studio or a performance venue or a sporting venue, or other locations commonly used for producing movies, videos, television programs, sports, news, documentaries, music videos, time-lapse photography, and still photography. The modular components also form assemblies useful in other types of worksites such as in manufacturing, construction, landscaping, agricultural, healthcare, retail, warehouses and the like, or alternatively, for use in some household and recreational applications. According to some embodiments, the modular components may be sized to make them suitable for handling and use by juveniles during play and learning activities.

The numbers and types of modules that may be incorporated into a particular assembly will vary depending on the intended end-use of the support assembly. However, an assembly may generally comprise: a plurality of caster components and/or wheel components and/or roller components and/or foot components; a plurality of structural tube modules assembled together in part by screws threadedly engaged with nuts retained within nut channels along the sides of the structural tube modules; and a dolly base assembly which may comprise a turntable assembly for rotational movement of the top components of the support apparatus which may include a vertical track assembly or vertical adjustment assembly or a tiltable jib arm assembly, as will be described in further detail below.

According to some embodiments disclosed herein, a group of one or more of the various types of modules is provided together in a kit for assembly into a specified type of support apparatus configured for the given functional requirements. Kits of the present disclosure may additionally comprise, or be packaged with, instruments or tools for assisting with the assembly of the system, and/or hard copy or software based instructions for assembling the same.

The broad range of configurability allows apparatuses to be assembled in a wide range of sizes and functional design for a broad range of end-user requirements. According to certain embodiments, the modules can be interconnected to form apparatuses that include, without limitation, carts, dollies, tracks, cranes, jibs, lifts, stands, racks, tables, workstations, seating, bedframes, shelving, storage, staging, railings, partitions, toy systems, and the like. Optionally, an apparatus may be combined with third party tools, mechanisms, and systems for varying end-use requirements.

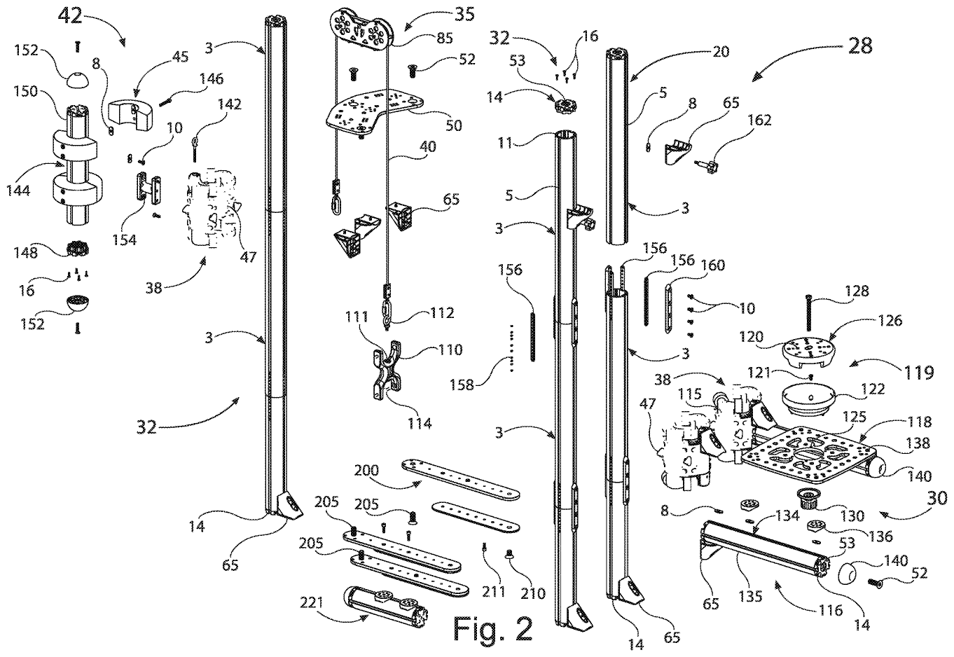

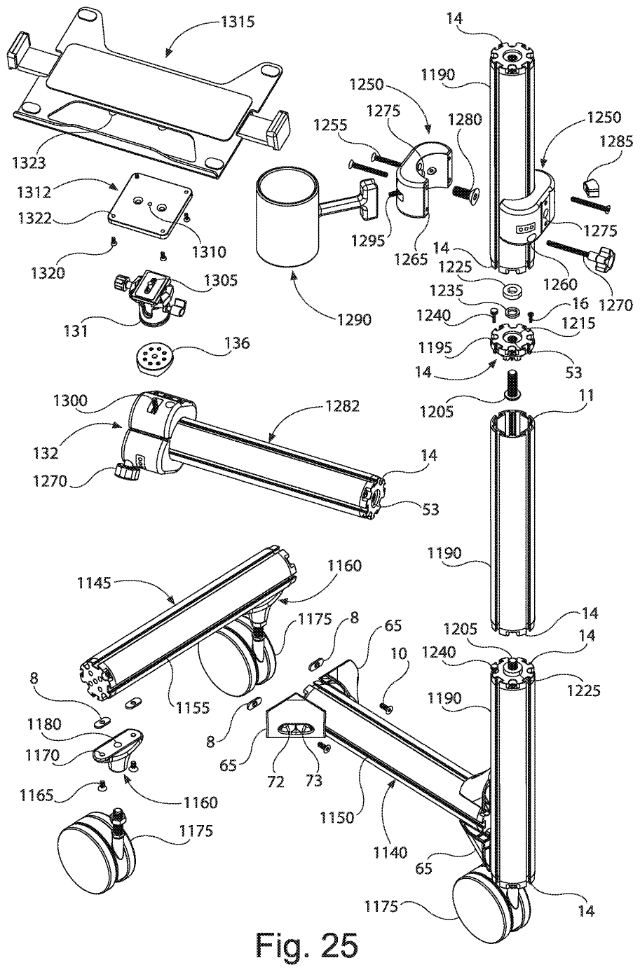

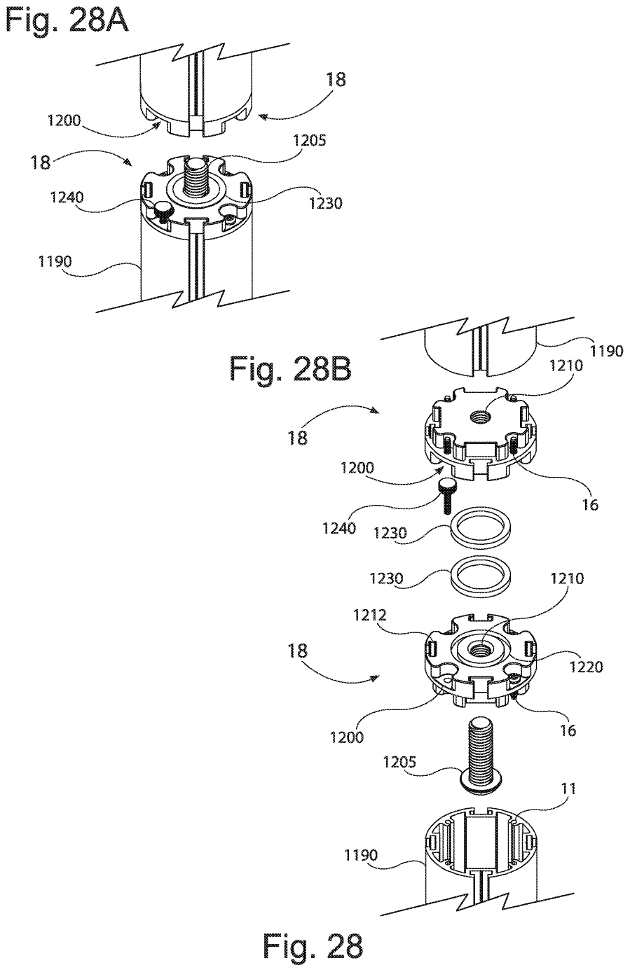

According to some embodiments, a modular apparatus comprises a plurality of elongate cylindrical structural components with one or more nut channels around its circumference wherein one or more components may be demountably engaged by screws or bolts threadedly engaged with nuts securely retained within the nut channels. As shown and first indicated in FIG. 2, and in close-up view in FIGS. 25 and 28, a cylindrical structural component 3 comprises four nut channels 5 whereby one or more nuts 8 may be threadedly engaged by one or more screws 10 to demountably engage another modular component having a concave face and configured to receive one or more screws or bolts for engagement with the one or more nuts 8.

A cylindrical structural component 3 may additionally comprise one or more screw slots 11 along the inner contours of the component whereby another component such as a threaded end connector 14 may be fastened to one or both ends by screws 16, as first indicated in FIG. 2 and shown in close-up in FIG. 25, or according to a further embodiment which will be described in further detail below with reference to FIG. 28, threaded end connector 18.

Various lengths of cylindrical structural components may be optionally combined with one or two end components of several types engaged at one or both ends of the cylindrical structural components to form various tube modules 20 which may be used in conjunction with one another and the other structural and functional components of the modular system such as corner brace connectors, and/or brace plates, and/or device mount plates, and/or pulley mount plates, and/or turntable components, and/or roller carriage assemblies, and/or weight components, and/or track roller assemblies, and/or wheel components, and/or foot mount components, as will be described in further detail below. Various lengths of cylindrical structural components may also be provided for direct attachment in a series of two or more secured end to end by channel braces or cylinder external braces to form rails and vertical posts, as will also be described in further detail below.

A first embodiment of a vertical track dolly is illustrated in FIGS. 1 to 7. The vertical track dolly 22 comprises a turntable dolly base 25 which is upwardly engaged by a vertical track assembly 28 configured for moving a device mount assembly 30 along vertical rail assemblies 32 of the vertical track assembly 28. The vertical track assembly 28 may comprise a pulley assembly 35 for controlling the positioning and movement of the device mount assembly 30 which in part comprises roller carriages 38, as previously disclosed in U.S. Pat. No. 12,398,841 B2, which are configured for stable rolling movement along the vertical rails 32.

The weight of a supported device or equipment and mount assembly 30, may be nearly or equally matched at the opposite end of the pulley assembly's cable 40 by a counterweight carriage assembly 42 comprising an additional roller carriage 38 with demountable weight components 45 attached so that the assemblies and supported device or equipment will remain static at any position along the vertical rails until moved by the operator. Optionally, one or more of the roller carriages 38 may include one or more adjustable clamping mechanisms 47 within, as previously disclosed in U.S. Pat. No. 12,398,841 B2, which may apply adjustable pressure of a friction pad against the vertical rails 32 to slow the movement or be fully engaged to temporarily lock the carriage assemblies 38 and supported device or equipment at any position along the vertical rails.

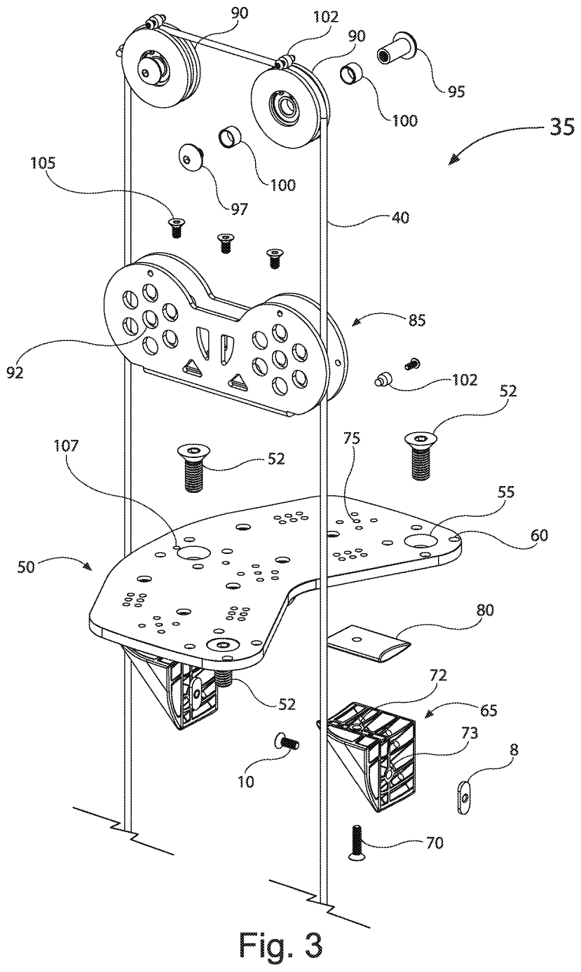

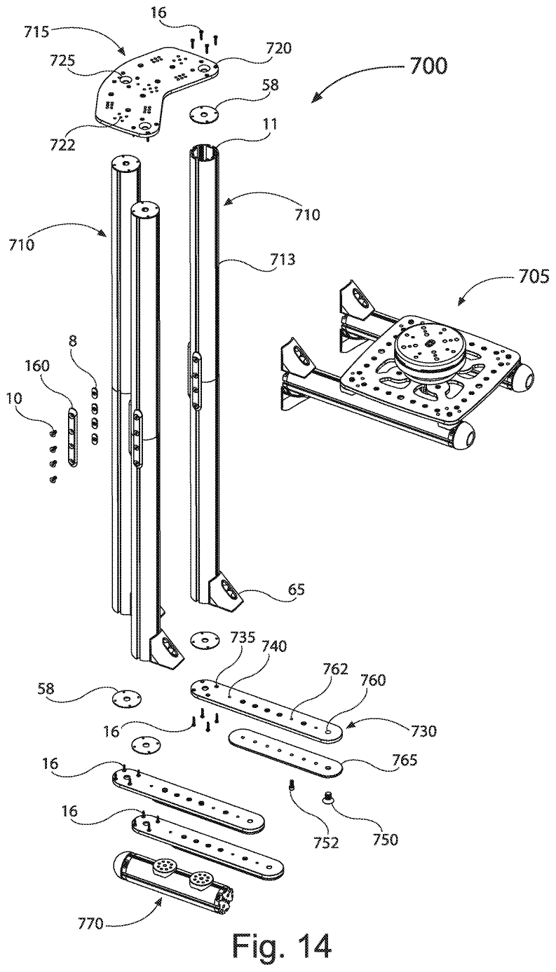

According to one embodiment, as shown in exploded view in FIG. 3, a pulley assembly 35 may comprise a mounting plate 50 whereby the assembly is demountably engaged with the top of the vertical rails 32. As shown, the threaded portion of screws 52 pass through holes 55 in the mounting plate 50 and are there threadedly engaged with a central threaded hole 53 in the threaded end connector 14 shown in FIG. 2 at the end of the vertical rail assemblies 32. According to a further embodiment, the vertical rails may exclude the threaded end connector and instead a mounting plate 50 attached directly or via a washer component 58 by screws 16 through holes 60 threadedly engaged with the screw slots 11, as will be described in further detail below with reference to FIG. 14. Optionally, the vertical rails 32 can be reinforced against the mounting plate 50 by corner brace connectors 65 fastened by a threaded portion of a screw 70 passed through a first through-hole 72 to be threadedly engaged with a threaded hole 75 in the mounting plate 50 via a flat insert 80 to adapt the corresponding concave side of the corner brace to the flat bottom of the mounting plate, and the perpendicular concave face of the corner brace connector 65 fastened by a threaded portion of a screw 10 passed through a second through-hole 73 to be threadedly engaged with a nut 8 in the nut channel 5 of the cylindrical structural component 3 of the vertical rail 32.

Pulley assembly 35 may further comprise a pulley bracket 85 within which one or more pulleys 90 are mounted to translate the motion of the cable 40 between sides of the vertical track assembly 28. The pulleys 90 may be secured at pulley axle holes 92 by a fastener. According to one embodiment, a binding barrel 95 is passed through an axle hole, the pulley, the axle hole on the opposite side and there secured by a binding barrel screw 97. Spacers or bushings 100 may be inserted around the binding barrel between the pulleys 90 and the pulley bracket 85 to maintain the central alignment of the pulleys. Cable retainers 102 may also be fastened near the outer edges of the pulley bracket for preventing the cable 40 from disengaging from the pulleys and pulley bracket 85. The pulley bracket 85 is fastened to the top of the mounting plate 50 by screws 105 threadedly engaged with threaded holes 107 in the mounting plate.

As illustrated in FIG. 2, the two roller carriages 38 of the device mount assembly are connected centrally by a bridge component 110 comprising a threaded hole 111 in its center whereby the cable 40 is attached via a carabiner and an eyebolt 112 threadedly engaged with the bridge component 110. The bridge component 110 may be fastened by screws 114 to threaded holes 115 in the sides of the roller carriage assemblies 38. Two tube modules 116 and a device mount plate 118 are demountably engaged on the sides of the roller carriages 38 perpendicular to the bridge component 110. According to one embodiment, an adjustable-level bowl/ball mount assembly 119 may be demountably engaged with the device mount plate 118 whereby a device such as a camera, lighting equipment, sound recording equipment, audio/visual equipment, sensor, robotic gimbal, robotic arm, power tool, or other equipment or interfacing mount component may be demountably engaged by screws at threaded holes 120, or other means of attachment.

According to one embodiment, the bowl/ball mount assembly 119 is fastened to the device mount plate 118 by screws 121 through holes in a bowl mount component 122 threadedly engaged with threaded holes 125 in the device mount plate. A ball adapter 126 is retained within the bowl mount component 122 by a screw or bolt 128 through the center of the ball adapter, a central hole in the bowl mount component 122, and there threadedly engaged with a locking handle 130 fastened against the rounded bottom surface of the bowl mount component at varying angles in tandem with the ball adapter 126 and supported device or equipment so that they may be levelled on the bowl mount component. According to further embodiments, as previously disclosed in U.S. Pat. No. 12,398,841 B2, a bowl/ball mount assembly may comprise a mount screw extending from the center of the top surface of the assembly whereby a device, equipment, or interfacing mount component comprising a threaded hole in its bottom surface may be threadedly engaged.

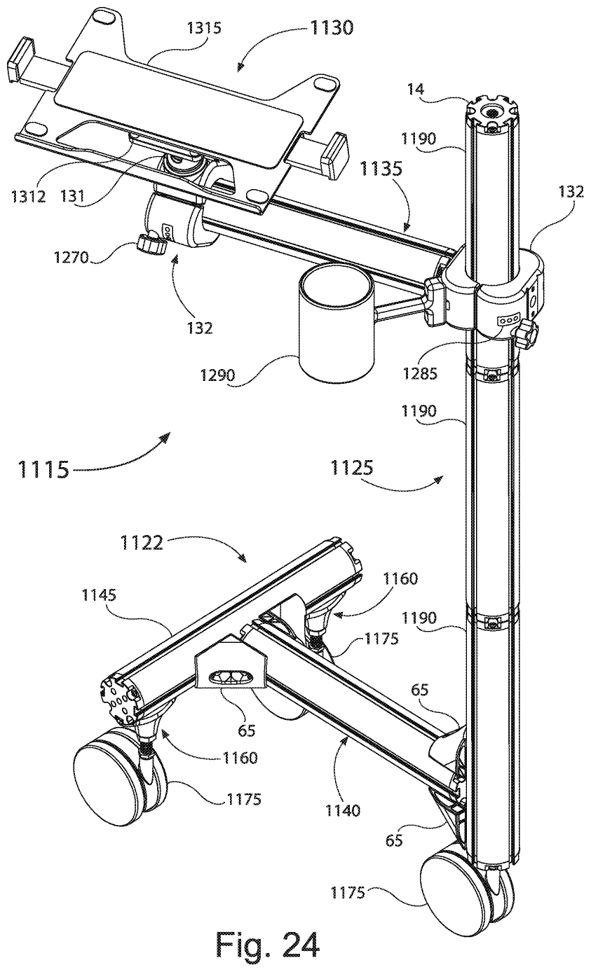

According to further embodiments, in place of a bowl/ball mount assembly, alternatively a device such as a camera, lighting equipment, sound recording equipment, audio/visual equipment, sensor, robotic gimbal, robotic arm, power tool, or other equipment may be demountably engaged on the device mount plate 118 or on a tube module 116 by another interfacing mount component such as a fluid-head mount, or a ball-and-socket joint mount 131 as shown in FIGS. 24, 25, and 27 which will be described in further detail below, or a stud mount component as previously disclosed in U.S. Pat. No. 12,398,841 B2, or a dovetail plate mount component as previously disclosed in U.S. Pat. No. 12,398,841 B2. A device, equipment, or interfacing mount component may alternatively be demountably engaged on a tube module via a clamp assembly 132 as shown in FIGS. 24 to 27 which will be described in further detail below.

According to one embodiment, each tube module 116 is demountably engaged with the roller carriages 38 by two corner brace connectors 65 fastened on one side to the outward faces of the roller carriages by screws 10 threadedly engaged with threaded holes in the roller carriages, and the perpendicular side with a side of the tube modules 116 by a screw 10 threadedly engaged with a nut 8 secured within a nut channel 134 in the sides of the modules' cylindrical structural component 135.

According to one embodiment, the four corners of the device mount plate 118 may be demountably engaged with either the top side or the bottom side of the tube modules 116 via four concave base components 136. The threaded portion of screws 138 are passed through holes in the corners of the device mount plate 118, and through-holes in the center of the concave base components 136, to be threadedly engaged with nuts 8 secured within the nut channels 134. Optionally, a bumper component 140 may be demountably engaged with the outer ends of the tube modules 116 by a screw threadedly engaged with the threaded hole 53 in the center of the modules' threaded end connectors 14. An operator may use one or both of the tube modules 116 as a handle to operate the rolling movement of the device mount assembly 30 along the vertical rail assemblies 32.

Alternatively, an operator may move the device mount assembly 30 by moving the counterweight carriage assembly 42 which is attached at the opposite end of the cable via a carabiner and eyebolt 142 threadedly engaged with a threaded hole in the assembly's roller carriage 38. The counterweight carriage assembly 42 may further comprise a tube module 144 whereon are demountably engaged weight components 45 by one or more screws 146 passed through holes in the weight components and threadedly engaged with one or more nuts 8 in the nut channel of the tube module. For ease of handling and as a protective enclosure of the tube module 144, a soft end component 148 may be fastened by screws 16 to the ends of the tube module's cylindrical structural component 150. Furthermore, bumper components 152 may be fastened to the soft end components 148. Optionally the weighted tube module 144 may be secured to the roller carriage by an additional intermediate tube module and corner brace connectors 65, or as shown in FIG. 2, via a parallel gooseneck connector 154 fastened to the tube module 144 by screws and nuts, and fastened to the roller carriage 38 by screws in to threaded holes in the outward face of the roller carriage.

According to some embodiments, a roller carriage 38 may comprise a channel-guide component, as previously disclosed in U.S. Pat. No. 12,398,841 B2, which is secured to the interior rail-facing side of the roller carriage and is aligned with and inserted into the corresponding nut channel in the side of the vertical rail assembly's cylindrical structural component(s) 3, to prevent the counterweighted roller carriage 42 assembly from deviating off-line when traveling along the vertical rail assembly 32. The roller carriage 38 may additionally comprise one or more of an adjustable clamping mechanism 47, as previously disclosed in U.S. Pat. No. 12,398,841 B2, which can be adjusted to apply varying degrees of clamping force on the rail for intermittent stoppage or limitation of speed with partial pressure of the mechanism applied. An adjustable clamping mechanism 47 may also be adjusted to be fully disengaged so that the roller carriage 38 is moveable along the rail assembly 32 without resistance.

Vertical rail assemblies 32 may comprise a single elongate cylindrical structural component or according to some embodiments is configured to be extended or shortened by comprising two or more cylindrical structural components which can be added or removed, as is illustrated in FIG. 2. The two or more cylindrical structural components 3 may be conjoined end to end by channel braces 156 secured in the nut channels 5 by set screws 158. The channel braces 156 comprise an elongate plate element having an outer profile shaped for fitting and sliding within the nut channels 5 of the corresponding cylindrical structural components 3 wherein it may brace the two components together by threadedly engaging two or more set screws 158 in two or more threaded holes in the channel brace. The set screws 158 extend through the channel brace 156 to press against the bottom of the nut channels 5 which drives the brace outward to press against the inward top faces of the nut channels thereby securely engaging the cylindrical structural components 3 together.

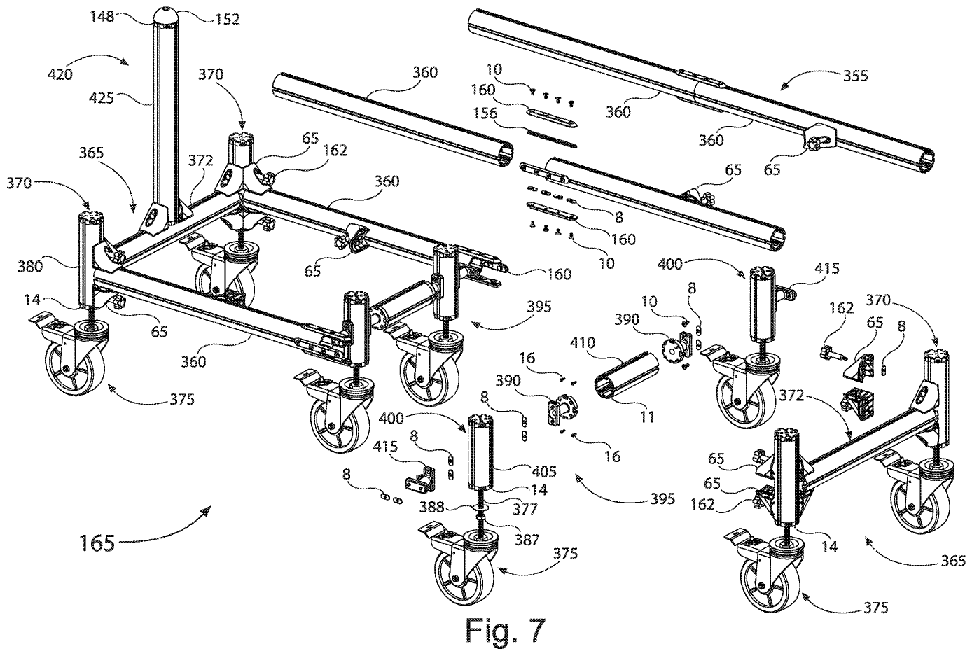

A series of two or more cylindrical structural components 3 may also be conjoined by one or more cylinder external braces 160 comprising two or more through-holes and a concave face whereby it may be demountably engaged against the sides of the two cylindrical structural components 3 by screws 10 with nuts 8 in the nut channels, or in place of the nuts used in conjunction with a channel brace 156 by engaging the screws with threaded holes in the channel brace, as shown in FIG. 2 or in FIG. 7 in a horizontal rail assembly as will be described in further detail below. Vertical rail assemblies 32 may also include corner brace connectors 65 slidingly engaged by a nut 8 in a nut channel providing a track stopper element which can be repositioned along the rails, by fastening and unfastening a screw 10 or a threaded knob 162 for ease-of-use.

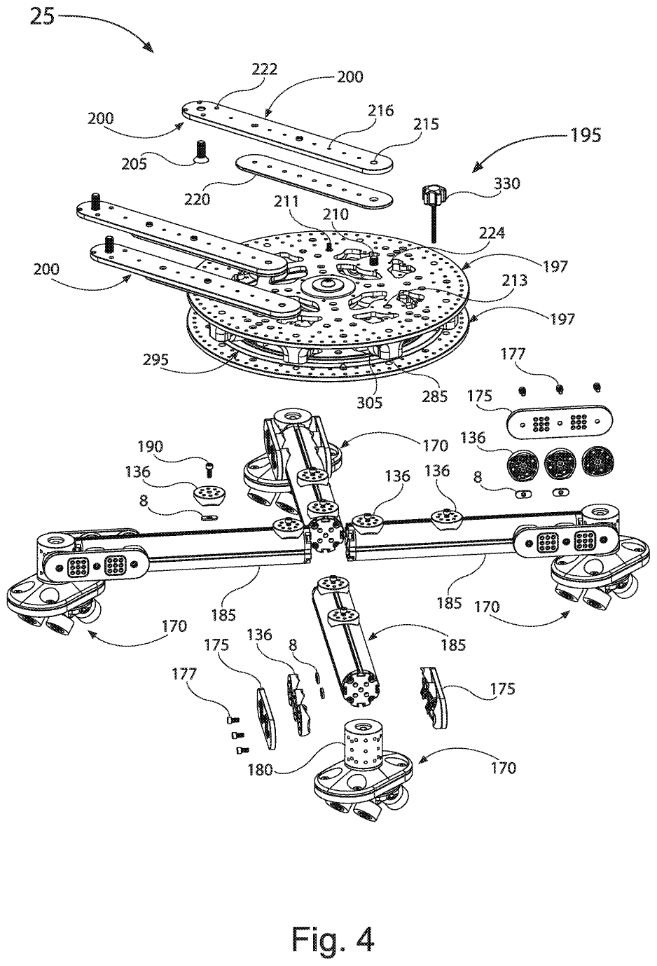

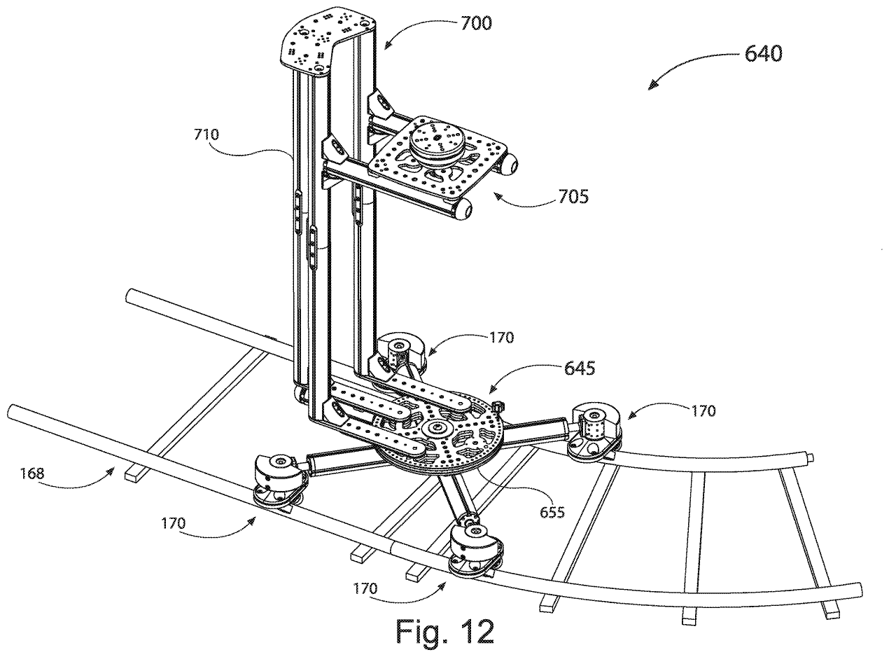

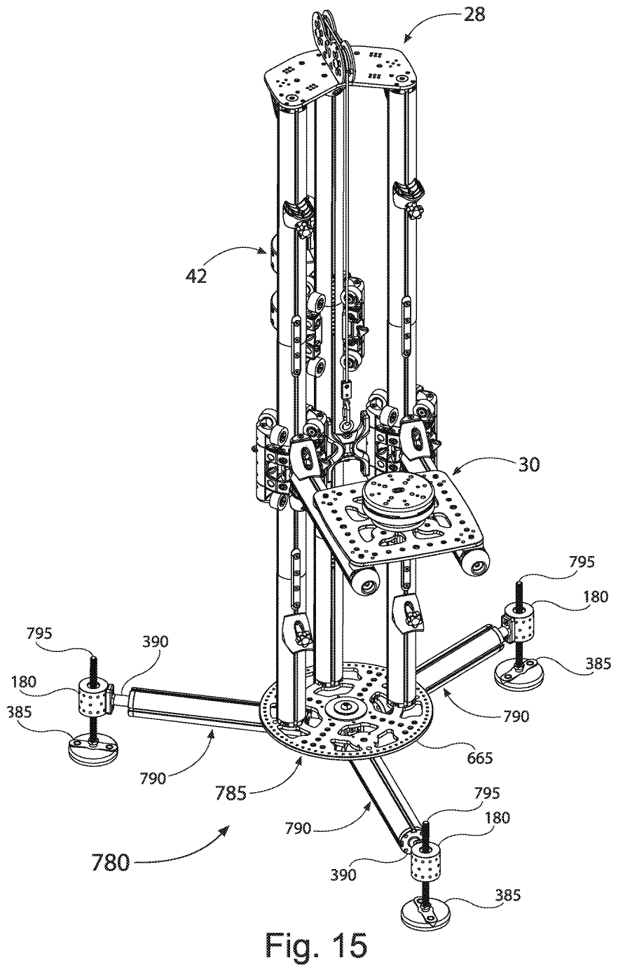

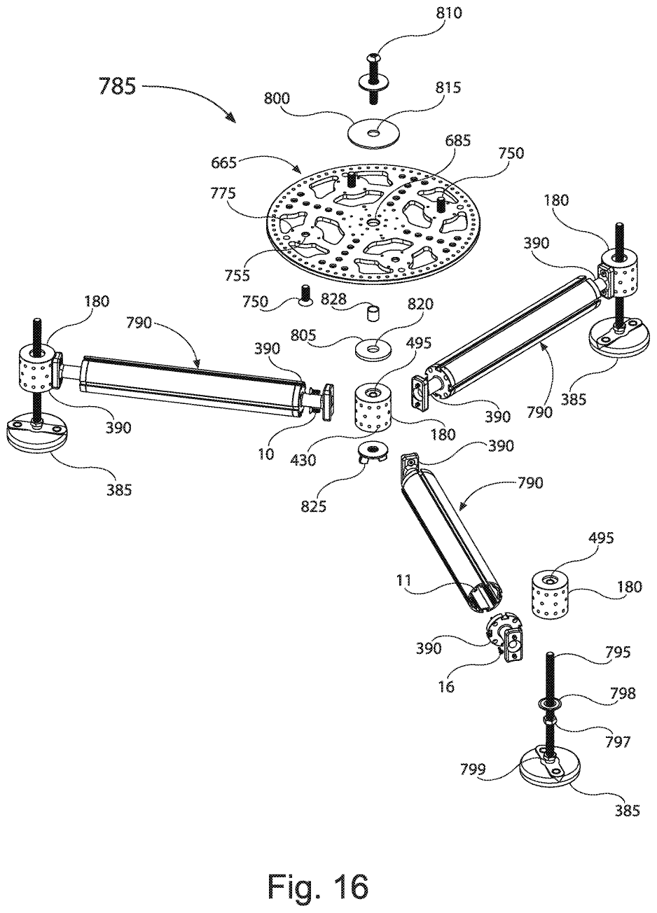

As illustrated in FIG. 1, a vertical track dolly 22 may further comprise a turntable dolly base 25 whereby the vertical track assembly 28 may be demountably engaged allowing for the 360-degree rotation of the vertical track assembly relative to the lower elements of the turntable dolly base. A turntable dolly base may be configured with casters for rolling directly on the ground or configured as a stand with foot components, as will be described in further detail below in reference to FIGS. 15 and 16. As shown in FIG. 1 and FIG. 4, the turntable dolly base 28 is configured for rolling movement along an adjustable-level track assembly 165, and the same components may be adjusted for rolling movement along a standard straight or curved track assembly 168 which will be described in further detail below in reference to FIG. 12.

According to one embodiment, the turntable dolly base 25 comprises four cylindrical track roller modules 170 attached via brace plates 175 and concave base components 136 engaged by screws 177 with threaded holes 178 in the sides of the track roller modules' cylindrical mount components 180 and with nuts 8 in the nut channels of the tube modules 185. Demountably engaged centrally at the four inward portions of the tube modules 185 by screws 190 concave base components 136, and nuts 8, is a lockable turntable assembly 195 comprising two rotation plates 197. A threaded portion of screws 190 are passed downwardly through holes 198 in the lower rotation plate 197 and through the hole in the center of the concave base components 136 to secure the assembly against the tube modules 185 by threadedly engaging the screws with the nuts in the nut channels of the tube modules.

According to one embodiment, as shown in FIG. 1, the 3-rail vertical track assembly 28 is upwardly engaged on the lockable turntable assembly 195 via three turntable extension plates 200 by screws 205 threadedly engaged with the threaded hole 53 in the center of the threaded end components 14 at the bottom ends of the three vertical rail assemblies 32. The turntable extension plates 200 are fastened by upward screws 210/211 through holes 213/214 in the top rotation plate 197 and threadedly engaged with threaded holes 215/216 in the extension plates 200. A washer plate 220 comprising through-holes may be inserted between the top rotation plate 197 and the extension plates 200 to stiffen the assembly. Optionally, for additional reinforcement a tube module 221, as shown in FIG. 2 where extending beyond the rotation plates 197, may be demountably engaged by screws, concave base components, and nuts to the underside of one or more of the extension plates 200 or washer plates 220.

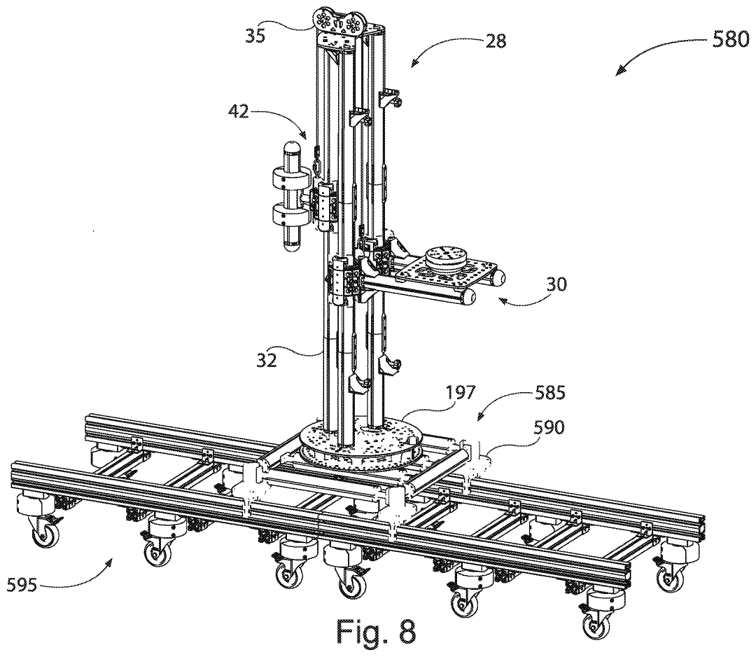

The turntable extension plates 200 may be provided to offset the vertical rail assembly 28 to effectively center the device mount plate 130 and supported device or equipment directly above the rotational axis of the lockable turntable assembly 195 when preferred by the operator. Alternatively, the bottom ends of the vertical track assembly's three vertical rails 32 may be mounted directly to the top rotation plate 197 by screws 210 through holes 213 there threadedly engaged with the central threaded hole 53 in the threaded end connectors 14 at the bottom ends of the three vertical rails 32, as will be described in further detail below in reference to FIG. 8. According to further embodiments, the vertical rails may exclude the threaded end connectors and instead their cylindrical structural components fastened to the extension plates 200 directly or via a washer component 58, as shown in FIG. 14, by screws 16 through holes 222 and into the screw slots 11, or fastened to the top rotation plate 197 directly or via the washer component 58, by screws 16 through holes 224.

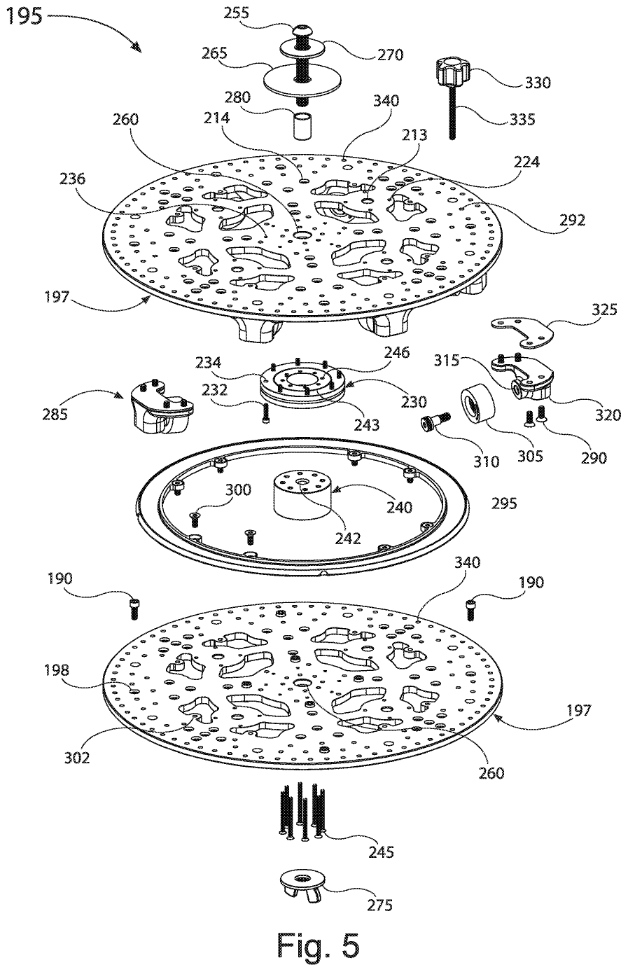

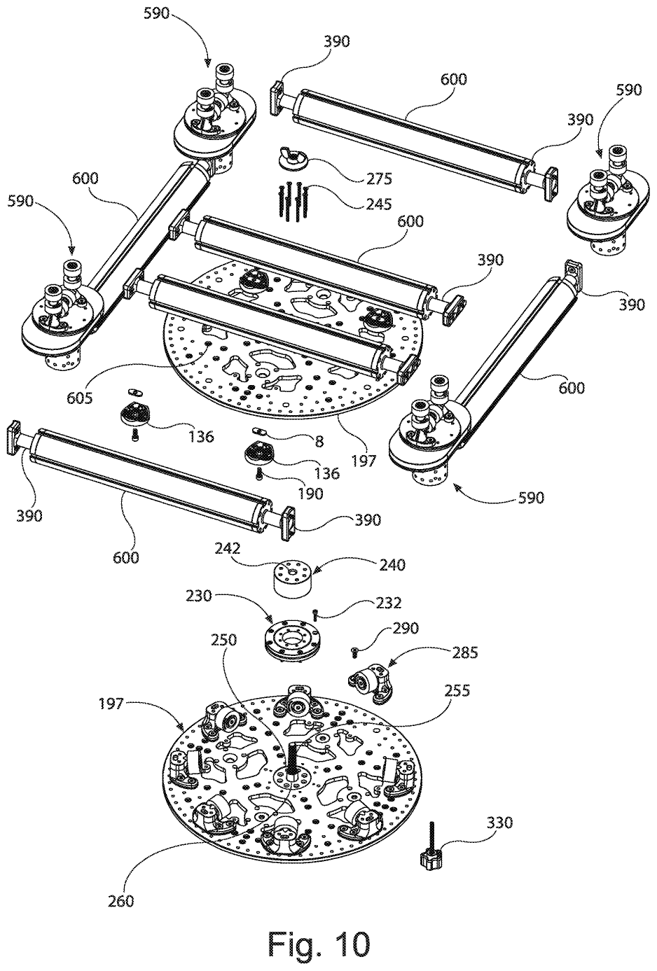

According to one embodiment as illustrated in FIG. 5, a lockable turntable assembly 195 comprises a rotational bearing 230 mounted centrally between the top and bottom rotation plates 197 allowing the top plate to rotate 360 degrees relative to the bottom plate. The rotational bearing 230 is fastened by screws 232 through holes in its outer ring 234 and there threadedly engaged with threaded holes 236 in the top rotation plate 197. A bearing retainer 240 with a central threaded hole 242 is mounted between the inner ring 243 of the bearing 230 and the bottom rotation plate 197, there fastened by screws 245 through the bottom plate and through holes in the bearing retainer 240 and threadedly engaged with threaded holes 246 in the inner ring 243 of the bearing. As indicated on the bottom view of the lockable turntable assembly 195 shown in FIG. 10 which will be described in further detail below, the rotation plates 197 further comprise a circular recess 250 which matches the diameter of the inner ring 243 of the bearing 230 so that the inner ring does not make contact with the underside of the top rotation plate 197, therefore allowing the outer ring, while fastened to the top plate, to rotate around the inner ring.

Optionally the lockable turntable assembly 195 may comprise a tension screw or bolt 255 of which a threaded portion is passed through a through-hole 260 in the center of the top rotation plate 197 and through the inner ring 243 of the bearing 230 and there threadedly engaged with the central threaded hole 242 in the bearing retainer 240. A rotation disc 265 made of a low-friction material may be installed between the head of the tension screw/bolt 255 and the top of the rotation plate 197. A washer 270 may also be included between the head of the screw/bolt 255 and the rotation disc 265. Tightening the tension screw/bolt 255 to a medium setting slows rotation of the top rotation plate 197 against the rotation disc 265, or at full tension locks rotation. A lock-nut 275 may also be provided under the bottom rotation plate 197, and the screw/bolt 255 threaded through the bearing retainer 240 to pass through the center through-hole 260 in the bottom rotation plate where the lock-nut 275 can be engaged onto the screw/bolt and against the bottom of the plate. A bushing 280 may also be optionally installed through the center through-hole 260 of the top rotation plate 197 to maintain the central alignment of the rotation disc 265.

According to some embodiments, for added stability around the rotation of the bearing 230, or optionally excluding the bearing and used as the rotation element alone, a lockable turntable assembly 195 may further comprise three or more roller elements 285 which may be fastened to the underside of the top rotation plate 197 by screws 290 threadedly engaged with threaded holes 292 in the top rotation plate, and are configured to roll in a circular path along a circular roller track inlay 295 which may be fastened to the topside of the bottom rotation plate by screws 300 threadedly engaged with threaded holes 302 in the bottom rotation plate. The roller element 285 may comprise a roller 305 rotationally engaged on an axle screw 310 which is threadedly engaged with a threaded hole 315 in a roller mount 320 which is fastened to the top rotation plate 197 by the screws 290. For reduction of noise and vibration, a non-metallic insert 325 may be included between the roller mount and the rotation plate. According to one embodiment, as illustrated, a lockable turntable assembly comprises eight roller elements. According to another embodiment, a lockable turntable assembly comprises four roller elements. According to further embodiments, a lockable turntable assembly comprises any number between three and 24 roller elements.

A lockable turntable assembly 195 may further comprise a threaded locking knob 330 with a threaded stem 335 which may provide a locking function in addition to or instead of the tension screw/bolt 255. The threaded stem 335 is threadedly engaged with one of a plurality of threaded holes 340 located radially at given increments around the two rotation plates 197. To lock rotation of the turntable assembly 195, the locking knob 330 is rotated to extend the threaded stem 335 down from the threaded hole 340 in the top plate to be threadedly engaged with a corresponding threaded hole 340 in the bottom plate 197. To unlock rotation, the locking knob is rotated in the opposite direction to retract the threaded stem 335 from the threaded hole in the bottom plate 197 to therefore allow rotation of the top plate 197, bearing 230, and supported vertical rail assembly or vertical adjustment assembly. According to one embodiment, the rotation plates 197 may comprise seventy-two threaded holes 340 to allow the plates to be locked relative to each other at 5-degree increments. According to further embodiments, rotation plates may comprise any number between four and one-hundred-eighty threaded holes.

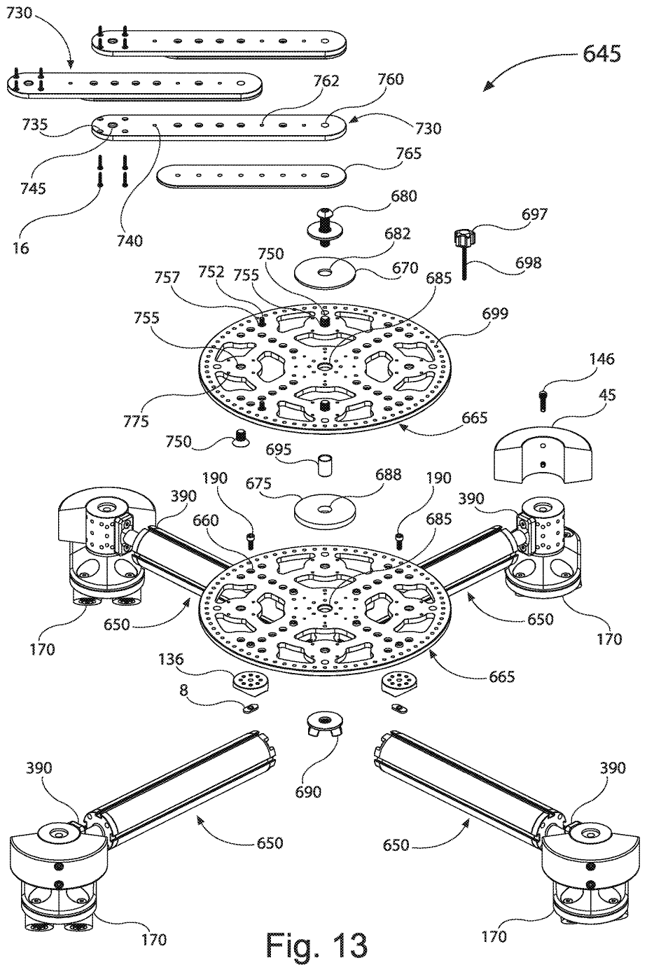

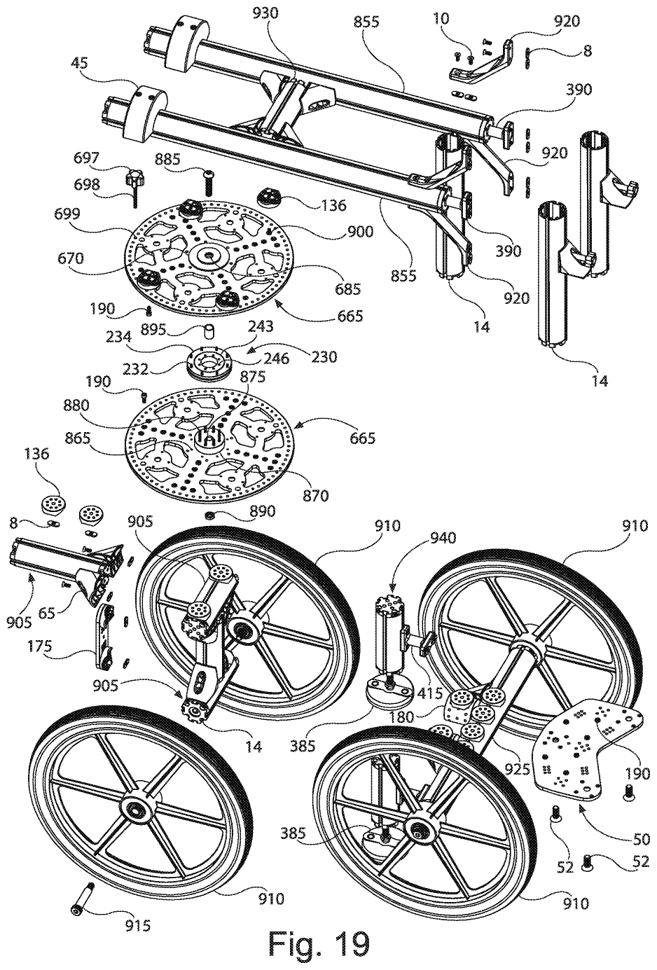

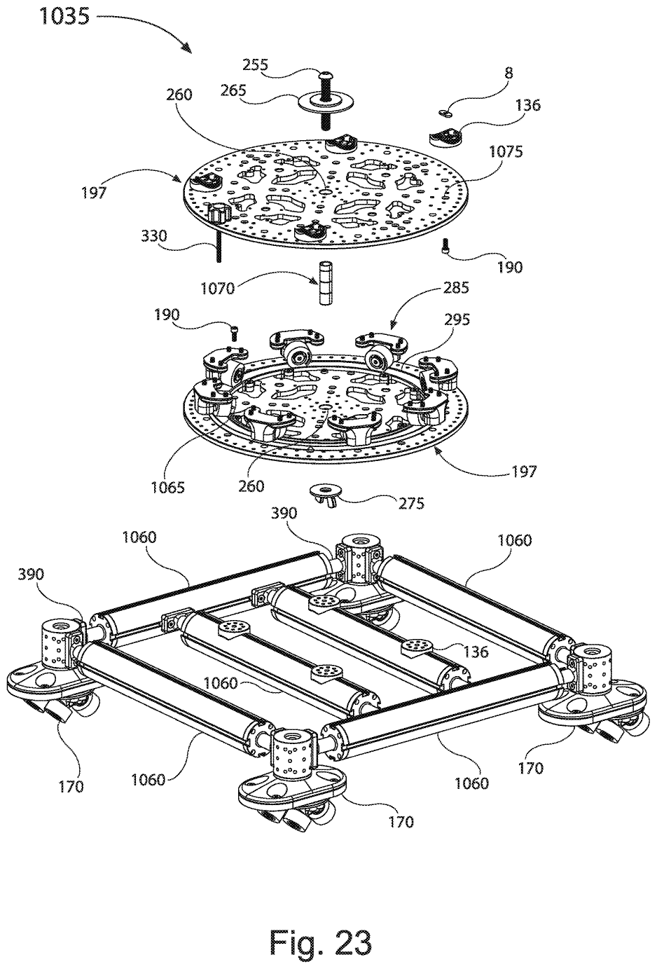

According to further embodiments, in place of the lockable turntable assembly 195, the rotational function of a vertical track dolly 22 may be provided by the lockable turntable assembly in FIG. 13 as will be described below where rotatable on a low-friction disc, or provided by the lockable turntable assembly in FIG. 19 as will be described below where rotatable on the bearing 230 alone without the roller elements 285, or provided by the lockable turntable assembly in FIG. 23 as will be described below where rotatable by only the roller elements 285.

As illustrated in FIG. 1, a track dolly may be configured for rolling movement along an adjustable-level track assembly. The base of the vertical track dolly 22 is configured as the turntable dolly base 25 with four cylindrical track roller modules 170 which travel stably along an adjustable-level track assembly 165. According to one embodiment, as shown in exploded view in FIG. 7, the adjustable-level track assembly 165 comprises two parallel horizontal rail assemblies 355 with cylindrical structural components 360 forming the rails. Each horizontal rail assembly 355 may comprise a single elongate cylindrical structural component 360 or according to some embodiments is configured to be extended or shortened by comprising two or more cylindrical structural components 360 which can be added or removed, as is illustrated in FIG. 7.

The two or more cylindrical structural components 360 may be conjoined end to end, as previously described in reference to FIG. 2, by channel braces 156 secured in the nut channels by set screws 158. A series of two or more cylindrical structural components 360 may also be conjoined by one or more cylinder external braces 160 comprising two or more through-holes and a concave face whereby it may be demountably engaged against the sides of the two corresponding cylindrical structural components 360 by screws 10 with nuts 8 in the nut channels, or in place of the nuts used in conjunction with a channel brace 156 by engaging the screws 10 with threaded holes in the channel brace 156. Horizontal rail assemblies 355 may also include corner brace connectors 65 slidingly engaged by a nut 8 in one of the nut channels to provide a track stopper element which can be repositioned along the rails, by fastening and unfastening a screw 10 or a threaded knob 162 for ease-of-use.

The horizontal rail assemblies 355 may be supported at each end by a height-adjustable track end assembly 365 demountably engaged at the ends of the rail assemblies by two corner brace connectors 65 secured laterally to the nut channels on the top and bottom of the rails and secured vertically to two vertical post tube modules 370 at the ends of a central tube module 372 secured to the center-facing nut channels of the vertical post tube modules 370 by two corner brace connectors 65. At the bottom of each vertical post tube module 370 is a threaded end connector 14 whereby a long threaded-stem caster 375 is threadedly engaged by its threaded stem 377 and can be extended or retracted into the cylindrical structural component 380 of the modules 370 to raise or lower its corner of the track assembly 165. In combination with adjustment of the casters 375 on the other vertical post modules 370, the track assembly can be raised and lowered and levelled. According to further embodiments, the casters 375 may be replaced by long threaded-stem foot components 385 as will be described in further detail below with reference to FIGS. 15 and 16. The casters 375 or the foot components 385 may include a lock-nut 387 and a washer 388 on the threaded stem 377 which may be used to lock the stem position to prevent unwanted rotation of the components during operation.

In addition to height-adjustment and levelling provided by the threaded-stem casters 375, the ends of the horizontal rail assemblies 355 can be raised and lowered along the vertical post modules 370 by loosening the screws or threaded knobs 162 of the corner brace connectors 65 where engaged with nuts 8 in the nut channels of the vertical cylindrical structural components 380 and repositioning the connectors 65 and retightening the screws or threaded knobs at the new vertical position along the modules 370. According to further embodiments, the two corner brace connectors 65 at each end of the rails can be replaced by a cylinder gooseneck end connector 390, as will be described in further detail below.

According to some embodiments and as shown in FIG. 7, the horizontal rail assemblies 355 may be additionally supported by one or more of a height-adjustable cross-support assembly 395 comprising two vertical post tube modules 400 each having at the bottom a threaded end connector 14 whereby a long threaded-stem caster 375 may be threadedly engaged and can be extended or retracted into the cylindrical structural components 405 of the tube modules to raise or lower them as additional points of contact with the ground for support and levelling and height-adjustment of the track assembly. According to further embodiments, the casters 375 may again be replaced by the long threaded-stem foot components 385 shown in FIGS. 15 and 16.

A short horizontal cylindrical structural component 410, having at each end a cylinder gooseneck end component 390 secured by screws 16 to the component's screw slots 11, bridges the two vertical post modules 400. According to one embodiment, the two horizontal rail assemblies 355 are demountably engaged to the vertical post modules 400 by an inwardly mounted perpendicular gooseneck connector 415 secured by screws and nuts 8 in the nut channels of the corresponding cylindrical structural components 360/405. The perpendicular gooseneck connectors 415 have a low profile and space the vertical post modules away from the horizontal rails such that they remain passable by the track roller modules 170. In addition to height-adjustment and levelling which may be provided by the threaded-stem casters 375 or threaded-stem foot components 385, each end of the cross-support assembly 395 may also be raised and lowered at one or both ends by loosening the screws of the perpendicular gooseneck connectors 415, where engaged with nuts 8 in the channels of the vertical cylindrical structural components 405, and then repositioning the connectors 415 and retightening the screws at the new vertical position along the vertical post modules.

For ease of mobility of the adjustable-level track assembly 165, one or more push handle assemblies 420 may be demountably engaged with one or both of the track end assemblies 365. According to one embodiment, the push handle assembly 420 comprises a tube module 425 demountably engaged by two corner brace connectors 65 to a central tube module 372 of one of the track end assemblies 365. The push handle assembly may further comprise a soft threaded end component 148 and bumper component 152 for handling at the top end of the module 425. According to a further embodiment, the two corner braces 65 may be replaced by a cylinder gooseneck end component 390 for demountable engagement of the push handle assembly 420 to the central tube module 372.

As previously noted, the turntable dolly base 25 is configured to stably roll along the adjustable-level track assembly 165 on four cylindrical track roller modules 170 demountably engaged at the ends of the tube modules 185 there secured by brace plates 175 and concave base components 136 engaged by screws 177 threadedly engaged with threaded holes 178 in the sides of the track roller modules' cylindrical mount components 180. According to a further embodiment, track roller modules 170 may be secured to the end of a cylindrical structural component via a cylinder gooseneck end connector 390 by screws threadedly engaged with threaded holes 430 in the cylindrical mount component 180, as will be described in further detail below in reference to FIGS. 12 and 13.

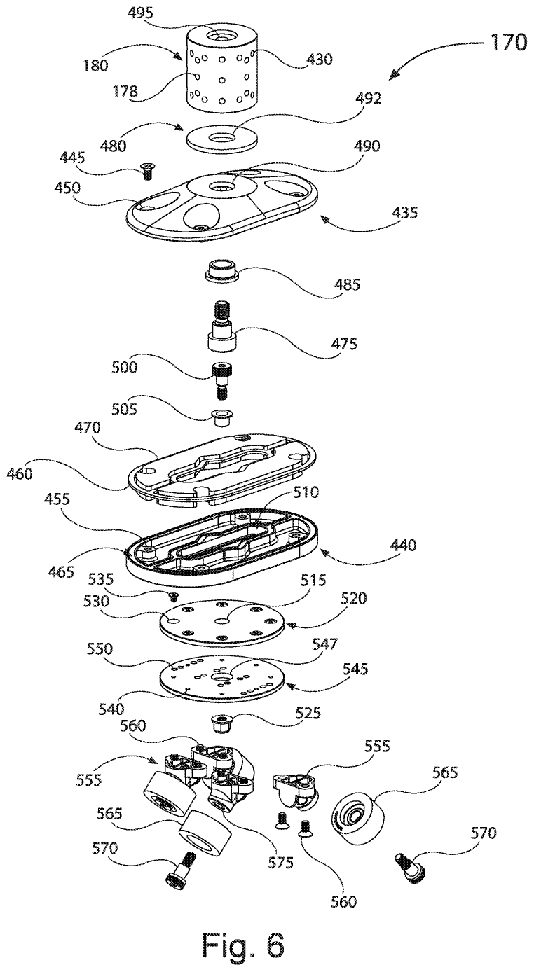

According to one embodiment, as illustrated in FIG. 6, a cylindrical track roller module 170 further comprises an upper body component 435 and a lower body component 440 which are secured to one another by screws 445 through holes 450 in the upper body component and threadedly engaged with threaded holes 455 in the lower body component. For operational noise and vibration reduction, a foam or rubber gasket component 460 may be included in a recess 465 between the contact areas of the upper and lower body components, and foam or rubber inserts 470 may be included in the hollow areas of the body components.

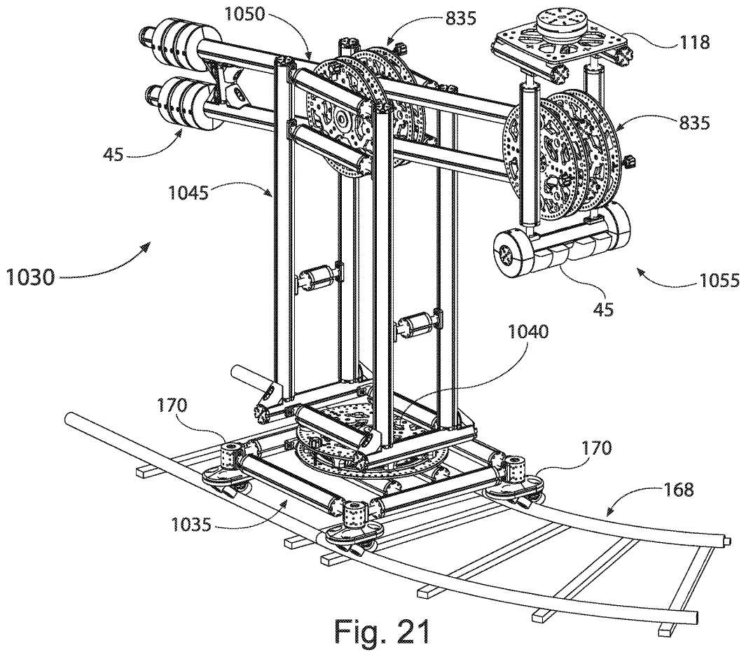

The upper body component 435 is secured by an upper pivot shoulder screw 475 to the cylindrical mount component 180 via a low-friction upper pivot disc 480 between the two components which allows them to pivot 360 degrees relative to one another where required for rolling movement along a curved rail or curved track assembly 168 as will be described in further detail below in reference to FIG. 12 and FIG. 21. An upper bushing 485 is installed on the shoulder of the shoulder screw 475 and the two components are situated in a recessed interior of the upper body component 435 and in a through-hole 490 in its center from which the threaded portion of the shoulder screw passes through a through-hole 492 in the pivot disc 480 and is threadedly engaged with a threaded hole 495 through the center of the cylindrical mount component 180. At an appropriate tension of the shoulder screw 475, the parts are retained while allowing rotation of the cylindrical mount component 180 rotating against the upper pivot disc 480 and the upper shoulder screw 475 rotating within the upper bushing 485.

The track roller module 170 further comprises a lower pivot shoulder screw 500 which is pivotably retained in a lower bushing 505 which is slidingly and pivotably retained within an elongate slot 510 which runs through a center portion of the lower body component 440. The threaded portion of the lower pivot shoulder screw 500 there extends from the bottom of the body component and through a through-hole 515 in the center of a low-friction lower pivot disc 520 and there secured by a lock-nut 525 which is threadedly engaged with the shoulder screw and fastened against the bottom of the disc 520. The lower pivot disc 520 further comprises through-holes 530 with recesses on the top side for fully containing the heads of screws 535 of which the threaded portions extend from the bottom of the lower pivot disc and are threadedly engaged with threaded holes 540 in a roller mount plate 545 which further comprises a lock-nut hole 547 greater than the diameter of the lock-nut 525 so that the two components do not interfere with each where located against the bottom of the lower pivot disc 520. The roller mount plate 545 may also include a plurality of sets of track diameter-adjustment roller mount holes 550 at which at least two cylindrical track roller mounts 555 are fastened by screws 560 threadedly engaged with the roller mount holes 550. A roller 565 is rotationally engaged on an axle screw 570 which is threadedly engaged with a threaded hole 575 in the roller mounts 555. Where needing to be reconfigured for compatibility with differing diameters of cylindrical rails and track assemblies such as the adjustable-level track assembly 165 in FIGS. 1 and 7 or a curved track assembly 168 such as in FIGS. 12 and 21, the operator may unfasten the screws 560 and realign the roller mounts 555 at a different set of the holes 550 and refasten the screws for the modules 170 to be reconfigured for the alternative separation provided between the corresponding rollers.

Where operating on a curved rail or curved track assembly 168, the combination of the pivoting movement of the upper body component assembly with the pivoting and sliding movement of the lower body component assembly at the contact surface of the lower bushing 505 within the slot 510 and the top surface of the lower pivot disc 520 against the bottom surface of the lower body component 440, the track roller modules 170 are configured to smoothly traverse the curvatures and shifting alignments of the track roller modules on the curved rails.

According to further embodiments, a vertical track dolly or a height-adjustable dolly may be configured on track roller modules for rolling movement along square rails or track assemblies or rectangular rails or track assemblies. As illustrated in FIGS. 8 to 11, a vertical track dolly 580 comprising a turntable dolly base 585 is configured with four square track roller modules 590 for rolling movement along a rectangular rail track assembly 595 comprising two or a series of parallel rectangular rail segments supported by casters or foot components and cross-segments fastened to the rails by square brackets. The vertical track dolly 580 further comprises the 3-rail vertical track assembly 28, as previously described in reference to FIG. 2, demountably engaged directly to the top rotation plate 197 of the turntable dolly base 585, allowing for rotatable and vertical movement of the device mount assembly 30 and a supported device or equipment.

According to one embodiment, as shown in FIGS. 8 to 11, the turntable assembly of the turntable dolly base 585 is configured the same as the lockable turntable assembly 195, as previously described. According to one embodiment, as shown, the bottom ends of the vertical track assembly's three vertical rails 32 may be mounted directly to the top rotation plate 197 by screws 210 through holes 213 there threadedly engaged with the central threaded hole 53 in the threaded end connectors 14 at the bottom ends of the three vertical rails 32. Alternatively, as previously described in reference to FIG. 4, the vertical track assembly 28 may be demountably engaged via the turntable extension plates 200 to offset the vertical rail assembly to effectively center a supported device or equipment directly above the rotational axis of the turntable dolly base 585. According to further embodiments, the vertical rails 32 may exclude the threaded end connectors 14 and instead their cylindrical structural components fastened to the extension plates 200 directly or via a washer component 58, as shown in FIG. 14, or fastened to the top rotation plate 197 directly or via the washer component 58, by screws 16 through holes 224.

According to further embodiments, in place of the lockable turntable assembly 195, the rotational function of a vertical track dolly 580 may be provided by the lockable turntable assembly in FIG. 13 as will be described below in reference where rotatable on a low-friction disc, or provided by the lockable turntable assembly in FIG. 19 as will be described below where rotatable on the bearing 230 alone without the roller elements 285, or provided by the lockable turntable assembly in FIG. 23 as will be described below where rotatable by only the roller elements 285.

The turntable dolly base 585 further comprises, according to one embodiment, a base frame assembled of six cylindrical structural components 600, having at each end a cylinder gooseneck end component 390, as previously described, secured by screws to the component's screw slots. The four outer cylindrical structural components form the outer frame of the dolly base, at the corners of which the four square track roller modules 590 are demountably engaged with the cylinder gooseneck end components 390. The two inner cylindrical structural components 600 span the middle of the dolly base whereon the lockable turntable assembly 195 is demountably engaged at through-holes 605 by screws 190, concave base components 136, and nuts 8 threadedly engaged by the screws within the nut channels of the cylindrical structural components.

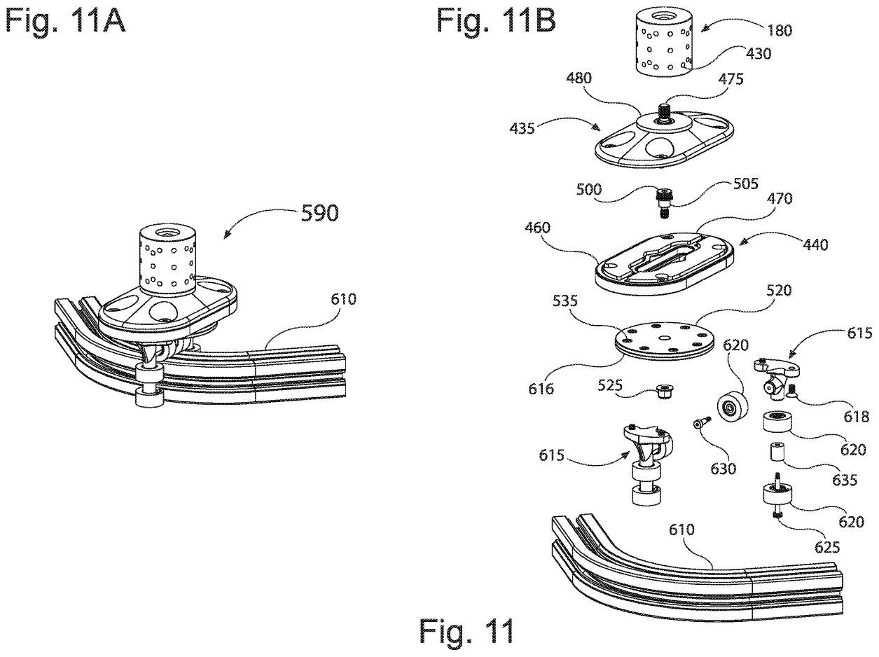

As previously noted, the square track roller modules 590 are specially configured for rolling movement along the rectangular rail track assembly 595 or other straight or curved square or rectangular rails or track assemblies such as a curved square rail component 610 as shown in FIG. 11. According to one embodiment, the square track roller modules 590 may comprise two square rail roller mounts 615 fastened to the bottom of a roller mount plate 616 by screws 618 threadedly engaged with threaded holes in the roller mount plate 616, which is upwardly mounted by the screws 535 to the lower pivot disc 520 and thereby the other components of the modular assembly as previously described in reference to FIG. 6. The square rail roller mounts 615 each comprise two rollers 620 attached downwardly by a vertical shoulder screw 625, in addition to one roller 620 attached inwardly by a horizontal shoulder screw 630. The two downward rollers 620 may be spaced for alignment and best contact with the sides of a straight or curved square rail component by a spacer 635 having a through-hole corresponding with the shoulder screw 625 and axle holes of the rollers 620. The square track roller modules 590 thereby maintain directional alignment atop one or an assembled series of square or rectangular rail components such as in the rectangular rail track assembly 595 in FIG. 8 or the curved square rail component 610.

As like the cylindrical track roller modules 170, the square track roller modules 590 comprise the cylindrical mount component 180 whereby the modules are demountably engaged to the cylinder gooseneck end components 390 at the corners of the dolly base frame by screws 10 threadedly engaged with threaded holes 430 in the cylindrical mount components. As noted above, the square track roller modules 590 also further comprise the previously described assembly of upper and lower body components 435/440, pivot discs 480/520, shoulder screws 475/500, and bushings 485/505 which together allow the square track roller modules 590 to pivot and slide for curvatures and shifting alignments of the modules where operating along curved rails.

According to further embodiments, an assortment of the modular support components may further be configured as a height-adjustable dolly for rolling and pivoting a supported device or equipment within a selectable range of height. As illustrated in FIGS. 12 to 14, a height-adjustable dolly 640 may comprise a turntable dolly base 645 with four tube modules 650 demountably engaged inwardly with the underside of a lockable turntable assembly 655, and outwardly with four cylindrical track roller modules 170 attached as previously described to four cylinder gooseneck end connectors 390 of the tube modules 650. According to further embodiments where operating without the need for a track assembly, a height-adjustable dolly 640 or turntable dolly base 645 may exclude the track roller modules and alternatively be moved about and positioned and levelled on casters 375 such as those shown in FIG. 7 or foot components 385 such as those shown in FIG. 15.

The cylindrical track roller modules 170 of the turntable dolly base 645 are configured for rolling movement along a track assembly with straight and curvilinear sections of cylindrical rails. The track roller modules 170 comprise the components as described in reference to FIG. 6 but in which here the roller mounts 555 have been positioned inwardly on the roller mount plate 545 to space the rollers 565 for proper contact along the narrower diameter rails of a curved track assembly 168. Optionally, for added balance and stability, weight components 45, as previously described in reference to FIG. 2, are demountably engaged by screws 146 threadedly engaged with threaded holes in the side of the roller modules' cylindrical mount components 180.

As illustrated in FIG. 13, the inward ends of the tube modules 650 are demountably engaged with the underside of the lockable turntable assembly 655 by screws 190 through holes 660 in the lower of two rotation plates 665 and through concave base components 136 and threadedly engaged with nuts 8 in the nut channels of the tube modules 650. The lockable turntable assembly 655 rotates 360 degrees without the use of the bearing 230 or roller elements 285 as previously described. According to this embodiment, the top rotation plate 665 is rotatable 360 degrees within an upper low-friction disc 670 against its top surface and a lower low-friction disc 675 below between it and the bottom rotation plate 665. A rotation tension screw or bolt 680 passes through a central through-hole 682 in the upper disc 670, a through-hole 685 in the center of the top rotation plate 665, a central through-hole 688 in the lower disc 675, the through-hole 685 in the center of the bottom rotation plate 665, and is threadedly engaged with a lock-nut 690 which is fastened against the bottom surface of the bottom rotation plate. Optionally, a washer may be included between the lock-nut and the bottom rotation plate. A bushing 695 may be included in the through-holes and around the tension screw/bolt 680 for maintaining the center alignment and smooth rotation of the assembly. The screw/bolt 680 and lock-nut 690 may be fastened at an appropriate tension to allow the top rotation plate 665 to continue to rotate between the discs 670/675 or be fully engaged to temporarily lock the assembly.

A lockable turntable assembly 655 may further comprise a threaded locking knob 697 with a threaded stem 698 which may provide an additional locking function. The threaded stem 698 is threadedly engaged with one of a plurality of threaded holes 699 located radially at given increments around the two rotation plates 665. To lock rotation of the turntable assembly 655, the locking knob 697 is rotated to extend the threaded stem 698 down from the threaded hole 699 in the top plate to be threadedly engaged with a corresponding threaded hole 699 in the bottom plate. To unlock rotation, the locking knob is rotated in the opposite direction to retract the threaded stem 698 from the threaded hole in the bottom plate to therefore allow rotation of the top plate. According to one embodiment, the rotation plates 665 may comprise seventy-two threaded holes 699 to allow the plates to be locked relative to each other at 5-degree increments. According to further embodiments, rotation plates may comprise any number between four and one-hundred-eighty threaded holes.

As illustrated in FIG. 14, the height-adjustable dolly 640 further comprises a vertical adjustment assembly 700 whereby a device mount assembly 705 is vertically positioned along two vertical posts 710. The vertical adjustment assembly 700 may further comprise a third rear vertical post 710 for stability. The vertical posts comprise one or a series of two or more cylindrical structural components 713 secured together by one or more of the channel braces 156 and/or one or more of the cylinder external braces 160 as previously described. The top ends of the vertical posts 710 may be secured to a mounting plate 715 attached directly or via a washer component 58 by screws 16 through holes 720 threadedly engaged with the screw slots 11 of the vertical posts' cylindrical structural components 713. Optionally, the vertical posts 710 can be reinforced against the mounting plate 715 by corner brace connectors 65 fastened by a screw 70 to a threaded hole 722 in the mounting plate via a flat insert 80 to adapt the corresponding concave side of the corner brace to the flat bottom of the mounting plate, as previously shown in FIG. 2. According to a further embodiment, the vertical posts 710 may further comprise threaded end connectors 14 at the top ends of the posts and, instead of the screws 16, secured to the mounting plate by screws 52 through holes 725 and threadedly engaged with the threaded hole 53 in the center of the threaded end components 14.

The device mount assembly 705 may comprise a bow/ball mount assembly 119 or other device interfacing mount component such as a fluid-head mount or a ball-and-socket joint mount 131 as shown in FIGS. 24, 25, and 27 whereon a device such as a camera, lighting equipment, sound recording equipment, audio/visual equipment, sensor, robotic gimbal, robotic arm, power tool, or other equipment may be demountably engaged via the device mount plate 118 or directly on a tube module. According to one embodiment, a supported device bowl/ball mount assembly 119 and device mount plate 118 are fastened to the two tube modules 116 which are demountable engaged by screws with nuts 8 in the nut channels of the vertical posts 710 whereby the device mount assembly 705 and supported device or equipment may be repositioned along the vertical posts.

According to one embodiment, as illustrated in FIGS. 12 and 14, the vertical adjustment assembly 700 is upwardly engaged on the lockable turntable assembly 655 via three turntable extension plates 730 by screws 16 through holes 735 in the extension plates and threadedly engaged with the screw slots 11 in the cylindrical structural components 713 of the vertical posts 710. Optionally, the vertical posts 710 can be reinforced against the extension plates 730 each by a corner brace connector 65 fastened by a screw 70 to a threaded hole 740 in the extension plate via a flat insert 80. According to a further embodiment, the vertical posts 710 may further comprise threaded end connectors 14 at the bottom ends and, instead of the screws 16 as shown, be secured to the extension plates 730 by bolts or screws 750 through holes 745 and threadedly engaged with the threaded end components 14.

The turntable extension plates 730 may be demountably engaged with the top rotation plate 665 by upward screws 750/752 through holes 755/757 in the top rotation plate 665 and threadedly engaged with threaded holes 760/762 in the extension plates. A washer plate 765 comprising through-holes may be inserted between the top rotation plate and the extension plates to stiffen the assembly. Optionally, for additional reinforcement a tube module 770, where extending beyond the rotation plates 665, may be demountably engaged by screws, concave base components, and nuts to the underside of one or more of the extension plates or washer plates.

The extension plates 730 thereby offset the vertical posts 710 and device mount assembly 705 and a supported device or equipment to effectively center the device or equipment directly above the rotational axis of the lockable turntable assembly 655. According to further embodiments, the bottom ends of the vertical posts 710 may be mounted without the extension plates 730 directly to the top rotation plate 665 by screws 16 through holes 775 fastened to screw slots 11, or by screws 750 through holes 755 according to embodiments where the vertical posts include threaded end connectors 14 and there threadedly engaged with the central threaded holes 53 in the end connectors, so that the device mount assembly 705 and supported device or equipment rotate at an extended position out from the rotational axis of the lockable turntable assembly 655.

According to further embodiments, in place of the lockable turntable assembly 655, the rotational function of a height-adjustable dolly 640 may be provided by the lockable turntable assembly 195 as previously described in reference to FIGS. 5 and 10 where rotatable on the bearing 230 and the roller elements 285, or provided by the lockable turntable assembly in FIG. 19 as will be described below where rotatable on the bearing 230 alone without the roller elements 285, or provided by the lockable turntable assembly in FIG. 23 as will be described below where rotatable by only the roller elements 285.

According to further embodiments, an assortment of the modular support components may further be configured as an adjustable-level tripod stand for positioning and moving a device within a selectable range of height. As illustrated in FIGS. 15 and 16, an adjustable-level tripod stand 780 may comprise a further embodiment of a lockable turntable assembly 785 with one of the rotation plates 665 as previously described and three tube modules 790 demountably engaged with a cylindrical mount component 180 below. The inward ends of the tube modules each comprise the cylinder gooseneck end connectors 390 which are demountably engaged by screws 10 fastened to the threaded holes 430 of the central cylindrical mount component 180 which here embodies the lower static element of the turntable assembly 785.

The outward ends of the tube modules 790 also comprise the cylinder gooseneck end connectors 390 each also fastened to a cylindrical mount component 180 in each of which is a long threaded-stem foot component 385 threadedly engaged by its threaded stem 795 in the central threaded hole 495 of the cylindrical mount components. According to further embodiments where increased mobility is preferred, the foot components 385 may be replaced by the long threaded-stem casters 375. An adjustable-level tripod stand 780 can thereby be levelled by individually adjusting the vertical positions of their three threaded stems 795 in the mount components 180 depending on the slope of the ground. The foot components or the caster components may include a lock-nut 797 and a washer 798 on the threaded stem which may be used to lock the stem position to prevent unwanted rotation of the components during operation. The foot components 385 may further comprise a ball-and-socket joint 799 between the bottom end of the threaded stem 795 and the base of the foot whereby the base is pivotable for best engagement with the ground.

As illustrated in FIG. 15, an adjustable-level tripod stand 780 may further comprise a vertical track assembly 28, a device mount assembly 30, and a counterweight carriage assembly 42, as previously described in reference to FIG. 2, or in further embodiments a vertical adjustment assembly 700 and device mount assembly 705, as previously described in reference to FIG. 14, whereby a supported device or equipment may be positioned or moved vertically and rotated 360 degrees on the turntable assembly 785. The bottom end of a vertical track assembly or a vertical adjustment assembly may be secured to the rotation plate 665 by upward screws 750 through holes 755 where the ends include threaded end components 14, or according to further embodiments, attached directly or via a washer component 58 by screws 16 through holes 775 threadedly engaged with the screw slots 11 of the vertical assemblies' cylindrical structural components. According to further embodiments, the vertical track assembly or vertical adjustment assembly may be demountably engaged to the lockable turntable assembly 785 via turntable extension plates 730 fastened to the rotation plate 665 by screws as previously described in reference to FIGS. 13 and 14.

According to this embodiment, the rotation plate 665 is rotatable 360 degrees within an upper low-friction disc 800 against its top surface and a lower low-friction disc 805 below between it and the cylindrical mount component 180. A rotation tension screw or bolt 810 passes through a central through-hole 815 in the upper disc 800, the through-hole 685 in the center of the rotation plate 665, a central through-hole 820 in the lower disc 805, and there threadedly engaged with the central threaded hole 495 in the cylindrical mount component 180. Optionally, a washer may be included between the screw/bolt head and the upper disc 800. The screw/bolt 810 may be fastened at an appropriate tension to allow the rotation plate 665 to continue to rotate between the discs 800/805 or be fully engaged to temporarily lock the assembly. Optionally the screw/bolt may be long enough to extend through the cylindrical mount component 180 to where it can be threadedly engaged by a lock-nut 825 against the bottom surface of the mount component to more securely lock the turntable assembly 785. Optionally, a washer may be included between the lock-nut 825 and mount component. A bushing 828 may be included in the through-holes and around the tension screw/bolt 810 for maintaining the center alignment and smooth rotation of the assembly.

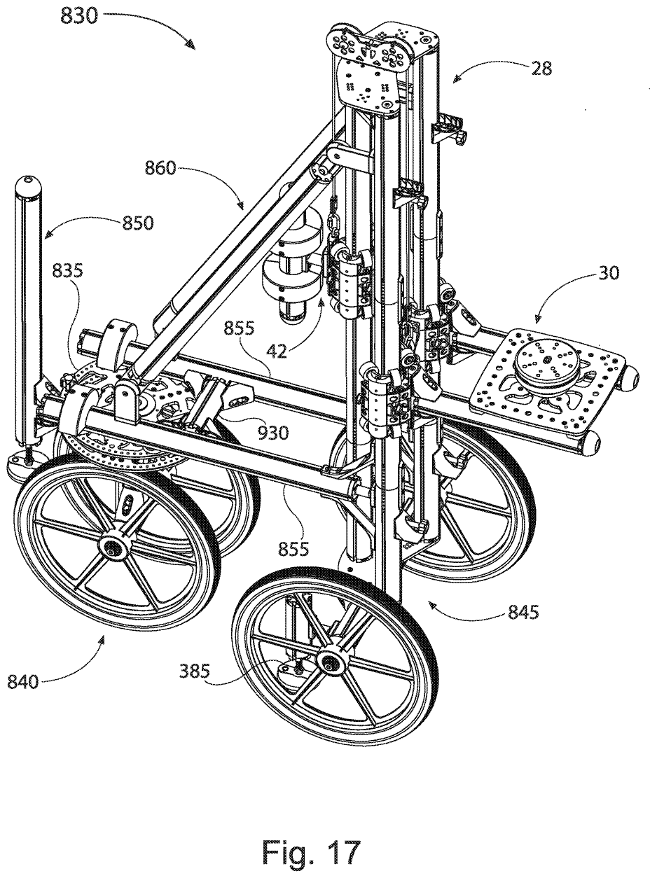

According to further embodiments, an assortment of the modular support components may further be configured as a steerable vertical track dolly or a steerable height-adjustable dolly for controllably rolling a supported device or equipment within a selectable range of height along the vertical modules. As illustrated in FIGS. 17 to 19, a steerable vertical track dolly 830 comprises a further embodiment of a lockable turntable assembly 835 configured for steering a rotating rear axle assembly 840 and rear wheels of the dolly whereby a device mount assembly 30, counterweight carriage assembly 42, and vertical track assembly 28 supported on a front axle assembly 845 can be directionally moved by turning the rear axle assembly 840 and pushing the dolly using a handle assembly 850. The rotating rear axle assembly 840 is attached via the lockable turntable assembly 835 near the rear ends of two horizontal chassis tube modules 855 and to which the vertical track assembly 28 is attached to the front ends.

The steerable dolly 830 may further comprise three long threaded-stem foot components 385 whereon the dolly may be temporarily positioned and levelled. Optionally, depending on the selected height of the vertical track assembly 28 and weight of the device mount assembly 30 and supported device or equipment, the steerable dolly may also comprise one or two of a diagonal support tube module 860 spanning between one or both of the horizontal chassis tube modules 855 and the corresponding vertical rail 32. According to additional embodiments, in place of the vertical track assembly 28, device mount assembly 30, and counterweight carriage assembly 42, a steerable dolly may instead comprise the vertical adjustment assembly 700 and device mount assembly 705, as previously described. Optionally, for added stability a steerable dolly 830 may further comprise one or more weight components 45 may be demountably engaged by screws with nuts in the nut channels along the chassis tube modules 855 or another tube module of the base of the dolly to counterbalance the weight of the vertical track assembly 28 and supported components, or of the vertical adjustment assembly 700 and supported components.

According to one embodiment, as illustrated in FIG. 19, the lockable turntable assembly 835 comprises two of the rotation plates 665 whereby a rotational bearing 230 is engaged allowing the bottom plate 665 to rotate 360 degrees relative to the top plate. The rotational bearing 230 is fastened by screws 232 through holes in its outer ring 234 and there threadedly engaged with threaded holes 865 in the top rotation plate 665 (shown indicated on the matching bottom rotation plate). A bearing retainer 870 with a central threaded hole 875 is mounted between the inner ring 243 of the bearing 230 and the bottom rotation plate 665, there fastened by screws 880 through the bottom plate and through holes in the bearing retainer 870 and threadedly engaged with threaded holes 246 in the inner ring of the bearing 230. As like the circular recess 250 on the previous embodiment of rotation plate 197 as indicated in FIG. 10, the rotation plate 665 also comprises a circular recess which matches the diameter of the inner ring of the bearing 230 so that the inner ring does not make contact with the underside of the top rotation plate 665, therefore allowing the outer ring, while fastened to the top plate, to rotate around the inner ring 243.

The lockable turntable assembly 835 may further comprise the threaded locking knob 697 with threaded stem 698 which may provide a locking function by threadedly engaging and disengaging the threaded stem 698 in one of the plurality of the threaded holes 699 located radially at given increments around the two rotation plates 665, as previously described in reference to FIG. 13.

Optionally, the lockable turntable assembly 835 may comprise a tension screw or bolt 885 of which a threaded portion is passed through the through-hole 685 in the center of the top rotation plate 665 and through the inner ring of the bearing 230 and there threadedly engaged with the central threaded hole 875 in the bearing retainer 870. The low-friction rotation disc 670 may be installed between the head of the tension screw/bolt 885 and the top of the rotation plate 665. A washer may also be included between the head of the screw/bolt 885 and the rotation disc 670. Tightening the tension screw/bolt 885 to a medium setting slows rotation of the bottom rotation plate 665 moving with the screw/bolt 885 and the rotation disc 670 sliding against the static upper rotation plate 665, or at full tension locks rotation. A lock-nut 890 may be provided under the bottom rotation plate 665, and the screw/bolt 885 threaded through the bearing retainer 240 to pass through the center through-hole 685 in the bottom rotation plate where the lock-nut 890 can be engaged onto the screw/bolt and against the bottom of the plate. A bushing 895 may also be optionally installed through the center through-hole 685 of the top rotation plate 665 to maintain the central alignment of the rotation disc 670.

According to further embodiments, in place of the lockable turntable assembly 835, the steering function of a steerable dolly 830 may be provided by the lockable turntable assembly 195 as previously described in reference to FIGS. 5 and 10 where including the bearing 230 and the roller elements 285, or provided by the lockable turntable assembly 655 as previously described in reference to FIG. 13 where rotatable on a low-friction disc 675, or provided by the lockable turntable assembly in FIG. 23 as will be described below where rotatable by only the roller elements 285.

As illustrated in FIG. 19 according to one embodiment comprising the lockable turntable assembly 835, the upper rotation plate 665 is demountably engaged by screws 190 of which a threaded portion is passed through a hole 900 in the rotation plate and through the center of the concave base components 136 and threadedly engaged with nuts 8 within the nut channels on the underside of the chassis tube modules 855. According to one embodiment, the top end of the rear axle assembly 840 is formed by two short tube modules 905 attached perpendicularly by corner brace connectors 65 and whereby the bottom rotation plate 665 is demountably engaged by screws 190, concave base components 136, and nuts 8. Attached downwardly by corner brace connectors 65 from the upper centered tube module 905 is two additional perpendicular tube modules 905 attached by corner brace connectors 65 and whereby in the bottom horizontal module two wheels 910 are rotationally engaged by an axle screw or bolt 915 threadedly engaged with a threaded end connector 14 in each end of the horizontal module. Optionally, a brace plate 175 may be secured by screws and concave base components to the horizontal axle tube module and the adjacent vertical tube module for additional reinforcement.

According to one embodiment, the vertical track assembly 28 or vertical adjustment assembly 700 is attached securely to the front ends of the horizontal chassis tube modules 855 by a cylinder gooseneck end connector 390 at the end of each module, as well as one or more of a narrow corner brace component 920 demountably engaged by screws 10 with nuts 8 within a nut channel in the underside and/or topside of one or both of the chassis modules 855 and within the perpendicular nut channel of the corresponding cylindrical structural component of the vertical track assembly or vertical adjustment assembly. Where in use in conjunction with the three-sided roller carriage assemblies 38 on a vertical track assembly 28 as previously described in reference to FIG. 2, the gooseneck end connectors 390 and the narrow corner brace components 920 provide a narrow profile and space the chassis modules away from the vertical rails such that they remain passable by the roller carriage assemblies.

According to one embodiment, as illustrated, the bottom ends of the vertical rail assemblies 32 connect the horizontal chassis tube modules 855 down to the front axle assembly 845 where the rails may be demountably engaged by upward screws 52 through holes in a lower mounting plate 50 threadedly engaged with the rails' threaded end connectors 14 as shown, or by screws 16 directly with the rails' screw slots 11 in embodiments where excluding the threaded end connectors. The mounting plate is there demountably engaged by downward screws 190 through holes in the mounting plate and concave base components 136 and threadedly engaged with nuts in the nut channels of a front axle tube module 925 and the threaded holes in two perpendicular cylindrical mount components 180 which are attached to the front tube module 925 by corner brace connectors 65. The front tube module 925 has a threaded end connector 14 at each end whereby the two front wheels 910 are rotationally engaged by two axle screws or bolts 915.

An operator may choose to reconfigure the steerable dolly from the front-facing rails and device mount assembly to side-facing rails and device mount assembly by disengaging the channel braces 156 and cylinder external braces 160 that conjoin the bottom sections of the rails from the top sections, and then demountably engaging the top sections in a sideway direction using corner brace connectors 65 along the horizontal chassis tube modules 855 and with the center back rail mounted to the short tube module 930 which bridges between the two chassis tubes and which can be repositioned anywhere along them on its corner brace connectors 65 for alignment with the vertical rails.

As noted above, an operator may push and steer the dolly 830 using the steering handle assembly 850. According to one embodiment, the steering handle assembly 850 comprises a tube module 935 demountably engaged by two corner brace connectors 65 to the axle assembly's rear tube module 905. The handle assembly may further comprise a soft threaded end component 148 and bumper component 152 for handling at the top end of the module 935. According to a further embodiment, the two corner braces 65 may be replaced by a cylinder gooseneck end component 390 at the end of the rear tube module 905. One or more additional tube modules may be included attached perpendicularly to the tube module 935 to form a T-shaped handle and other forms.

According to one embodiment, the horizontal chassis tube modules 855, the lockable turntable assembly 835, and the rear axle assembly 840 are configured in such a way that the wheels 910 remain fully passable under the chassis modules so that the wheels may be turned at least 90 degrees in both directions allowing the steerable dolly 830 to perform tight turning radiuses.

The steering handle assembly 850 may further comprise at the bottom end a threaded end connector 14 whereby a long threaded-stem foot component 385 may be threadedly engaged along its threaded stem 795 to be extended from and retracted in to the module for adjusting its length to optionally make contact with the ground whereby, in conjunction with two threaded foot components 385 attached to the front axle tube module 925, the steerable dolly 830 can be temporarily positioned and levelled. According to one embodiment, the front two foot components 385 are threadedly engaged each with the threaded end connector 14 at the bottom of a short tube module 940, each of which is demountably engaged with the front axle by a perpendicular gooseneck component 415. In addition to threadedly adjusting the three foot components in and out of their respective tube modules, they may also be adjusted toward and away from the ground by changing their modules' positions on their respective corner brace connectors 65 and perpendicular gooseneck connectors 415, which in totality provide a substantial range of levelling adjustment.

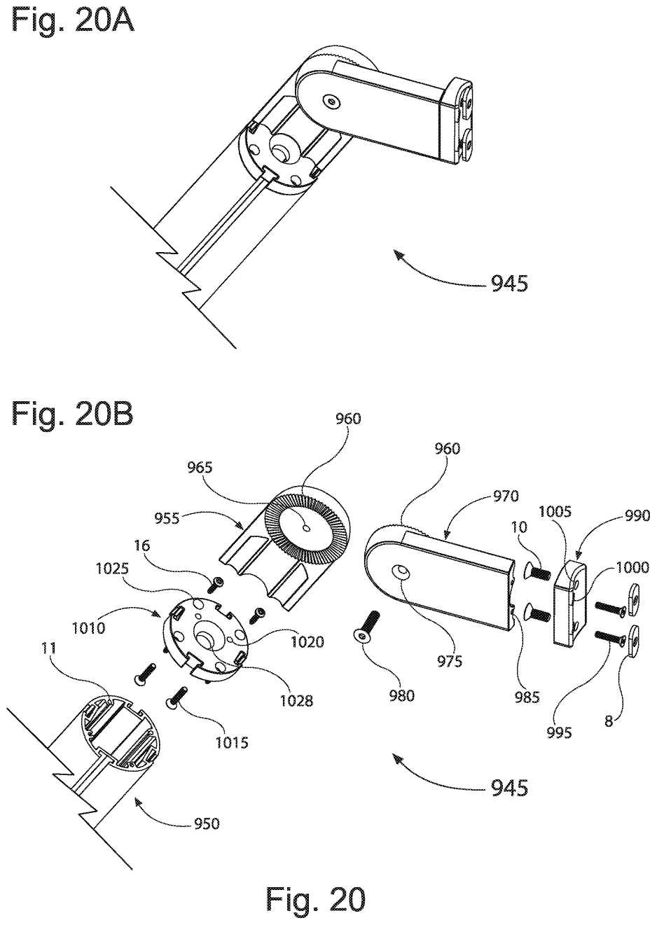

As noted above, for increased structural rigidity of the steerable dolly 830, the dolly may also comprise one or two of the diagonal support tube modules 860 extending diagonally between one or both of the horizontal chassis tube modules 855 and the corresponding vertical rail 32 or vertical post 710. According to one embodiment, a diagonal support tube module 860 comprises an adjustable angled connector 945 at both ends of an elongate cylindrical structural component 950. As illustrated in FIG. 20 according to one embodiment, the adjustable angled connector 945 comprises a threaded-hole toothed plate component 955 with a plurality of radial teeth 960 around a central threaded hole 965, which interlocks with a through-hole toothed plate component 970 having a corresponding set of radial teeth 960 around a central through-hole 975 whereby the threaded portion of a screw 980 is passed through and threadedly engaged with the threaded hole 965 of the other plate to interlock the radial teeth 960 of each plate in the grooves between the teeth of the other. According to one embodiment, each plate comprises seventy-two radial teeth 960, which allow the two toothed plate components to be interlocked at 5-degree increments. According to further embodiments, the plates may comprise any number between four and three-hundred-sixty radial teeth.

The end of each plate component 955/970 has threaded holes whereby another component may be demountably engaged for interfacing the connector with another module of a dolly or stand assembly. The through-hole toothed plate component 970 comprises two threaded holes 985 at the end of the component whereby a cylinder side mount component 990 is secured by two screws 995 through recessed through-holes 1000 and threadedly engaged with the threaded holes 985. The cylinder side mount component 990 further comprises a concave outer face whereby a cylindrical structural component, cylindrical mount component 180, roller carriage assembly 38 or other matching round component may be demountably engaged by screws 10 inserted through the opposite face of the component through recessed through-holes 1005 and threadedly engaged with nuts 8 or threaded holes.

The threaded-hole toothed plate component 955 comprises two threaded holes (not shown) at the end of the component whereby a cylinder end mount component 1010 is secured by two screws 1015 through recessed through-holes 1020 threadedly engaged with the threaded holes. The cylinder end mount component 1010 further comprises recessed through-holes 1025 whereby a threaded portion of screws 16 pass through to be threadedly engaged with the screws slots 11 of a cylindrical structural component 950. In addition to the recessed through-holes 1025 or in an embodiment which may exclude them, the cylinder end mount component 1010 may comprise a central recessed through-hole 1028 whereby a screw or bolt 210 may be used to demountably engage the adjustable angled connector 945 with a tube module having a threaded end connector 14 at its end, or with another component having a matching threaded hole.

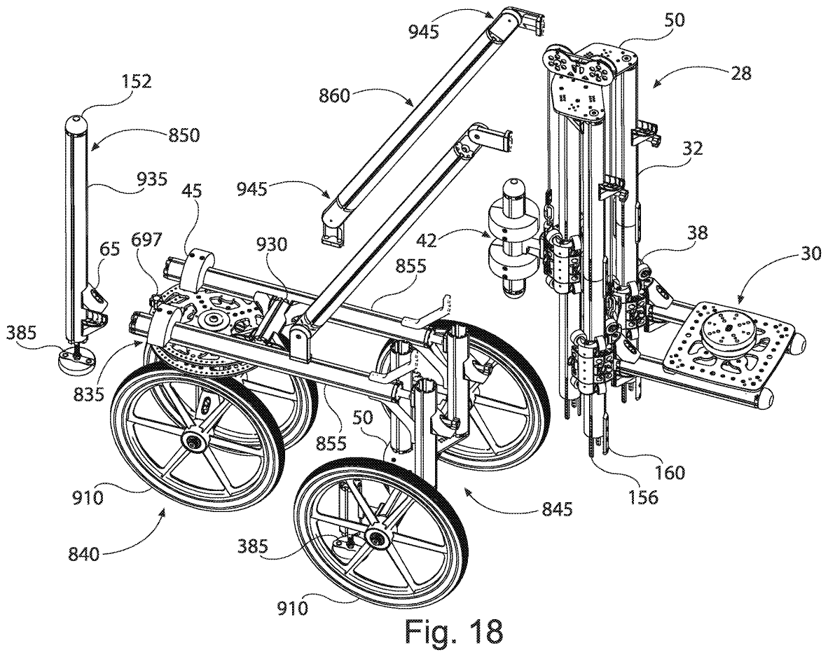

As illustrated in FIGS. 18 and 19, the two diagonal support tube modules 860 comprise the cylindrical structural component 950 whereon at both ends are fastened an adjustable angled connector 945 via the cylinder end mount component 1010. Each adjustable angled connector 945 is adjusted to an angle at which their cylinder side mount component 990 is aligned with their corresponding horizontal chassis tube module 855 or vertical rail 32, or alternatively vertical post 710, and there demountably engaged by screws 10 through recessed through-holes 1005 threadedly engaged with nuts 8 in the nut channel of the corresponding module.

According to further embodiments, an assortment of the modular support components may further be configured as a rotating jib dolly or rotating jib stand for controllably moving a supported device or equipment side to side and from low to high angles at the end of a pivoting jib arm. As illustrated in FIGS. 21 to 23, a rotating jib dolly 1030 is shown configured for rolling movement along a curved track assembly 168, as previously described. The rotating jib dolly may be reconfigured for rolling movement along an adjustable-level track assembly 165, or with the cylindrical track roller modules 170 replaced by square track roller modules 590 for rolling movement along a square or rectangular rail track assembly 595, or with the cylindrical track roller modules 170 replaced by casters 375 engaged with cylindrical mount components 180 for rolling movement directly on the ground, or with the cylindrical track roller modules 170 replaced by foot components 385 engaged with cylindrical mount components 180 for standing support directly on the ground.

As illustrated according to one embodiment, the rotating jib dolly 1030 comprises a further embodiment of a turntable dolly base 1035 with a further embodiment of a lockable turntable assembly 1040 whereby a vertical support structure 1045 is rotatable 360 degrees and supports a pivotable jib arm assembly 1050 whereon at one end is a self-levelling device mount assembly 1055 opposite a number of weight components 45 at the other end for counterbalancing the mount assembly and supported device or equipment.

According to one embodiment as illustrated, the turntable dolly base 1035 comprises a base frame assembled of six cylindrical structural components 1060, having at each end a cylinder gooseneck end component 390 secured by screws 16 to the component's screw slots 11. The four outer cylindrical structural components form the outer frame of the dolly base where at the corners four cylindrical track roller modules 170 are demountably engaged with the cylinder gooseneck end components 390. The two inner cylindrical structural components 1060 span the middle of the dolly base whereon the lockable turntable assembly 1040 is demountably engaged by downward screws 190 at through-holes 1065 in the assembly's bottom rotation plate 197, and through concave base components 136, threadedly engaged with nuts in the nut channels of the cylindrical structural components 1060.

The lockable turntable assembly 1040 is configured the same as the lockable turntable assembly 195 previously described in reference to FIGS. 5 and 10 except here excluding the rotational bearing 230 and bearing retainer 240 and rotating exclusively on the roller elements 285 on the roller track inlay 295. According to one embodiment, as illustrated, a lockable turntable assembly 1040 comprises eight roller elements 285. According to another embodiment, a lockable turntable assembly comprises four roller elements. According to further embodiments, a lockable turntable assembly comprises any number between three and twenty-four roller elements.

The rotation tension screw/bolt 255, low-friction disc 265, and lock-nut 275 may again be included at the center through-holes 260 of the rotation plates 197, but where excluding the bearing and bearing retainer, here instead a stack of bushings or an elongate bushing 1070 extends from the low-friction disc 265 down to the lock-nut 275 around the tension screw/bolt 255 to maintain the central alignment of the turntable assembly 1040 and optionally provide tension or lock the assembly. The lockable turntable assembly may be additionally or alternatively locked by the threaded locking knob 330, as previously described.

According to further embodiments, in place of the dolly base's lockable turntable assembly 1040, the rotational functions may be provided by the lockable turntable assembly 195 as previously described in reference to FIGS. 5 and 10 where rotatable on the bearing 230 and the roller elements 285 combined, or provided by the lockable turntable assembly 655 as previously described in reference to FIG. 13 where rotatable on a low-friction disc 675, or provided by the lockable turntable assembly 835 as previously described in reference to FIG. 19 where rotatable on the bearing 230 alone without the roller elements 285.

The vertical support structure 1045 is mounted to the top rotation plate 197 by upward screws 190 at through-holes 1075, and through concave base components 136, threadedly engaged with nuts 8 in the nut channels of two cylindrical structural components 1080 spanning the lower end of the vertical support structure 1045. At both ends of the cylindrical structural components 1080 a cylinder gooseneck end connector 390 connects the components with two more cylindrical structural components 1085 whereon are engaged by corner brace connectors 65, or alternatively cylinder gooseneck end connectors 390, four elongate cylindrical structural components 1090 forming the four corner posts of the vertical support structure. Four of the cylindrical structural components 1080 with cylinder gooseneck end connectors 390 bridge the vertical cylindrical structural components 1090 near the top.

The pivotable jib arm assembly 1050 comprises two lockable turntable assemblies 835, as previously described in reference to FIG. 19, here oriented vertically and each one mounted midway along the sides of two arm module assemblies 1095. According to one embodiment, the elongate component of each arm module 1095 may comprise a single cylindrical structural component, or according to one embodiment as illustrated, the arm modules comprise two cylindrical structural components 1100 which are conjoined by channel braces 156 and cylinder external braces 160, as previously described, in the nut channels of the cylindrical structural components 1100. A lockable turntable assembly 835 is mounted to the sides of both arm modules 1095, by screws 190, at through-holes 900 and through concave base components 136, threadedly engaged with nuts 8 in the nut channels of the arm modules, there securing the two arms and two turntable assemblies together. The outer rotation plate 665 of each turntable assembly 835 is demountably engaged with the vertical support structure's two upper cylindrical structural components 1080 on each side by screws 190, at through-holes 900 and through concave base components 136, threadedly engaged with nuts 8 in the nut channels of the cylindrical structural components 1080. The arm modules 1095 are thereby pivotable vertically on the vertical support structure 1045. The height of the arm can be adjusted by repositioning the upper cylindrical structural components 1080 on their cylinder gooseneck end connectors 390 along the nut channels of the vertical cylindrical structural components 1090.

The self-levelling device mount assembly 1055 is demountably engaged to the front end of the arm modules 1095 by screws 190, concave base components 136, and nuts 8 at the through-holes 900 in the inner rotation plates 665 of two additional lockable turntable assemblies 835 which are provided as the pivot mechanism of the device mount assembly 1055. Two cylindrical structural components 1105 with cylinder gooseneck end connectors 390 at each end are mounted vertically to the outer two rotation plates 665 by screws, concave base components, and nuts. Another cylindrical structural component 1109 is attached horizontally at the bottom of via the two cylinder gooseneck end connectors 390, and whereon a plurality of weight components 45 are demountably engaged by screws and nuts. Attached perpendicularly at the top ends are two cylindrical structural components 1111 whereon a device mount plate 118, bowl/ball mount assembly 119 or other interfacing mount component, and the supported device or equipment are demountably engaged where it may be manually tilted by the operator or is otherwise gravitationally levelled by the under-slung weight components 45. According to further embodiments, the lower weight components 45 can be excluded and the device mount components and supported device or equipment under-slung.

A plurality of weight components 45 are demountably engaged by screws and nuts at the opposite end of the arm modules 1095 for counterbalancing the front device mount assembly 1055 and supported device or equipment. A short cylindrical structural component 1113 attached by corner brace connectors 65, or alternatively by cylinder gooseneck end connectors 390, may be used to there reinforce the jib arm assembly 1050. According to further embodiments, the counterbalancing weight components may be excluded and a second top-slung or under-slung device mount assembly provided at the second end for a dual-device support apparatus.

As illustrated according to one embodiment, the lockable turntable assemblies 835 of the jib arm assembly 1050 and the device mount assembly 1055 may include the threaded locking knob 697 and/or the tension screw/bolt 885 assembly for locking or tensioning the pivotable movement of the mounted components.

According to further embodiments, in place of the jib arm and device mount assemblies' lockable turntable assemblies 835, the rotational functions may be provided by the lockable turntable assembly 195 as previously described in reference to FIGS. 5 and 10 where rotatable on the bearing 230 and the roller elements 285 combined, or provided by the lockable turntable assembly 655 as previously described in reference to FIG. 13 where rotatable on a low-friction disc 675, or provided by the lockable turntable assembly 1040 as previously described in reference to FIG. 23 where rotatable on the roller elements 285 alone.

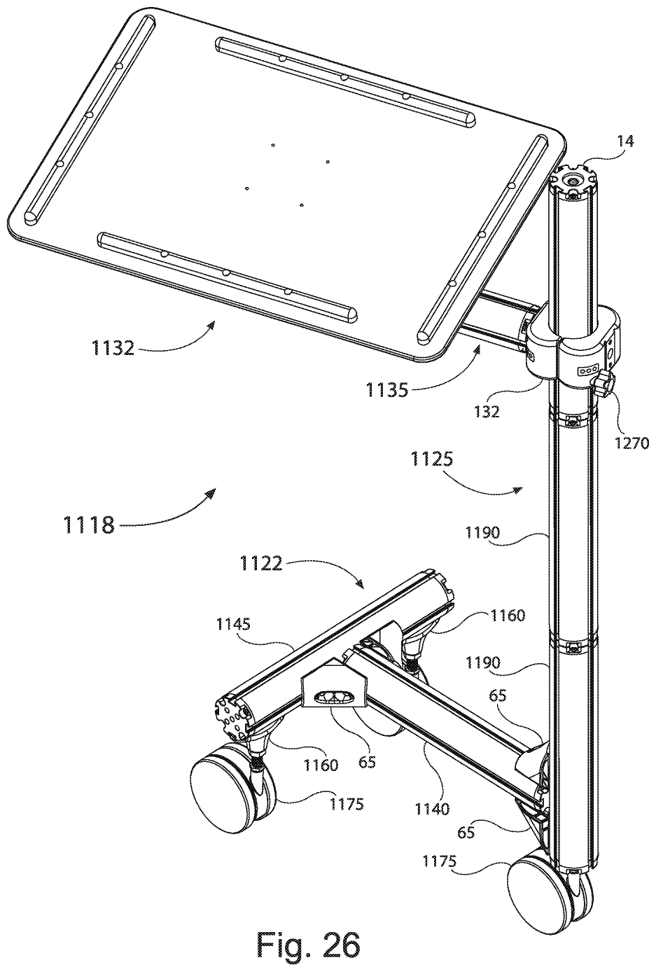

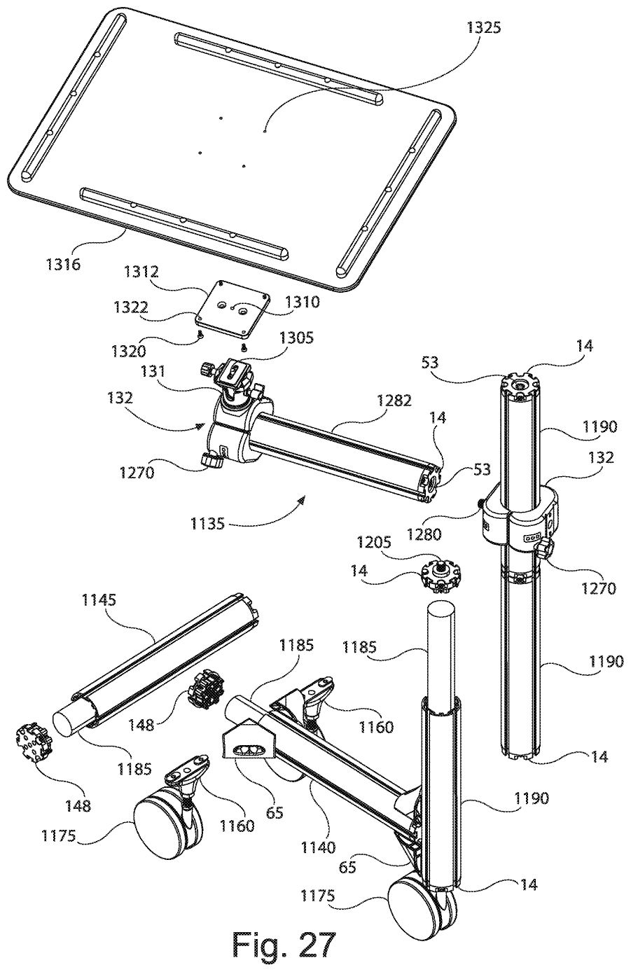

According to further embodiments, an assortment of the modular support components may further be configured as illustrated in FIGS. 24 and 25 as a reconfigurable portable device stand 1115 for supporting a device such as a laptop computer, tablet, camera, lighting equipment, sound recording equipment, audio/visual equipment, sensor, robotic gimbal, robotic arm, power tool, or other equipment, or as illustrated in FIGS. 26 and 27 configured as a reconfigurable portable table stand 1118. A close-up view of one of the embodiments of a threaded end connector 18 is shown in FIG. 28.

A reconfigurable portable device stand 1115 or a reconfigurable portable table stand 1118 may comprise a base assembly 1122 from which extends vertically an upright support assembly 1125 wherefrom a device mount assembly 1130 and supported device or a table assembly 1132 is extended on an arm assembly 1135.

According to one embodiment, the base assembly 1122 comprises a first cylindrical structural component 1140 demountably engaged with a second cylindrical structural component 1145 in a perpendicular T-shape by two corner brace connectors 65 fastened by threaded portions of screws 10 passed through through-holes 72/73 to be threadedly engaged with nuts 8 in the nut channels 1150/1155 of the cylindrical structural components. According to a further embodiment, the corner brace connectors are replaced by a cylindrical gooseneck end connector 390, as previously described, fastened by screws 16 to the screw slots 11 in the end of the first cylindrical structural component 1140, and fastened by screws 10 to nuts 8 in the nut channel 1155 of the second cylindrical structural component 1145. The base assembly 1122 may further comprise a plurality of a threaded side mount component 1160 demountably engaged by screws 1165 at through-holes 1170 threadedly engaged with nuts 8 in the bottom nut channels of the cylindrical structural components 1140/1145. As illustrated, threaded-stem casters 1175 may be threadedly engaged with a threaded hole 1180 in the center of the threaded side mount components 1160, or according to further embodiments, threaded-stem foot components. For increased stability, weight components 45, as previously described, may be demountably engaged with one or both of the base assembly's cylindrical structural components 1140/1145, or as illustrated in FIG. 27, an internal weight component 1185 such as one or more steel segments or one or more sandbags may be installed within the hollow components. Threaded end connectors 14 as previously described, or threaded end connectors 18 as will be described below, or soft threaded end components 148 as previously described may be installed at the ends of the cylindrical structural components 1140/1145. According to a further embodiment, the second cylindrical structural component 1145 may be replaced by a wide foot component demountably engaged to the underside of the first cylindrical structural component 1140.

A reconfigurable portable device stand 1115 or a reconfigurable portable table stand 1118 further comprise an upright support assembly 1125 having one or more cylindrical structural components 1190 extending upward from the base assembly 1122. According to one embodiment as illustrated, a first upright cylindrical structural component 1190 is demountably engaged by corner brace connectors 65 perpendicular with the end of the base cylindrical structural component 1140, or alternatively the base component 1140 has a cylindrical gooseneck end connector 390 at the end whereby it is demountably engaged with the upright component 1190. The bottom end of the upright component 1190 may comprise a threaded end connector 14/18 whereby a threaded-stem caster 1175 or threaded-stem foot is threadedly engaged.

According to further embodiments, a base assembly may comprise two cylindrical structural components extending from the upright support assembly in an L-shape, or it may comprise three cylindrical structural components extending in an A-shape or a Y-shape or an H-shape, or it may comprise four cylindrical structural components extending in an X-shape.

In embodiments where the upright support assembly 1125 includes two or more conjoined upright cylindrical structural components 1190, the components may be demountably engaged by two of threaded end connector 14 or two of threaded end connector 18. The two threaded end connectors 14/18 are fastened at the corresponding cylinder ends by the threaded portion of screws 16 passed through recessed screw through-holes 1195/1200 and threadedly engaged with the screw slots 11 in the cylindrical structural components 1190. A connector screw 1205 has been threadedly engaged into a central threaded hole 53/1210 of the first threaded end connector on the first cylindrical structural component 1190 with the screw head then contained by the first cylindrical structural component 1190. The threaded end of the connector screw 1205 extends from the first threaded end connector whereby the second threaded end connector and corresponding second cylindrical structural component 1190 can be manually rotated by threaded engagement of its central threaded hole 53/1210 onto the connector screw. According to one embodiment, the connector screw 1205 is secured into the first threaded end component by a glue or an epoxy or thread-locker or other adhesive to prevent disengagement when being installed into the second threaded end connector. According to one embodiment, the threaded end connectors 14/18 further comprise nut channel openings 1212 which allow nuts 8 to be moved through the connectors into and out of the nut channels of cooperating cylindrical structural components.

Threaded end connectors 14/18 may further comprise a circular recess 1215/1220 around the central threaded hole 53/1210 wherein a circular insert 1225/1230 made of a resiliently compressible material such as a foam or a rubber material is installed into one or both the first and second threaded end connectors to provide a range of tension so that the connectors can be securely engaged and then disengaged by manual rotation. As illustrated in FIG. 25 according to one embodiment, a single circular insert 1225 is installed in the circular recess 1215 of the first threaded end connector 14 and protrudes from the recess to be received and make contact in the circular recess 1215 of the second threaded end connector 14 where it maintains a narrow gap between the end faces of the connectors wherein the circular insert is compressible until the connectors are adequately engaged and aligned.

As illustrated in FIG. 28 according to a further embodiment, a circular insert 1230 is installed in the circular recesses 1220 of both the first and the second threaded end connectors 18 from where they protrude to make contact while maintaining a narrow gap between the end faces of the connectors wherein the circular inserts 1230 are compressible until the connectors are adequately engaged and aligned.

According to some embodiments, the circular inserts 1225/1230 are secured within the circular recesses by a glue or an epoxy or other adhesive. According to some embodiments, a hard insert such as a washer or spacer 1235 is inserted between the compressible inserts 1225/1230 and the bottom of the recess as a filler component where required depending on the thickness of the compressible inserts and their required extension out of the recess.

According to some embodiments, a thumb-screw 1240 is provided in place of one of the four screws 16 of one of the threaded end connectors 14/18 and threadedly engaged in the corresponding screw slot 11 to provide a rotation locking function. The head diameter of the thumb-screw fits just within the size of the recess around its screw through-hole 1195/1200 in the first threaded end connector 14/18, where it may be threadedly engaged in to be contained by the recess, or be threadedly extended out of its recess to protrude into a corresponding recess of the aligned second threaded end connector 14/18, where therefore the two connectors cannot be disengaged until the thumb-screw is withdrawn.

A reconfigurable portable device stand 1115 or a reconfigurable portable table stand 1118 further comprise an arm assembly which is extended from the upright support assembly and from which a device mount assembly and supported device or a table assembly is extended and positioned. According to one embodiment, the arm assembly 1135 comprises a clamp assembly 132 which is clamped along the one or more cylindrical structural components 1190 of the upright support assembly 1125. Two half-clamp components 1250 are demountably engaged with one another by screws 1255 engaged in through-holes 1260 in one and threadedly engaged with threaded holes 1265 in the other. The screws can be set to a position such that necessarily loosening only one releases the clamp so that it may be raised and lowered and pivoted along the cylindrical structural component(s) 1190 and then resecured. According to one embodiment, the releasing screw is a threaded knob 1270.

The half-clamp component 1250 further comprises a central recessed through-hole 1275 in which a screw 1280 is engaged outwardly through the hole and where the screw head is contained by the recess so that it does not interfere with the corresponding cylindrical structural component 1190. A threaded portion of the screw 1280 is extended outwardly whereby a cylindrical structural component 1282 with a threaded end connector 14/18 is threadedly engaged by the screw 1280. According to some embodiments, the arm assembly 1135 may comprise two or more cylindrical structural components conjoined end to end. According to further embodiments, the clamp assembly 132 is excluded and the connecting end of the cylindrical structural component 1282 is demountably engaged via corner brace connectors 65 by screws with nuts in the nut channels, or the connecting end of the cylindrical structural component 1282 is provided with a cylinder gooseneck end connector 390 in place of the threaded end connector 14/18 whereby the arm component is demountably engaged by screws with nuts in the nut channels of the upright support assembly 1125.

The half-clamp component 1250 may also comprise two angled threaded inserts 1285 secured by outward screws in recessed through-holes, whereby another component may be secured by a screw threadedly engaged with a threaded hole in the insert. Alternatively, a threaded insert may be removed and a longer screw outwardly installed to receive a component with a threaded hole. As shown in FIG. 25, a cup holder component 1290 is threadedly engaged with an outward screw 1295.

According to one embodiment, a second clamp assembly 132 is provided on the cylindrical structural component 1282 of the arm assembly 1135 whereon the device mount assembly 1130 or the table assembly 1132 is pivotable and slidable. As illustrated in FIGS. 25 and 27, optionally a ball-and-socket joint mount 131 is provided as an interfacing mount component between the arm assembly 1135 and the device mount assembly 1130 or the table assembly 1132. As illustrated according to one embodiment, the joint mount 131 is secured by an outward screw 1300 passed through a concave base component 136 and threadedly engaged with a threaded hole in the bottom of the joint mount 131. A mount screw 1305 at the other end of the ball-and-socket joint mount 131 is threadedly engaged with a threaded hole 1310 in a mount plate 1312 whereby a laptop computer bracket 1315 or a table component 1316 is secured by screws 1320 in through-holes 1322 in the mount plate 1312 there threadedly engaged with threaded holes 1323 in the backside of the laptop computer bracket 1315 or with threaded holes 1325 in the backside of the table component 1316.

According to further embodiments, a portable device stand 1115 can exclude the mount plate 1312 and the laptop computer bracket 1315 and table component 1316 to directly mount a device such as a camera, light, microphone, audio/visual equipment, sensor, robotic gimbal, robotic arm, power tool, or other equipment or additional interfacing mount component such as a tablet bracket on the ball-and-socket joint mount 131 via its screw mount 1305.

While embodiments of the disclosure have generally been presented in the context of modular components and modular assemblies, the disclosure extends to non-modular components and assemblies (e.g., components and assemblies that may not be modular with other components and assemblies, or that may consist of “one-piece” components or assemblies).

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

### Additional Embodiments

Further embodiments of the present disclosure generally relate to additional components and assemblies which may be configured and sized to remain compatible with the assemblies and components as previously described in the present application as well as disclosed in U.S. Pat. Nos. 11,384,898 B2, 12,398,841 B2, 11,535,288 B2, and 11,987,280 B2, all of which are incorporated herein by reference in their entireties, or may be used without inclusion of these earlier components, to configure support assemblies of various types and utility.

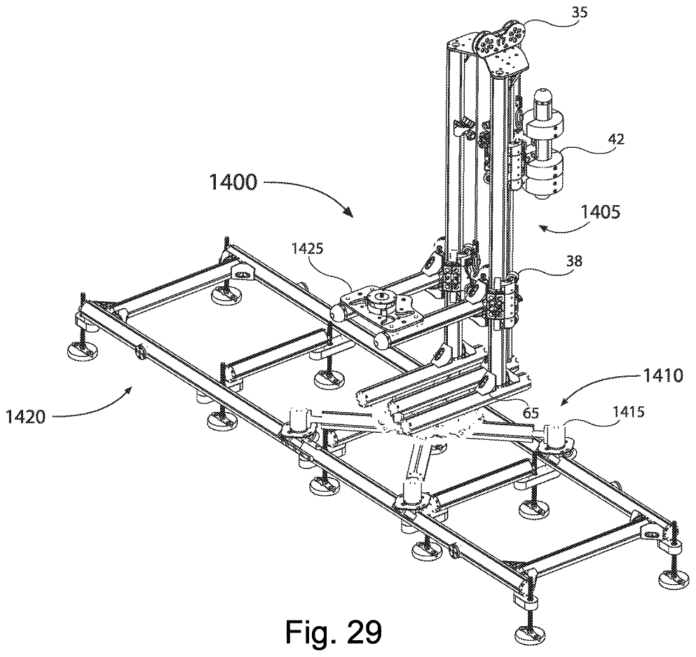

As illustrated in FIG. 29, a further embodiment of a vertical track dolly 1400 may comprise a further embodiment of a 3-rail vertical track assembly 1405 supported on a turntable dolly base 1410 with four cylinder-mount track roller assemblies 1415 configured for rolling engagement along a further embodiment of an adjustable-level track assembly 1420. As previously described in reference to the 3-rail vertical track assembly 28 of FIGS. 1 to 3, the 3-rail vertical track assembly 1405 of FIG. 29 may also comprise the pulley assembly 35 whereby the ends of a cable are pulled upward and downward to correspondingly move the counterweight carriage assembly 42 on the rear vertical rail assembly thereon moving oppositely of a front-facing assembly of two three-sided roller carriage assemblies 38 and two tube modules whereon a further embodiment of a device mount assembly 1425 may be supported for mounting and controllably moving a device or equipment of the types previously listed.

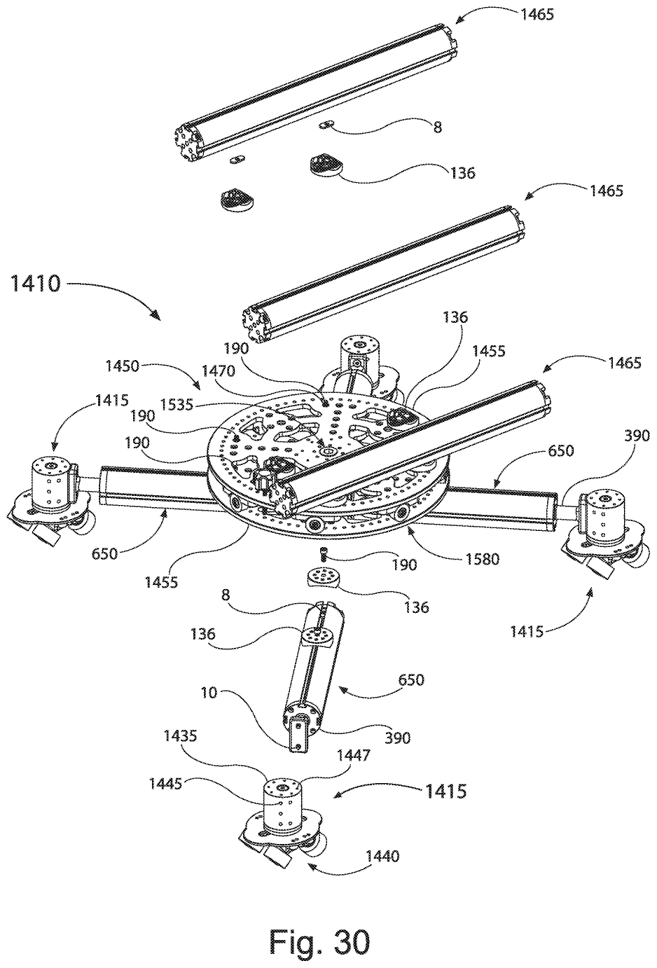

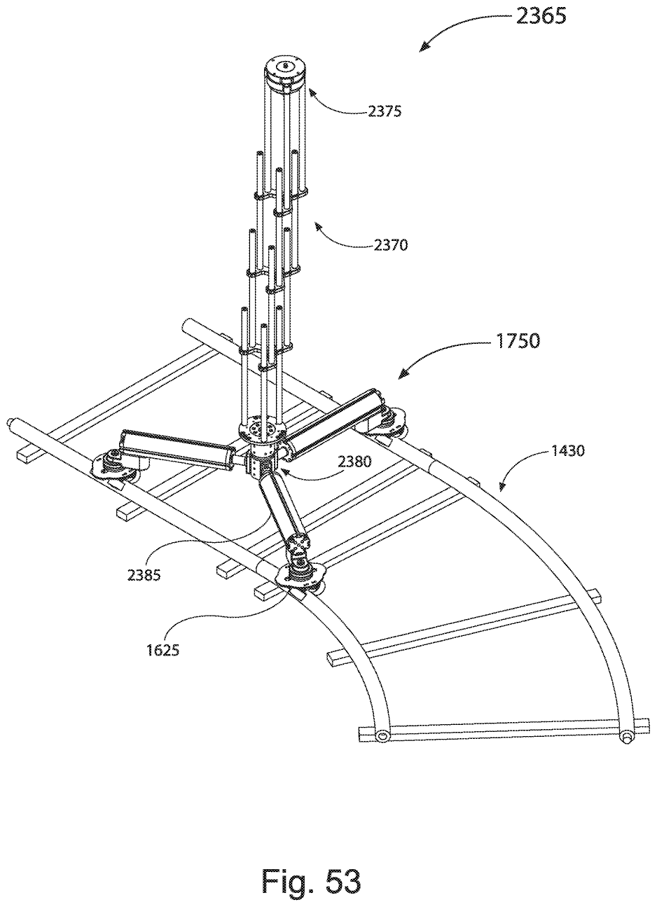

As illustrated in FIG. 29, according to one embodiment a vertical track dolly 1400 may comprise the turntable dolly base 1410 whereby the vertical track assembly 1405 may be demountably engaged allowing for the 360-degree rotation of the vertical track assembly relative to the lower elements of the turntable dolly base. A turntable dolly base may be additionally configured on casters 375 for rolling directly on the ground, as will be described in further detail below. As shown in FIG. 29 and FIG. 30, the turntable dolly base 1410 is configured for rolling movement along the adjustable-level track assembly 1420, and the same components may be reconfigured for rolling movement along a standard straight or curved track assembly 168 as described previously in reference to FIG. 12, and standard track assembly 1430 shown in FIG. 53, and according to further embodiments may be configured for other types of round track elements, or square and rectangular rail elements where the sides are oriented on an incline matching the incline of the dolly base's rollers, as will be described in further detail below.

According to some embodiments, the turntable dolly base 1410 has at each corner the cylinder-mount track roller assembly 1415 comprising an upward cylindrical mount component 1435 with a flat bottom side rotationally engaged on a first lower roller elements subassembly 1440. The cylinder-mount track roller assemblies 1415 may be demountably engaged at the cylinder gooseneck end components 390 at the outward ends of the four tube modules 650, as previously described in reference to FIG. 13, by one or more screws 10 threadedly engaged with one or more threaded holes 1445 in the circumferential surface of the cylindrical mount components 1435. According to some embodiments, the cylindrical mount component 1435 may also comprise one or more threaded holes 1447 on the top surface of the component whereby one or more additional components may be demountably engaged, as will be described in further detail below in reference to FIGS. 53 to 55.

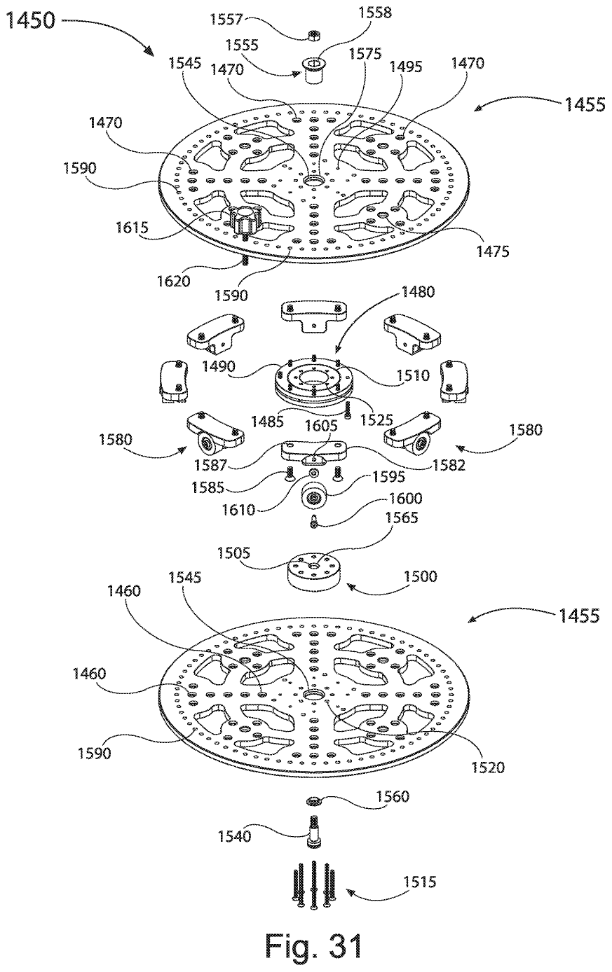

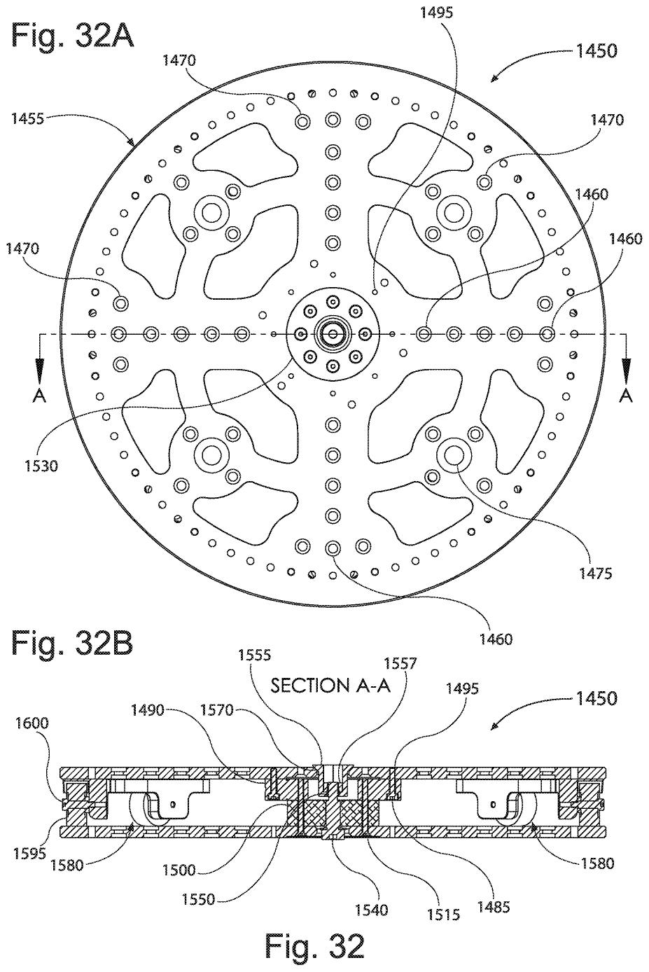

According to some embodiments, a lockable turntable assembly 1450 may be demountably engaged at the center of the track dolly base 1410 on the four inward portions of the tube modules 650 by screws 190, concave base components 136, and nuts 8. The lockable turntable assembly 1450 may comprise two rotation plates 1455 where a threaded portion of screws 190 are passed downwardly through holes 1460 in the lower rotation plate 1455, as indicated in FIGS. 31 and 32A, and through the hole in the center of the concave base components 136 to secure the assembly against the tube modules 650 by threadedly engaging the screws with the nuts in the nut channels of the tube modules.

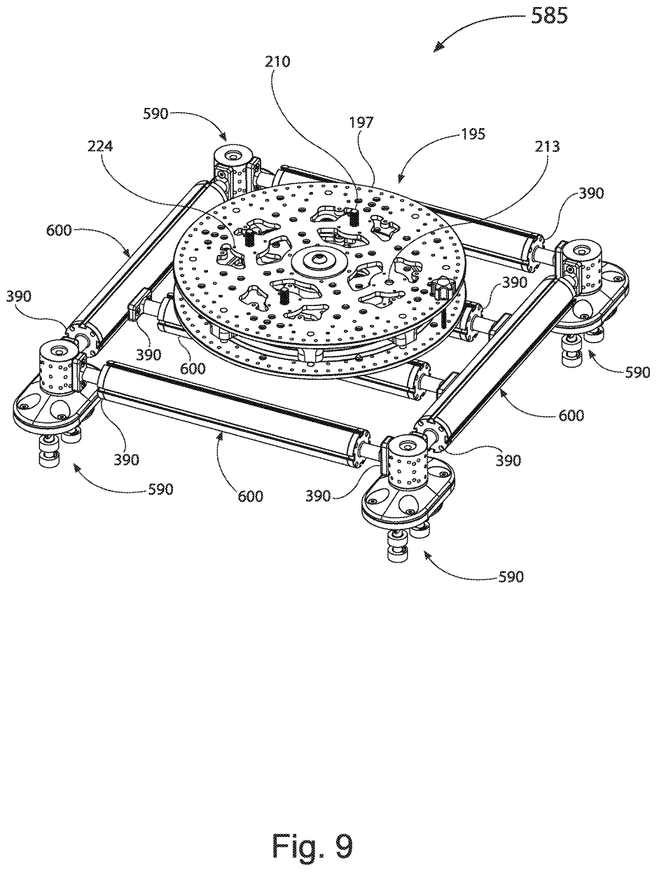

According to one embodiment, as shown in FIGS. 29 and 30, the 3-rail vertical track assembly 1405 is upwardly engaged on the lockable turntable assembly 1450 via three tube modules 1465 which may be demountably engaged with concave base components 136 on the top surface of the upper rotation plate 1455 by screws 190 passed upwardly through holes 1470 and threadedly engaged with nuts in the nut channels on the underside of the tube modules 1465. The lower ends of the three rail subassemblies of the vertical track assembly 1405 may be demountably engaged with the top side of the three tube modules 1465 by corner brace connectors 65 and screws 10 threadedly engaged with nuts 8 in the upward nut channels of the tube modules, as previously described. Alternatively, the rotation plates 1455 may also comprise through-holes 1475 at which the lower ends of the vertical track assembly 1405 may be demountably engaged directly by upward screws 210 threadedly engaged with threaded end connectors 14 in the lower ends of the three rail subassemblies, as like previously described in reference to FIG. 9 and the lockable turntable assembly 195.

When provided, the interfacing tube modules 1465 allow the vertical track assembly 1405 to be offset horizontally toward the rear to effectively center the device mount assembly 1425 and supported device or equipment directly above the rotational axis of the lockable turntable assembly 1450, or offset toward the front, when either may be preferred by the operator.

According to some embodiments, as shown in FIGS. 31 and 32, the lockable turntable assembly 1450 may comprise a rotational bearing 1480 mounted centrally between the top and bottom rotation plates 1455 allowing the top plate to rotate 360 degrees relative to the bottom plate. The rotational bearing may be fastened by screws 1485 through holes in its outer ring 1490 and there threadedly engaged with threaded holes 1495 in the top rotation plate 1455. A bearing retainer 1500 with a central through-hole 1505 may be mounted between an inner ring 1510 of the bearing 1480 and the bottom rotation plate 1455, and there fastened by screws 1515 through holes 1520 in the bottom plate and through holes in the bearing retainer 1500 and threadedly engaged with threaded holes 1525 in the inner ring 1510 of the bearing. According to some embodiments, the bearing retainer 1500 is a spacer. As indicated in FIG. 32A, according to some embodiments the rotation plates 1455 may further comprise a circular recess 1530 which matches the diameter of the inner ring 1510 of the bearing so that the inner ring does not make contact with the underside of the top rotation plate 1455, therefore allowing the outer ring, while fastened to the top plate, to rotate around the inner ring.

Optionally the lockable turntable assembly 1450 may further comprise adjustable tension components 1535 with a tension screw 1540 or bolt of which at least a threaded portion is passed through a through-hole 1545 in the center of the bottom rotation plate 1455 and through the central through-hole 1505 of the bearing retainer 1500 and into the opening in the center of the inner ring 1510 of the bearing 1480 where it passes through a central hole 1550 in a circular clasp component 1555, as indicated in FIG. 32B, where it may be threadedly engaged with a captive nut 1557 contained within the circular clasp component. According to some embodiments, the tension screw 1540 is a shoulder screw. According to a preferred embodiment, the nut 1557 is a hexagonal-shaped nut and engaged within a hexagonal-shaped recess 1558 in the circular clasp component. According to a further embodiment, the nut is a square-shaped nut and engaged within a square-shaped recess. According to another embodiment, the central hole of the circular clasp component may be threaded and the nut excluded.

According to some embodiments, as shown in FIGS. 31 and 32, the central through-hole 1545 of the lower rotation plate 1455 is a wider diameter than the head of the tension screw 1540 and the screw head engaged against the bearing retainer 1500. According to a preferred embodiment, a low-friction bushing 1560 may be included between the head of the tension screw 1540 and the underside of the bearing retainer 1500, or against the lower rotation plate in other embodiments where the plate's through-hole is narrower than the head of the tension screw, thereby providing a low-friction material against which the tension screw may more easily rotate. The bearing retainer 1500 may further comprise a chamfer 1565 around the central hole 1505 (as indicated in FIG. 31 at a matching chamfer on the top side of the component) wherein an edge of the bushing 1560 may be engaged and aligned to center.

According to preferred embodiments, the circular clasp component 1555 further comprises an angled rim 1570 or angled edge or angled flange matching the angle of a chamfer 1575 around the central through-hole 1545 of the top rotation plate 1455. According to further embodiments, the clasp's rim, edge, or flange is flat and the clasp may be engaged with the top surface of the rotation plate around the through-hole. According to a preferred embodiment, the circular clasp component is made of a low-friction material. By tightening and loosening the opposing tension screw 1540, the captive nut 1557 may be pulled downward or released and the tension of the circular clasp component against the rotation plate may be adjusted from between firm to loose to assist the operator to control the rotation speed of the top rotation plate and supported components and devices or equipment, or lock their rotation.

According to some embodiments, the arrangement of the bearing, bearing retainer, and the adjustable tension components 1535 may be inverted with the bearing retainer located above the bearing and the tension screw facing upward and the circular clasp component facing downward.

According to some embodiments, for added stability around the rotation of the bearing 1480, or optionally excluding the bearing and used as the rotational support element alone, a lockable turntable assembly 1450 may further comprise three or more roller elements 1580. According to a preferred embodiment, the roller element may comprise a roller mount 1582 which may be fastened to the underside of the top rotation plate 1455 by one or more screws 1585 of which a threaded portion is passed through a hole 1587 in the roller mount and threadedly engaged with threaded holes 1590 in the top rotation plate. The roller element 1580 may further comprise a roller 1595 rotationally engaged on an axle screw 1600 which is threadedly engaged with a threaded hole 1605 in the roller mount 1582. According to a preferred embodiment, optionally for reduction of noise and vibration, a non-metallic washer 1605 may be included between the roller mount and the roller. The rollers are configured to roll in a circular path near the outer edge of the lower rotation plate 1455. According to some embodiments, as illustrated, a lockable turntable assembly 1450 comprises eight roller elements. According to another embodiment, a lockable turntable assembly comprises four roller elements. According to further embodiments, a lockable turntable assembly comprises any number between three and twenty-four roller elements.

A lockable turntable assembly 1450 may further comprise a threaded locking knob 1615 with a threaded stem 1620 which may provide a locking function in addition to or instead of the adjustable tension components 1535. The threaded stem 1620 is threadedly engaged with one of a plurality of the threaded holes 1590 which may be located radially at given increments around the two rotation plates 1455. To lock rotation of the turntable assembly 1450, the locking knob 1615 is rotated to extend the threaded stem 1620 down from the threaded hole 1590 in the top plate to be threadedly engaged with a corresponding threaded hole 1590 in the bottom plate. To unlock rotation, the locking knob is rotated in the opposite direction to retract the threaded stem from the threaded hole in the bottom plate to therefore allow rotation of the top plate and supported vertical assembly and device or equipment. According to one embodiment, the rotation plates 1455 may comprise seventy-two threaded holes 1590 to allow the plates to be locked relative to each other at 5-degree increments. According to further embodiments, rotation plates may comprise any number between four and one-hundred-eighty threaded holes. According to further embodiments, the threaded knob 1615 is replaced by a standard screw or bolt.

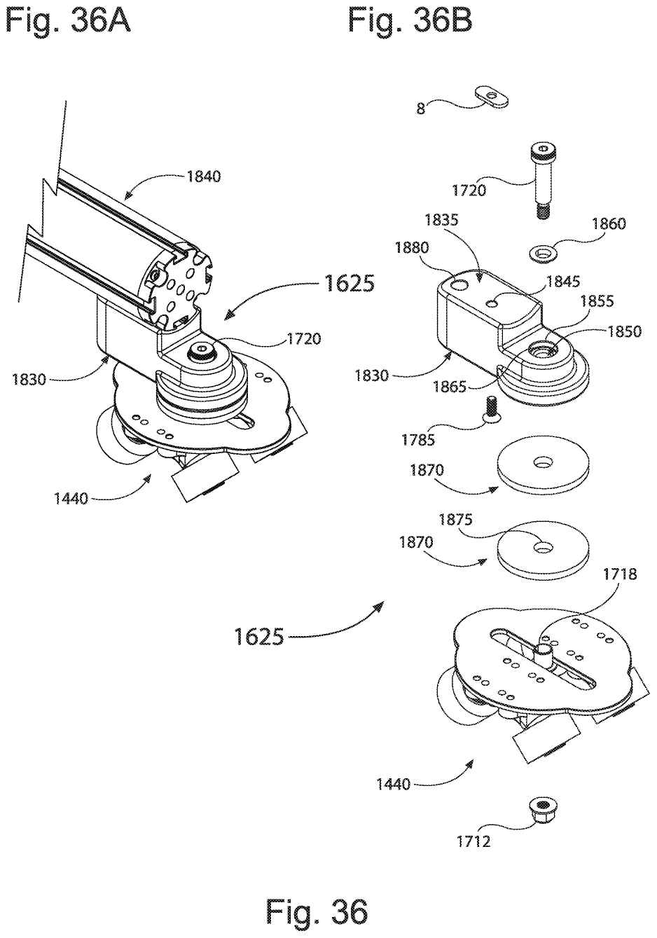

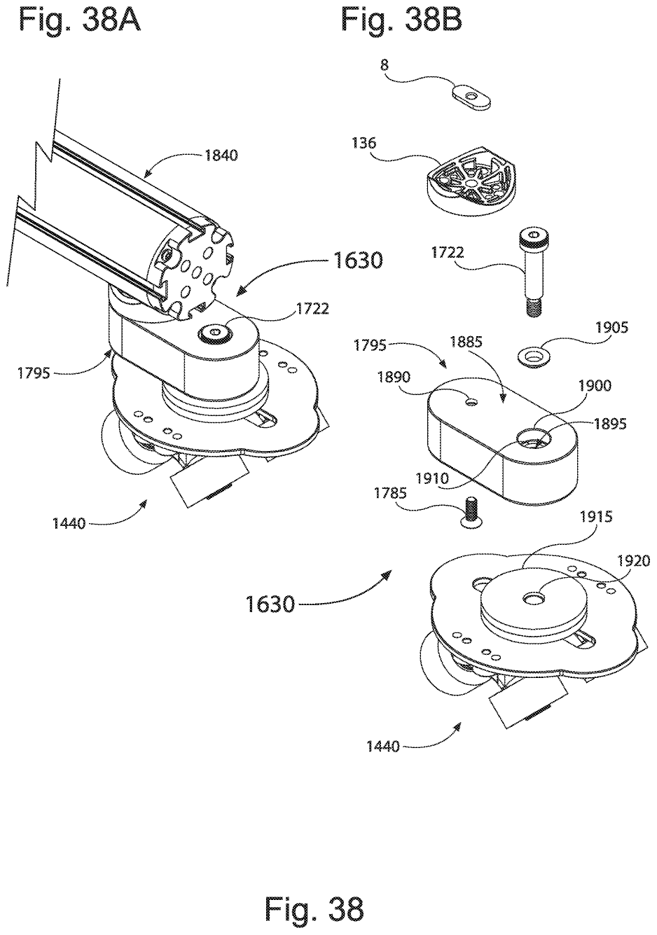

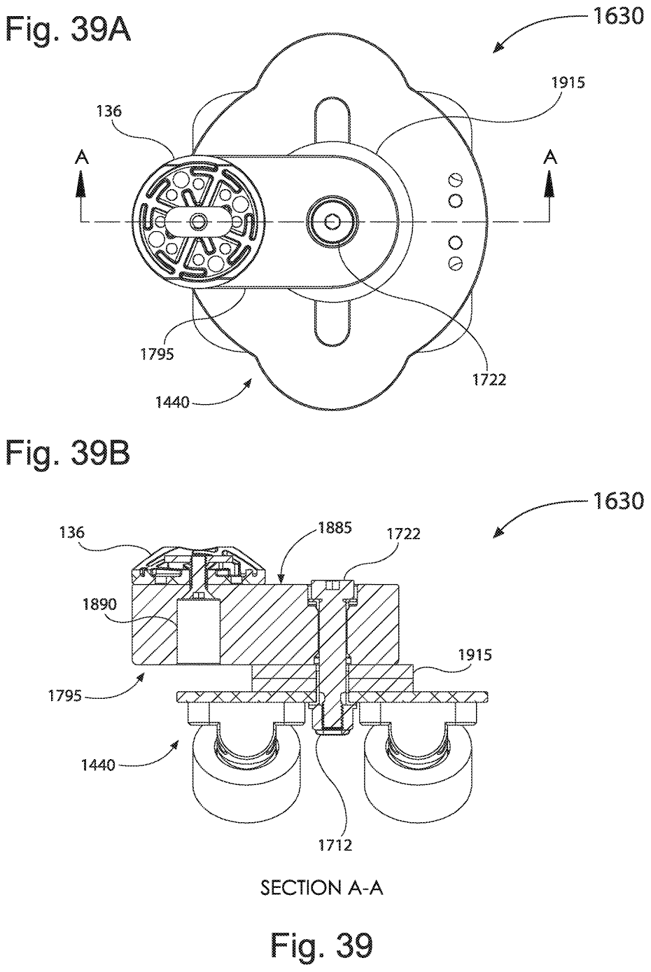

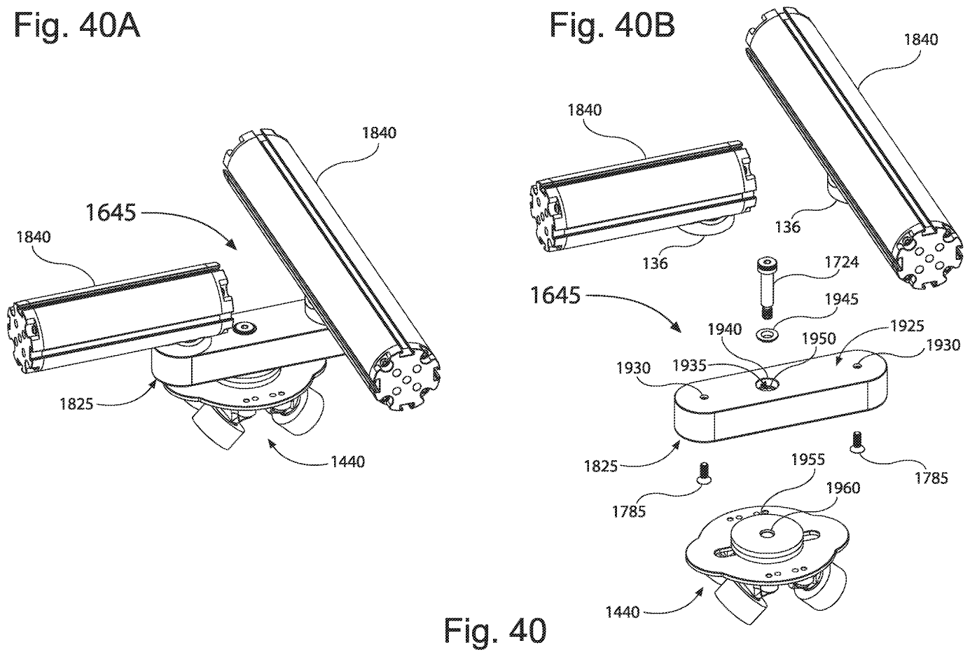

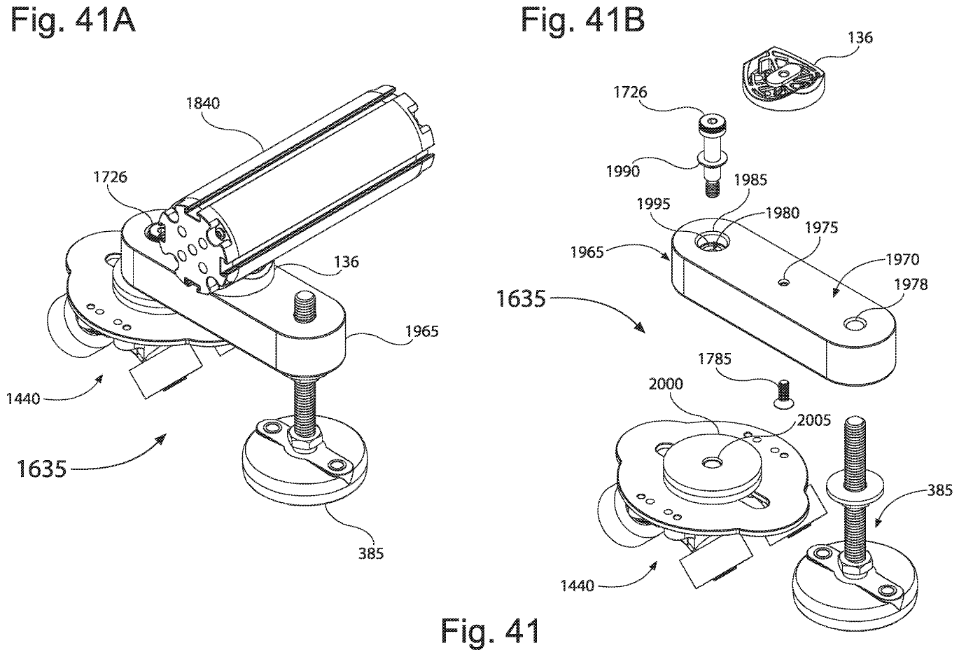

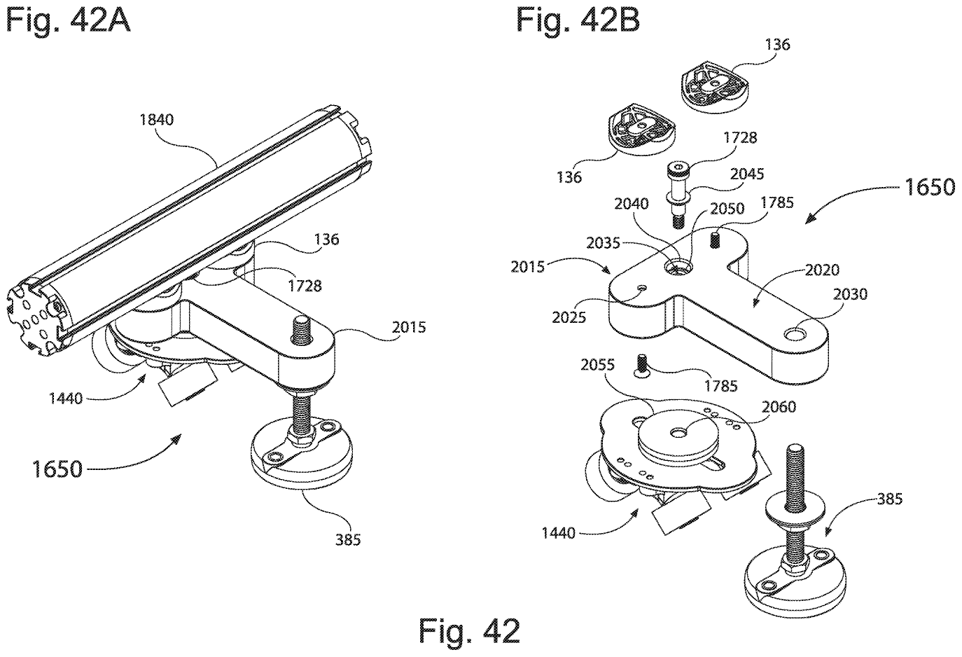

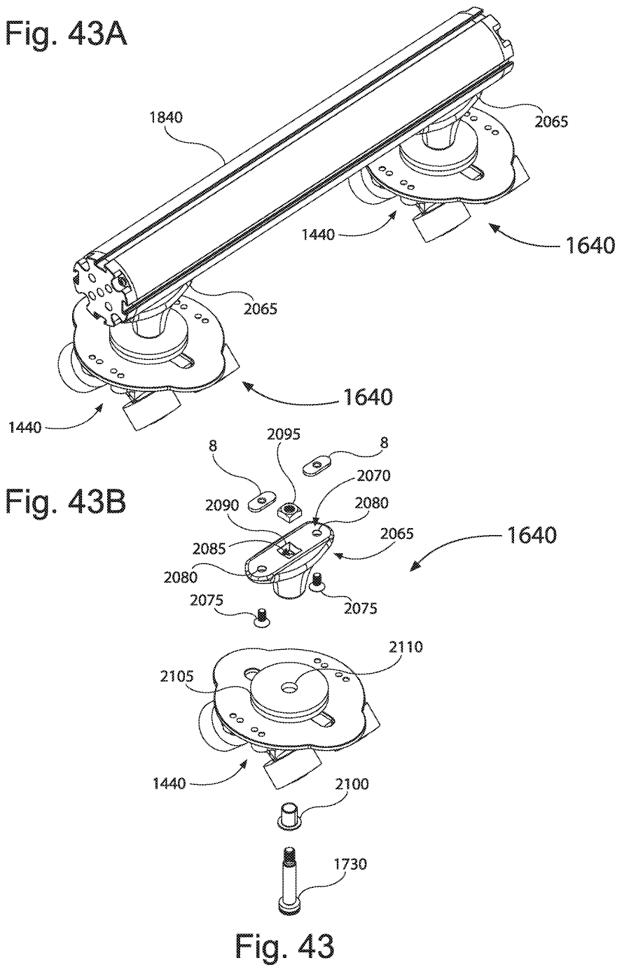

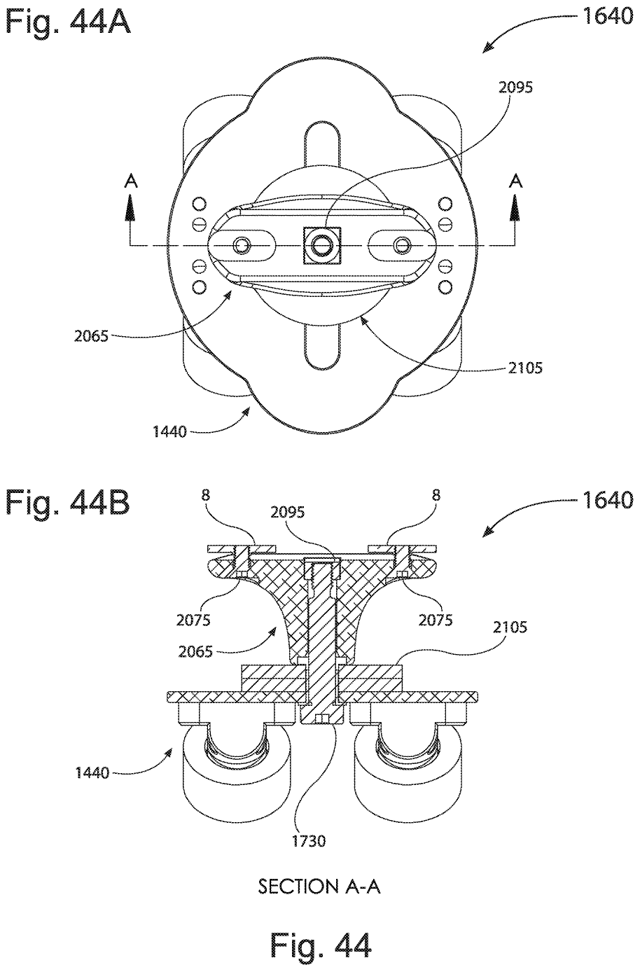

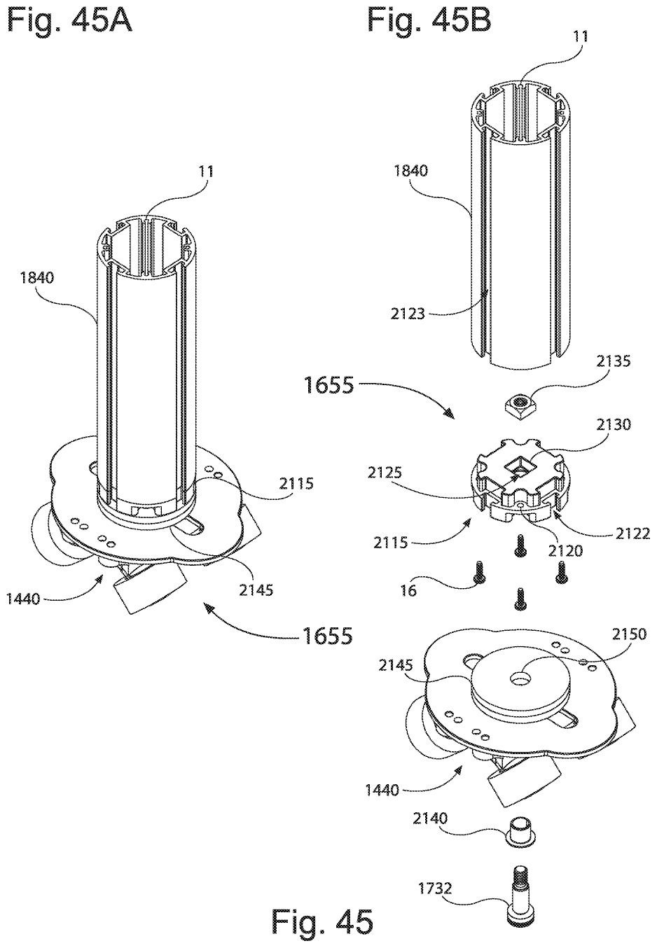

As previously described, the various embodiments of a turntable dolly base are configured for rolling engagement along standard track assemblies and adjustable-level track assemblies of the present disclosure. According to some embodiments, the various dolly bases comprising round or cylindrical structural components as previously described may comprise three or more of a first embodiment of a side-mount track roller assembly 1625 shown in FIGS. 36, 37, 53 and 54, or three or more of a second embodiment of a side-mount track roller assembly 1630 shown in FIGS. 38 and 39, or three or more of a third embodiment of a side-mount track roller assembly 1635 shown in FIG. 41, or three or more of a fourth embodiment of a side-mount track roller assembly 1640 shown in FIGS. 43 and 44, or three or more of a first embodiment of a double side-mount track roller assembly 1645 shown in FIG. 40, or three or more of a second embodiment of a double side-mount track roller assembly 1650 shown in FIG. 42, or three or more of a tube end-mount track roller assembly 1655 shown in FIG. 45.

According to a preferred embodiment, as illustrated in FIGS. 29 and 30, turntable dolly base 1410 may be configured with one of the cylinder-mount track roller assemblies 1415 at each corner. As previously described, the cylinder-mount track roller assembly may be demountably engaged at the cylinder gooseneck end component 390 at the outward end of each tube module 650 by one or more screws 10 threadedly engaged with one or more threaded holes 1445 in the circumferential surface of the cylindrical mount component 1435. For added stability of the dolly base, optionally a weight component 45 may be demountably engaged with one or more of the cylindrical mount components 1435 by screws 146 at one or more threaded holes 1445 opposite the location of the mounted gooseneck end component 390, as previously described in reference to FIGS. 12 and 13 where configured with the first embodiment of cylindrical mount component 180.

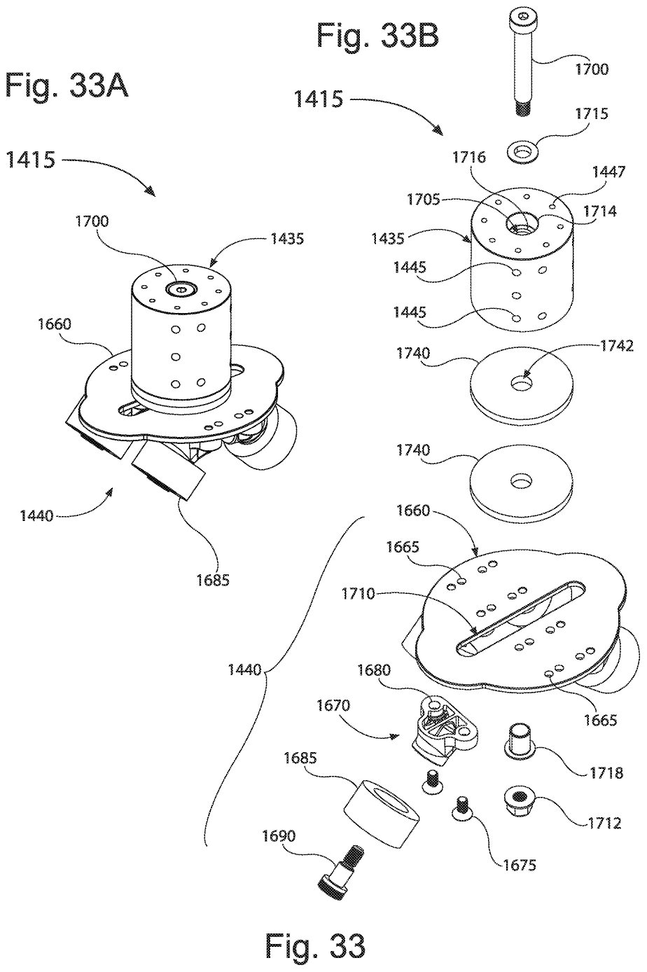

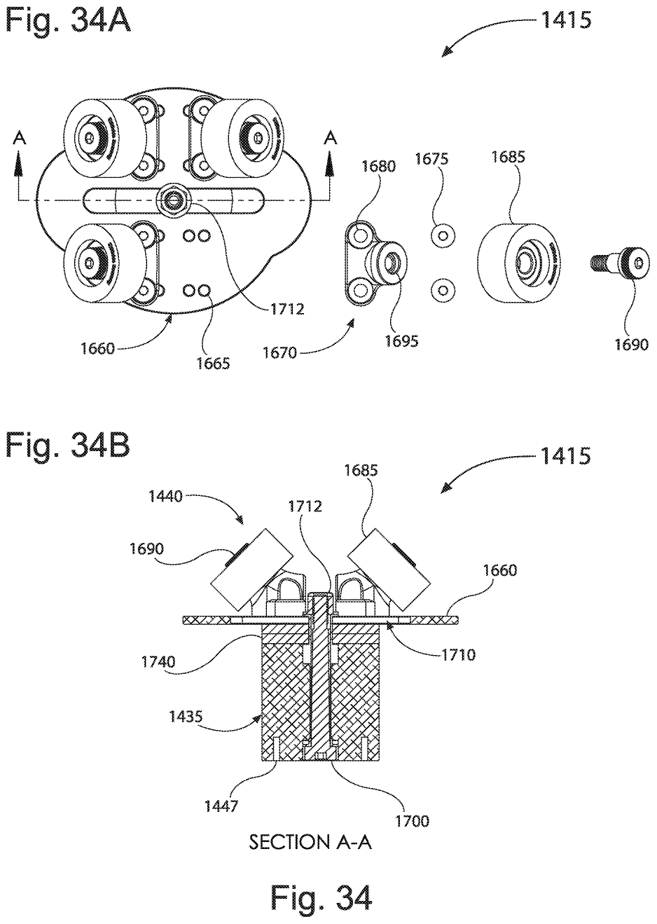

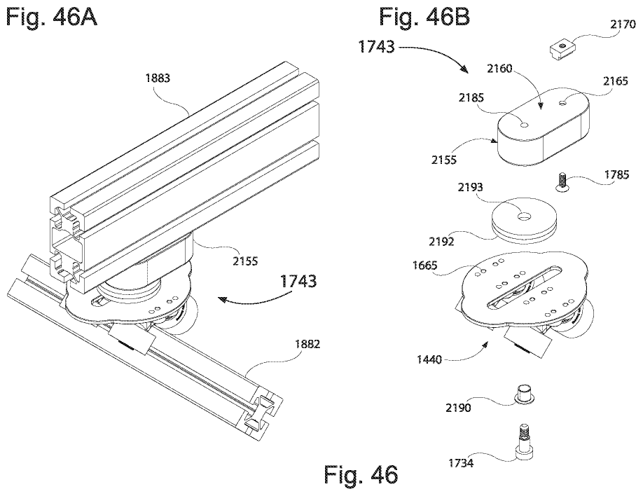

As illustrated in FIGS. 33 and 34, the cylindrical mount component 1435 may comprise a flat bottom side which may be rotationally engaged on a first lower roller elements subassembly 1440 configured for rolling engagement with a cylindrical track assembly or for rolling engagement with a square rail oriented with its sides on an incline as will be described in further detail below in reference to FIG. 46. The first lower roller elements subassembly 1440 may comprise a sliding plate 1660 having one or more sets of threaded holes 1665 whereby two or more roller mounts 1670 are demountably engaged each by one or more screws 1675, a threaded portion of which are passed through holes 1680 in the roller mounts and threadedly engaged with the threaded holes 1665. A roller 1685 may be secured to each roller mount by an axle screw 1690 threadedly engaged with a threaded hole 1695 in the roller mount. According to a preferred embodiment, axle screw 1690 is a shoulder screw. According to a preferred embodiment, the sliding plate 1660 is a flat plate. According to some embodiments, the sliding plate 1660 is a round plate. According to some embodiments, the sliding plate 1660 is a square plate. According to some embodiments, the sliding plate 1660 is a rectangular plate.

According to some embodiments, at least two sets of threaded holes 1665 in the sliding plate 1660 are provided in two rows whereby repositioning the roller mounts 1670 from one set to another widens or narrows the separation between the rollers 1685 to be configured for varying track rail diameters, as illustrated in FIGS. 33 and 34 at the wider separation for rolling engagement with the adjustable-level track assembly 1420, or at the narrower separation for rolling engagement with a standard straight and/or curved track assembly 168 as shown in FIG. 12 or track assembly 1430 as shown in FIG. 53. According to some embodiments, the contact surface and threaded hole 1695 in the roller mount 1670 may be inclined whereby the roller 1685 is mounted at an inclined angle relative to the rail of the track assembly. According to a preferred embodiment, the sliding plate 1660 comprises two rows of four threaded holes 1665 whereby four roller mounts 1670 may be configured to either of two width positions.

According to some embodiments, the cylindrical mount component 1435 may be slidably and pivotably engaged with the top of the sliding plate 1660 by a pivot screw 1700 of which at least a threaded portion is passed through a mounting hole 1705 in the center of the cylindrical mount component and through a slot 1710 in the sliding plate 1660 where it is threadedly engaged with a nut 1712 under the sliding plate. According to some embodiments, the pivot screw 1700 is a shoulder screw. According to a preferred embodiment, the nut 1712 is a locknut. According to some embodiments, a recess 1714 surrounds the central mounting hole 1705 within which the head of the pivot screw may be partially or fully contained lower than the top surface of the component. According to some embodiments, a low-friction bushing 1715 may be included between the head of the pivot screw 1700 and the cylindrical mount component 1435 thereby providing a low-friction material against which the pivot screw may more easily rotate. The cylindrical mount component may further comprise a chamfer 1716 around the central mounting hole 1705 wherein an edge of the bushing 1715 may be engaged and aligned to center. According to a preferred embodiment, bushing 1715 is a flanged bushing with a flange diameter at least slightly less than the diameter of the recess 1714 in embodiments where present.

According to some embodiments, as is illustrated in FIGS. 33 and 34, the first lower roller elements subassembly 1440 may additionally comprise a low-friction bushing 1718 inserted between the nut 1712 and the underside of the sliding plate 1660 through which the pivot screw 1700 is passed thereby providing a low-friction material against which the nut may more easily slide and rotate and removing friction between the slot 1710 and the pivot screw. According to a preferred embodiment, bushing 1718 is a flanged bushing with a flange diameter of approximately the width of the nut 1712 and wider than the slot 1710. The width of the slot 1710 is slightly wider than the diameter of the narrow elongate portion of the flanged bushing, or the diameter of the pivot screw 1700 alone in embodiments excluding the bushing, so that for either configuration they pivot within and traverse the slot from side to side the distance and angular adjustment required for the track roller assemblies 1415 and the dolly base 1410 to freely traverse straight and curved standard track assemblies such as track assemblies 168/1430 where the side-to-side and angular alignment of the track roller assemblies is required to adjust to accommodate the pitch of straight track and radiuses of curved track.

According to further embodiments, the elements and features of the first lower roller elements subassembly 1440 as described in conjunction with the elements and features of the pivot screw 1700 are equally compatible with alternative pivot screws 1720/1722/1724/1726/1728/1730/1732/1734/1736/1738, as will be described below in reference to FIGS. 36 to 50 in further embodiments of track roller assemblies which may also comprise the embodiments of the first lower roller elements subassembly 1440.

By tightening and loosening the pivot screw 1700, tension may be applied to the components between the pivot screw and the nut 1712 and may be adjusted from between firm to loose to adjust the fluidity and firmness with which the track roller assemblies 1415 pivot and slide, or may be optionally locked. According to some embodiments, one or more of a pivot disc 1740 having a central through-hole 1742 and made of a low-friction material may be included between the flat bottom of the cylindrical mount component 1435 and the top of the sliding plate 1660 to facilitate the pivoting and sliding of the cylindrical mount component above the sliding plate. According to some embodiments, the pivot disc 1740 is a flat and circular shape. According to some embodiments, the pivot disc is a plastic washer. According to a preferred embodiment as illustrated in FIGS. 33 and 34, the cylinder-mount track roller assembly 1415 includes two pivot discs 1740 each with a central through-hole 1742 with a diameter slightly wider than the lower bushing 1718 in embodiments where present around the pivot screw 1700, or a diameter slightly wider than the pivot screw where without the bushing, wherein the inner element(s) may rotate. According to embodiments with varying number and thickness of one or more pivot disc, or excluding any pivot disc, varying lengths of bushing 1718 may be provided.

According to a preferred embodiment, the central mounting hole 1705 may be threaded with the minor diameter of the threads remaining at least slightly wider than the diameter of the narrower pivot screw 1700 passing through, thereby providing a threaded hole in which the turntable dolly base 1410 may be optionally configured with threaded-stem casters 375/1175 or threaded-stem foot components 385 to be configured as a turntable stand.

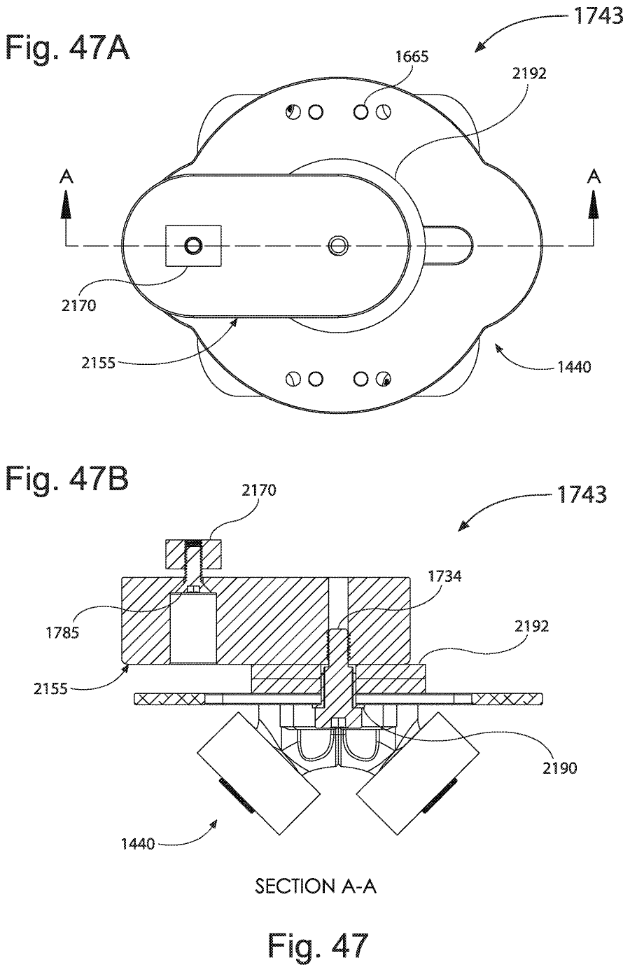

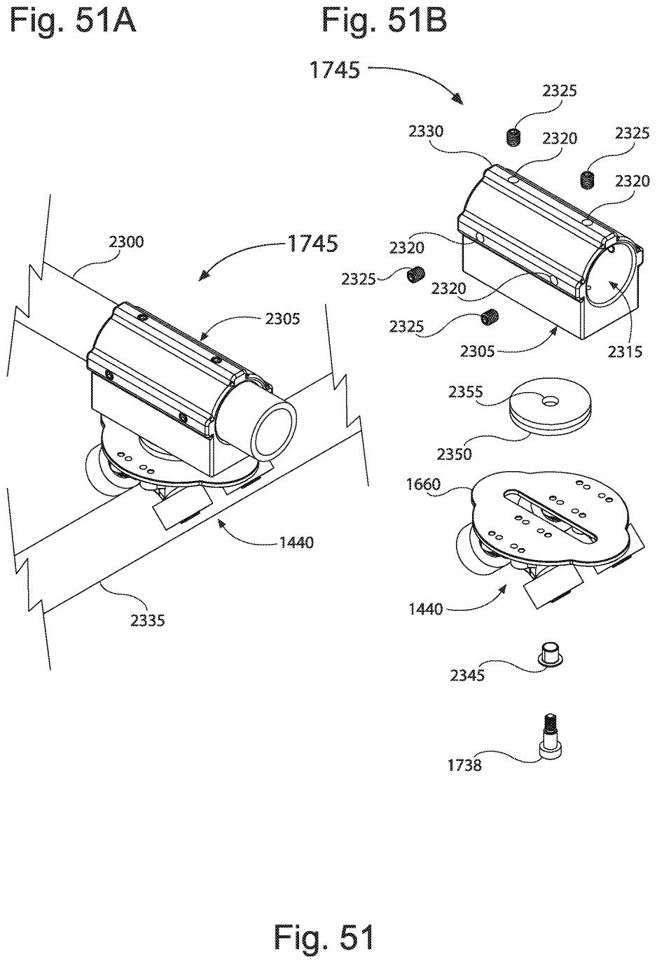

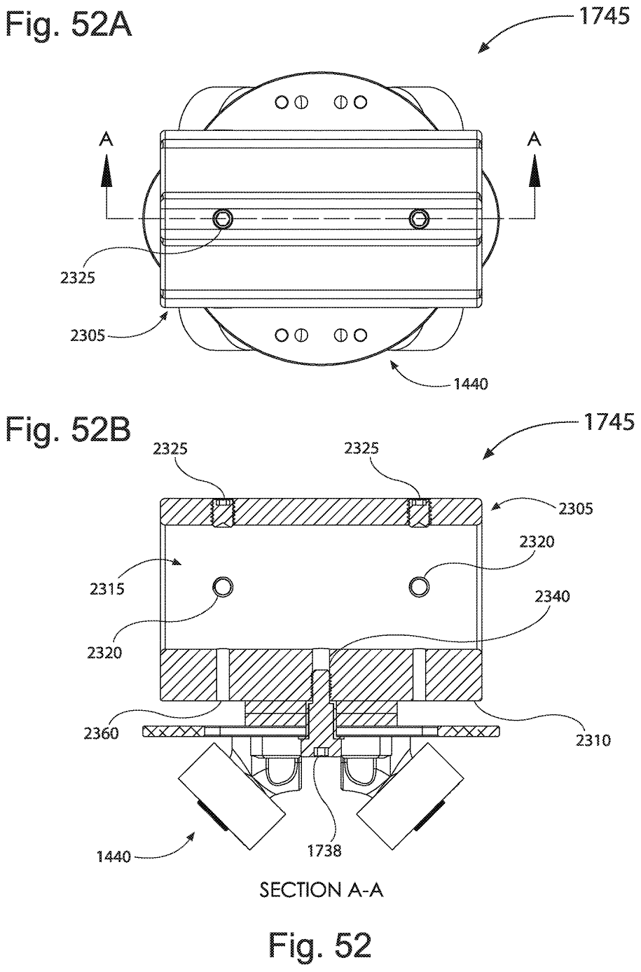

According to some embodiments, the arrangement of the pivot screw 1700 and the nut 1712 may be inverted with the head of the pivot screw engaged under the sliding plate 1660 and a threaded portion oriented upward into a captive nut secured within a recess in the top section of the cylindrical mount component, as like shown in the fourth side-mount track roller assembly 1640 which will be described below in reference to FIGS. 43 and 44. According to further embodiments, the recess and the nut may be excluded, and only a threaded portion of the pivot screw 1700 is entered into the mounting hole 1705 from the underside where it is threadedly engaged directly with a matching thread of the mounting hole, as like shown in a fifth embodiment of a side-mount track roller assembly 1743, as will be described in further detail below in reference to FIGS. 46 and 47, and in a pipe fitting mount track roller assembly 1745 as will be described in further detail below in reference to FIGS. 51 and 52.

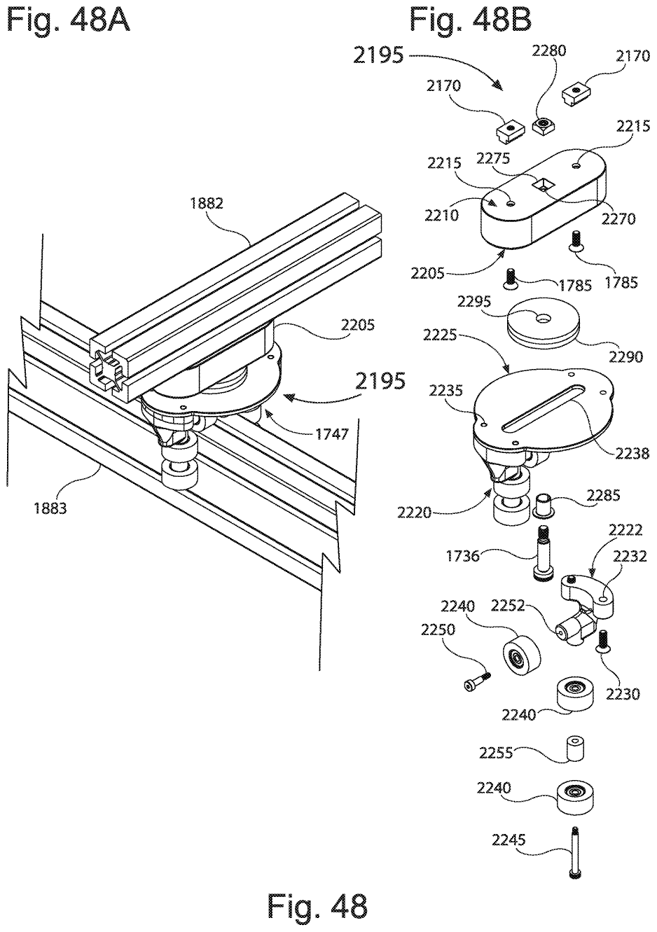

According to further embodiments, cylinder-mount track roller assemblies comprising the cylindrical mount components 1435 demountably engaged at the corners of a dolly base by gooseneck end connectors 390 may alternatively comprise embodiments of a second lower roller elements subassembly 1747 or embodiments of a third lower roller elements subassembly 1748 in place of the first lower roller elements subassembly 1440, as will be described below in reference to FIGS. 48 to 50, whereby the cylinder-mount track roller assemblies may be configured for rolling engagement with square and/or rectangular rail elements or rail elements having at least three flat sides.

According to further embodiments, in place of the vertical track assembly 1405 the turntable dolly base 1410 may be configured with a vertical adjustment assembly 700, as previously described in reference to FIGS. 12 and 14, to form a height-adjustable dolly as like previously described in reference to the height-adjustable dolly 640.

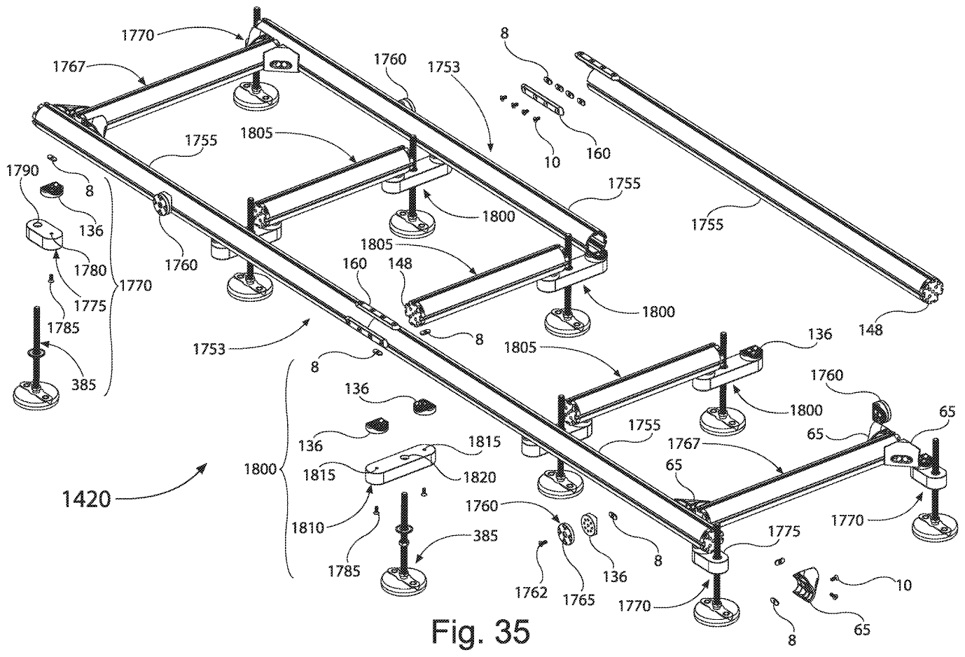

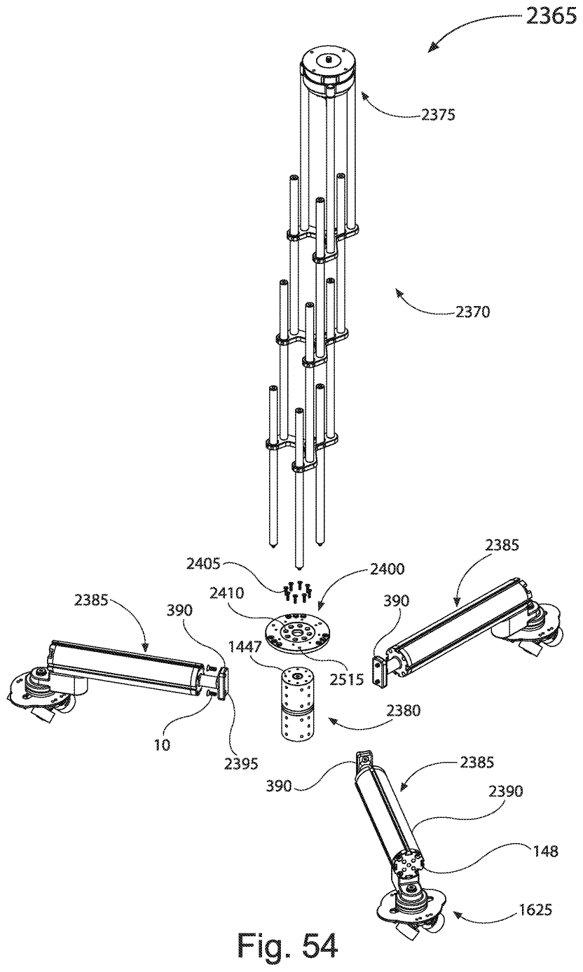

As shown in FIGS. 29 and 35, further embodiments of an adjustable-level track assembly may be configured for rolling engagement of the height-adjustable dolly 640, or vertical track dollies 22/1400, or rotating jib dolly 1030, or further dollies that may be configured using any one of the turntable dolly bases 25/645/1035/1410, or a dolly base assembled using square framing components and/or rectangular framing components as described below in reference to FIG. 46, or a rotating hub dolly base 1750, as described below in reference to FIGS. 53 and 54, or dolly base or any other type of dolly or platform or equipment or device for which an adjustable-level track assembly may be sized and configured to be compatible with. Adjustable-level track assembly 1420 comprises two parallel horizontal rail assemblies 1753 with cylindrical structural components 1755 forming the rails. Each horizontal rail assembly may comprise a single elongate cylindrical structural component or according to some embodiments is configured to be extended or shortened by comprising two or more cylindrical structural components which can be added or removed, as shown in FIG. 35. Optionally a threaded end component 148, as previously described in reference to FIG. 2, may be fastened at one or more of the outer ends of the cylindrical structural components 1755.

According to some embodiments, a series of two or more cylindrical structural components 1755 may be conjoined end to end by one or more cylinder external braces 160, as previously described in reference to FIG. 2, comprising two or more through-holes and a concave face whereby it may be demountably engaged against the sides of the two corresponding cylindrical structural components 1755 by screws 10 with nuts 8 in the nut channels. The low depth and narrow width of the cylinder external braces 160 allow for clear passage of the track roller assemblies 170/1415/1625/1630/1635/1640/1645/1650. According to further embodiments, channel braces 156 as previously described may additionally be used in combination with or in place of the cylinder external braces 160 secured in the nut channels by set screws 158. The horizontal rail assemblies 1753 may also include one or more of a side-mount plate 1760 to provide a stopper element at which the rollers of the one or more corresponding track roller assemblies will contact and be stopped. The side-mount plates 1760 may be repositioned along the rails by fastening and unfastening a screw 1762, or a threaded knob 162 for ease-of-use, through a hole 1765 in the plate and threadedly engaged with a nut 8 in one of the nut channels. Alternatively, a stopper element may be provided by one or more corner brace connectors 65 slidable along a nut channel where fastened by a nut 8.

According to some embodiments, the pair of horizontal rail assemblies 1753 are conjoined near their ends by a cylindrical structural component 1767 demountably engaged perpendicularly by one or two corner brace connectors 65 secured at both ends of the cylindrical structural component 1767 by screws 10 and nuts 8 and the other sides of the corner braces secured by screws and nuts to the nut channels on the inward side of each rail assembly 1753. Optionally a threaded end component 148 may be fastened at one or both ends of the cylindrical structural component 1767. According to further embodiments, the corner braces 65 and optional threaded end components 148 may be replaced by a cylinder gooseneck end component 390 fastened to each end of the cylindrical structural component 1767 and oppositely fastened by screws 10 and nuts 8 to the inward side of each rail assembly 1753.

Each of the parallel horizontal rail assemblies 1753 may be downwardly supported at each end by a rail end-support assembly 1770 demountably engaged with the underside of the rail assemblies. According to a preferred embodiment, the rail end-support assembly 1770 comprises a threaded mount component 1775 having near one end a through-hole 1780 whereby a threaded portion of a screw 1785 is passed through and then through a concave base component 136 whereby the assembly may be secured to the rail assembly 1753 by a nut 8 in the nut channel along the underside of the rail assembly. According to a preferred embodiment, there is a recessed area around the through-hole 1780 in which the head of the screw 1785 sits.

Toward the other end of the threaded mount component 1775 a threaded hole 1790 may be provided whereby a threaded-stem foot component 385 may be threadedly engaged. According to a preferred embodiment, the foot component is provided with a locking nut and washer to be set against the bottom of the threaded mount component 1775 to prevent unwanted movement of the foot's threaded stem during operation. The threaded-stem foot component 385 may be extended or retracted through the threaded mount component 1775 to raise or lower its corner of the track assembly 1420 to raise or lower and level the track assembly in conjunction with the other three rail end-support assemblies 1770. According to further embodiments, the threaded-stem foot components 385 may be replaced by threaded-stem casters 375. According to some embodiments, the threaded mount component 1775 and a first embodiment of a flat side-mount component 1795 included in track roller assemblies, as will be described in further detail below in reference to FIGS. 38 and 39, may be the same component.

According to some embodiments, the adjustable-level track assembly 1420 may be additionally supported by one or more pairs of a rail cross-support assembly 1800 conjoined by a cylindrical structural component 1805. Optionally, the cylindrical structural component 1805 may be provided with a threaded end component 148 at one or both ends. The rail cross-support assembly 1800 may comprise a threaded double mount component 1810 having near the ends of the component a pair of through-holes 1815 whereby at each a threaded portion of a screw 1785 is passed through and then through each a concave base component 136 whereby one end is secured to the underside of the rail assemblies 1753 by a nut 8, and the opposite end secured to the underside of the cylindrical structural component 1805 conjoining the pair of the rail cross-support assemblies 1800. According to a preferred embodiment, there is a recessed area around the through-holes 1815 in which the head of the screw 1785 sits.

A threaded hole 1820 may be located near the middle of the threaded double mount component 1810 whereby a threaded-stem foot component 385 may be threadedly engaged. The threaded-stem foot component 385 may be extended or retracted through the component 1810 to raise or lower its area of the track assembly 1420 to thereby adjust the height and horizontal level of the track assembly in conjunction with the one or more other cross-support assemblies 1800 and the rail end-support assemblies 1770 as previously described. The length of the threaded double mount component 1810 and the midway position of its threaded hole 1820 may be configured so that an extended threaded stem of the foot component 385 remain passable on the inward side of the track roller assemblies 170/1415/1625/1630/1635/1640/1645/1650/1743/1745. According to further embodiments, the threaded-stem foot components 385 of the cross-support assemblies 1800 may be replaced by threaded-stem casters 375. According to some embodiments, the threaded double mount component 1810 and a first flat double side-mount component 1825 of the track roller assemblies, as will be described in further detail below in reference to FIG. 40, may be the same component.

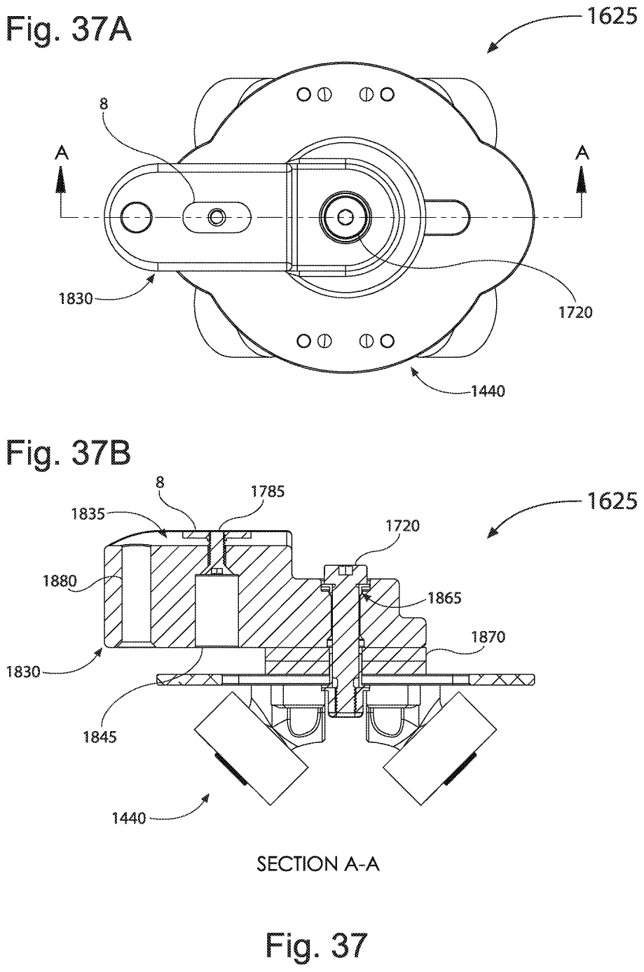

As illustrated in FIGS. 36 and 37, the embodiments of a track roller assembly may further include a first side-mount track roller assembly 1625 which may be configured as the track roller elements of the rotating hub dolly base 1750, as will be described below in reference to FIGS. 53 and 54, or a dolly base similar to any one of the turntable dolly bases 25/645/1035/1410, or any other type of dolly base or platform or equipment or device comprising a compatible round surface and a threadedly engageable element at which embodiments of the first side-mount track roller assembly 1625 may be engaged.

According to some embodiments, the first side-mount track roller assembly 1625 may comprise a first concave side-mount component 1830 having a flat bottom surface and an upward concave surface 1835 at which it may be demountably engaged with a cylindrical structural component 1840 by a threaded portion of a screw 1785 passed through a through-hole 1845 in the underside of the mount component 1830 and out through the concave surface 1835 where it may be threadedly engaged with a nut 8 in the nut channel of the underside of the cylindrical structural component 1840. According to a preferred embodiment, there is a recessed area around the through-hole 1845 in which the head of the screw 1785 sits.

According to some embodiments, the first side-mount track roller assembly 1625 may comprise the first lower roller elements subassembly 1440, as previously described in reference to FIGS. 33 and 34, configured for rolling engagement with a cylindrical track assembly such as the adjustable-level track assemblies 165/1420, or standard straight or curved track assemblies 168/1430, and according to further embodiments configured for other types of round track elements, or square and rectangular rail elements where the sides are oriented on an incline matching the incline of the rollers 1685, as will be described in further detail below in reference to FIG. 46.

According to a preferred embodiment, elements and features of the first lower roller elements subassembly 1440 are the same as previously described in reference to FIGS. 33 and 34, whereby in this assembly 1625 the first concave side-mount component 1830 may be slidably and pivotably engaged with the top of the sliding plate 1660 by pivot screw 1720. At least a threaded portion of the pivot screw 1720 is passed through a mounting hole 1850 near an end of the concave side-mount component 1830, and there passed through the slot 1710 where it is threadedly engaged with the nut 1712, as previously described. According to some embodiments, the pivot screw 1720 is a shoulder screw. According to some embodiments, a recess 1855 surrounds the mounting hole 1850 within which the head of the pivot screw may be partially or fully contained lower than the top surface of the component. According to some embodiments, a low-friction bushing 1860 may be included between the head of the pivot screw 1720 and the mount component 1830 thereby providing a low-friction material against which the pivot screw may more easily rotate. The mount component may further comprise a chamfer 1865 around the mounting hole 1850 wherein an edge of the bushing 1860 may be engaged and aligned to center. According to a preferred embodiment, bushing 1860 is a flanged bushing with a flange diameter at least slightly less than the diameter of the recess 1855 in embodiments where present.

By tightening and loosening the pivot screw 1720, tension may be applied to the components between the pivot screw and the nut 1712 and may be adjusted from between firm to loose to adjust the fluidity and firmness with which the track roller assembly 1625 pivots and slides, or may be optionally locked. According to some embodiments, one or more of a pivot disc 1870 having a central through-hole 1875 and made of a low-friction material may be included between the flat bottom of the first concave side-mount component 1830 and the top of the sliding plate 1660 to facilitate the pivoting and sliding of the mount component above the sliding plate. According to some embodiments, the pivot disc 1870 is a flat and circular shape. According to some embodiments, the pivot disc is a plastic washer. According to a preferred embodiment as illustrated in FIGS. 36 and 37, the first side-mount track roller assembly 1625 includes two of the pivot discs 1870 each with the central through-hole 1875 with a diameter slightly wider than the lower bushing 1718 in embodiments where present around the pivot screw 1720, or a diameter slightly wider than the pivot screw where without the bushing, in which the inner element(s) may rotate. According to embodiments with varying number and thickness of one or more pivot disc, or excluding any pivot disc, varying lengths of bushing 1718 may be provided.

According to some embodiments, the entire top surface may be the concave surface 1835 and the recess 1855 contained within and the pivot screw 1720 positioned with the head lower than the concave surface. As illustrated in FIGS. 36 and 37, according to a preferred embodiment, the first concave side-mount component 1830 comprises a lower end where the head of the pivot screw rests below the concave surface. According to these embodiments, a track roller assembly 1625 may be positioned anywhere along the nut channel of a cylindrical structural component 1840, where fastened by the screw 1785 with a nut 8, to configure and reconfigure dolly bases for track assemblies of varying widths using a single set of components, or threadedly engaged with an underside of any other type of dolly or platform or equipment or device comprising a threadedly engageable element and a round surface compatible with the concave feature of the mount component 1830.

According to a preferred embodiment, the mounting hole 1850 may be threaded with the minor diameter of the threads remaining at least slightly wider than the diameter of the narrower pivot screw 1720 passing through, thereby providing a threaded hole in which the first concave side-mount component 1830 may be optionally configured with threaded-stem casters 375/1175 or threaded-stem foot components 385 in place of the first lower roller elements subassembly 1440. According to some embodiments, the concave side-mount component 1830 additionally comprises a threaded hole 1880 whereby a threaded-stem caster 375/1175 or threaded-stem foot component 385 may be optionally threadedly engaged when the track roller elements are not in use and optionally the dolly base can be rolled or stood on the ground without damaging or removing the track roller elements.

According to some embodiments, the arrangement of the pivot screw 1720 and the nut 1712 may be inverted with the head of the pivot screw engaged under the sliding plate 1660 and a threaded portion oriented upward into a captive nut secured within a recess in the top section of the concave side-mount component, as like shown in the fourth side-mount track roller assembly 1640 which will be described below in reference to FIGS. 43 and 44. According to further embodiments, the recess and the nut may be excluded, and only a threaded portion of the pivot screw 1720 is entered into the mounting hole 1850 from the underside where it is threadedly engaged directly with a matching thread of the mounting hole, as like shown in the fifth embodiment of side-mount track roller assembly 1743 and the pipe fitting mount track roller assembly 1745 as will be described in further detail below.

According to further embodiments, the first concave side-mount component 1830, pivot screw 1720, bushing 1860, and pivot disc(s) 1870 may be alternatively configured with the second lower roller elements subassembly 1747 or the third lower roller elements subassembly 1748 for rolling engagement with square or rectangular rail elements or rail elements having at least three flat sides, as will be described below in reference to FIGS. 48 to 50.

As illustrated in FIGS. 38 and 39, the embodiments of a track roller assembly may further include a second side-mount track roller assembly 1630 which may be configured as the track roller elements of the rotating hub dolly base 1750 in FIGS. 53 and 54, or a dolly base similar to any one of the turntable dolly bases 25/645/1035/1410, or a dolly base assembled using two or more of a square framing component 1882 or two or more of a rectangular framing component 1883 or combination as shown in FIGS. 46 and 48, or any other type of dolly base or platform or equipment or device comprising a compatible round or flat surface and a threadedly engageable element at which embodiments of the second side-mount track roller assembly 1630 may be engaged.

According to some embodiments, the second side-mount track roller assembly 1630 may comprise a first flat side-mount component 1795 having a flat bottom surface and a flat top surface 1885 at which it may be demountably engaged with a cylindrical structural component 1840 via a concave base component 136 of which the flat side rests against the flat top surface 1885 of the side-mount component and the concave side engages with the underside of the cylindrical structural component 1840. A threaded portion of a screw 1785 is passed through a through-hole 1890 in the underside of the side-mount component 1795 and out through the flat top surface 1885 and through the concave base component 136 where it may be threadedly engaged with a nut 8 in the nut channel of the underside of the cylindrical structural component 1840. According to a preferred embodiment, there is a recessed area around the through-hole 1890 in which the head of the screw 1785 sits.

According to some embodiments, the second side-mount track roller assembly 1630 may comprise the first lower roller elements subassembly 1440, as previously described in reference to FIGS. 33 and 34, configured for rolling engagement with a cylindrical track assembly such as the adjustable-level track assemblies 165/1420, or standard straight or curved track assemblies 168/1430, and according to further embodiments configured for other types of round track elements, or square and rectangular rail elements where the sides are oriented on an incline matching the incline of the rollers 1685.

According to a preferred embodiment, elements and features of the first lower roller elements subassembly 1440 are the same as previously described in reference to FIGS. 33 and 34, whereby in this assembly 1630 the first flat side-mount component 1795 may be slidably and pivotably engaged with the top of the sliding plate 1660 by pivot screw 1722. At least a threaded portion of the pivot screw 1722 is passed through a mounting hole 1895 near an end of the first flat side-mount component 1795, and there passed through the slot 1710 where it is threadedly engaged with the nut 1712, as previously described. According to some embodiments, the pivot screw 1722 is a shoulder screw. According to some embodiments, a recess 1900 surrounds the mounting hole 1895 within which the head of the pivot screw may be partially or fully contained lower than the top surface of the component. According to some embodiments, a low-friction bushing 1905 may be included between the head of the pivot screw 1722 and the mount component 1795 thereby providing a low-friction material against which the pivot screw may more easily rotate. The mount component may further comprise a chamfer 1910 around the mounting hole 1895 wherein an edge of the bushing 1905 may be engaged and aligned to center. According to a preferred embodiment, bushing 1905 is a flanged bushing with a flange diameter at least slightly less than the diameter of the recess 1900 in embodiments where present.

By tightening and loosening the pivot screw 1722, tension may be applied to the components between the pivot screw and the nut 1712 and may be adjusted from between firm to loose to adjust the fluidity and firmness with which the track roller assembly 1630 pivots and slides, or may be optionally locked. According to some embodiments, one or more of a pivot disc 1915 having a central through-hole 1920 and made of a low-friction material may be included between the flat bottom of the side-mount component 1795 and the top of the sliding plate 1660 to facilitate the pivoting and sliding of the mount component above the sliding plate. According to some embodiments, the pivot disc 1915 is a flat and circular shape. According to some embodiments, the pivot disc is a plastic washer. According to a preferred embodiment as illustrated in FIGS. 38 and 39, the second side-mount track roller assembly 1630 includes two of the pivot discs 1915 each with the central through-hole 1920 with a diameter slightly wider than the lower bushing 1718 in embodiments where present around the pivot screw 1722, or a diameter slightly wider than the pivot screw where without the bushing, wherein the inner element(s) may rotate. According to embodiments with varying number and thickness of one or more pivot disc, or excluding any pivot disc, varying lengths of bushing 1718 may be provided.

According to some embodiments, the entire head of the pivot screw 1722 may be located above the top surface 1885 of the first flat side-mount component 1795 and no recess 1900 provided and the concave base component 136 provided with a depth greater than the height of the pivot screw head. According to some embodiments, the entire head of the pivot screw 1722 may be located lower than the top surface 1885 of the side-mount component 1795 in a recess 1900 with a depth greater than the height of the pivot screw head, where required for mounting directly against the side of square or rectangular framing components 1882/1883, as will be described in further detail below in reference to FIGS. 46 and 47 where the mount component may be interchangeable with the side-mount component 1795. As illustrated in FIGS. 38 and 39, according to some embodiments a portion of the head of the pivot screw 1722 may be located within the recess 1900 and the depth of the cooperating concave base component 136 may be greater than the protruding portion of the pivot screw head.

According to these embodiments in conjunction with the concave base component 136, a track roller assembly 1630 may be positioned anywhere along the nut channel of a cylindrical structural component 1840 where fastened by the screw 1785 with a nut 8, to configure and reconfigure dolly bases for track assemblies of varying widths using a single set of components, or threadedly engaged with an underside of any other type of dolly or platform or equipment or device comprising a threadedly engageable element and a round surface compatible with the concave base component 136, or with a flat underside where the concave base component may be excluded. Embodiments may also be demountably engaged at varying angles of the track roller assembly 1630 relative to a cooperating flat component, or the cylindrical structural component 1840 given that the angular orientation of the concave base component may be adjusted on the flat top surface 1885.

According to a preferred embodiment, the mounting hole 1895 may be threaded with the minor diameter of the threads remaining at least slightly wider than the diameter of the narrower pivot screw 1722 passing through, thereby providing a threaded hole in which the first flat side-mount component 1795 may be optionally configured with threaded-stem casters 375/1175 or threaded-stem foot components 385 in place of first lower roller elements subassembly 1440, as illustrated in FIG. 35 where according to a preferred embodiment the threaded mount component 1775 and the first flat side-mount component 1795 may be the same component.

According to some embodiments, the arrangement of the pivot screw 1722 and the nut 1712 may be inverted with the head of the pivot screw engaged under the sliding plate 1660 and a threaded portion oriented upward into a captive nut secured within a recess in the top section of the flat side-mount component, as like shown in the fourth side-mount track roller assembly 1640 which will be described below in reference to FIGS. 43 and 44. According to further embodiments, the recess and the nut may be excluded, and only a threaded portion of the pivot screw 1722 is entered into the mounting hole 1895 from the underside where it is threadedly engaged directly with a matching thread of the mounting hole, as like shown in the fifth embodiment of side-mount track roller assembly 1743 and the pipe fitting mount track roller assembly 1745, as will be described in further detail below.

According to further embodiments, the first flat side-mount component 1795, pivot screw 1722, bushing 1905, and pivot disc(s) 1915 may be alternatively configured with the second lower roller elements subassembly 1747 or the third lower roller elements subassembly 1748 for rolling engagement with square or rectangular rail elements or rail elements having at least three flat sides, as will be described below in reference to FIGS. 48 to 50.

As illustrated in FIG. 40, the embodiments of a track roller assembly may further include a first double side-mount track roller assembly 1645 which may be configured as the track roller elements of the rotating hub dolly base 1750 in FIGS. 53 and 54, or a dolly base similar to any one of the turntable dolly bases 25/645/1035/1410, or a dolly base assembled using two or more of the square framing component 1882 or two or more of the rectangular framing component 1883 or combination as shown in FIGS. 46 and 48, or any other type of dolly base or platform or equipment or device comprising a compatible round or flat surface and threadedly engageable elements at which embodiments of the first double side-mount track roller assembly 1645 may be engaged.

According to some embodiments, the first double side-mount track roller assembly 1645 may comprise a first flat double side-mount component 1825 having a flat bottom surface and a flat top surface 1925 at which it may be demountably engaged with one or two of a cylindrical structural component 1840 via two concave base components 136 of which the flat sides rest against the flat top surface 1925 of the side-mount component and the concave sides engage with the underside of the one or two cylindrical structural component 1840. The threaded portion of two screws 1785 are passed through two through-holes 1930 in the underside of the first flat double side-mount component 1825 near opposite ends, and out through the flat top surface 1925 and through the concave base components 136 where they may be threadedly engaged with nuts 8 in the nut channel of the underside of the one or two cylindrical structural component 1840. According to a preferred embodiment, there is a recessed area around the through-holes 1930 in which the head of the screws 1785 sit.

According to some embodiments, the first double side-mount track roller assembly 1645 may comprise the first lower roller elements subassembly 1440, as previously described in reference to FIGS. 33 and 34, configured for rolling engagement with a cylindrical track assembly such as the adjustable-level track assemblies 165/1420, or standard straight or curved track assemblies 168/1430, and according to further embodiments configured for other types of round track elements, or square and rectangular rail elements where the sides are oriented on an incline matching the incline of the rollers 1685.

According to a preferred embodiment, elements and features of the first lower roller elements subassembly 1440 are the same as previously described in reference to FIGS. 33 and 34, whereby in this assembly 1645 the first flat double side-mount component 1825 may be slidably and pivotably engaged with the top of the sliding plate 1660 by pivot screw 1724. At least a threaded portion of the pivot screw 1724 is passed through a mounting hole 1935 midway along the side-mount component 1825, and there passed through the slot 1710 where it is threadedly engaged with the nut 1712, as previously described. According to some embodiments, the pivot screw 1724 is a shoulder screw. According to some embodiments, a recess 1940 surrounds the mounting hole 1935 within which the head of the pivot screw may be partially or fully contained lower than the top surface of the component. According to some embodiments, a low-friction bushing 1945 may be included between the head of the pivot screw 1724 and the mount component 1825 thereby providing a low-friction material against which the pivot screw may more easily rotate. The mount component may further comprise a chamfer 1950 around the mounting hole 1935 wherein an edge of the bushing 1945 may be engaged and aligned to center. According to a preferred embodiment, bushing 1945 is a flanged bushing with a flange diameter at least slightly less than the diameter of the recess 1940 in embodiments where present.

By tightening and loosening the pivot screw 1724, tension may be applied to the components between the pivot screw and the nut 1712 and may be adjusted from between firm to loose to adjust the fluidity and firmness with which the track roller assembly 1645 pivots and slides, or may be optionally locked. According to some embodiments, one or more of a pivot disc 1955 having a central through-hole 1960 and made of a low-friction material may be included between the flat bottom of the first flat double side-mount component 1825 and the top of the sliding plate 1660 to facilitate the pivoting and sliding of the mount component above the sliding plate. According to some embodiments, the pivot disc 1955 is a flat and circular shape. According to some embodiments, the pivot disc is a plastic washer. According to a preferred embodiment as illustrated in FIG. 40, the first double side-mount track roller assembly 1645 includes two of the pivot discs 1955 each with the central through-hole 1960 with a diameter slightly wider than the lower bushing 1718 in embodiments where present around the pivot screw 1724, or a diameter slightly wider than the pivot screw where without the bushing, wherein the inner element(s) may rotate. According to embodiments with varying number and thickness of one or more pivot disc, or excluding any pivot disc, varying lengths of bushing 1718 may be provided.

According to some embodiments, the entire head of the pivot screw 1724 may be located above the top surface 1925 of the first flat double side-mount component 1825 and no recess 1940 provided and the concave base components 136 may be provided with a depth greater than the height of the pivot screw head. According to some embodiments, the entire head of the pivot screw 1724 may be located lower than the top surface 1925 of the side-mount component in a recess with a depth greater than the height of the pivot screw head. As illustrated in FIG. 40, according to some embodiments a portion of the head of the pivot screw 1724 may be located within the recess 1940 and the depth of the cooperating concave base components 136 may be greater than the protruding portion of the pivot screw head. According to these embodiments in conjunction with the concave base components, a track roller assembly 1645 may be positioned anywhere along the nut channel of a single cylindrical structural component 1840 or threadedly engaged with an underside of any other type of dolly or platform or equipment or device comprising threadedly engageable elements and a round surface compatible with the concave base components 136, or with a flat underside where the concave base components may be excluded, such as the square and rectangular framing components 1882/1883. According to some embodiments, as shown in FIG. 40, two cylindrical structural components 1840 may be demountably engaged perpendicular to one another or at varying other relative angles as the angular orientation of the concave base components may be adjusted on the flat top surface 1925.

According to a preferred embodiment, the mounting hole 1935 may be threaded with the minor diameter of the threads remaining at least slightly wider than the diameter of the narrower pivot screw 1724 passing through, thereby providing a threaded hole in which the first flat double side-mount component 1825 may be optionally configured with threaded-stem casters 375/1175 or threaded-stem foot components 385 in place of the first lower roller elements subassembly 1440, as illustrated in FIG. 35 where according to a preferred embodiment the threaded double mount component 1810 and the first flat double side-mount component 1825 may be the same component.

According to some embodiments, the arrangement of the pivot screw 1724 and the nut 1712 may be inverted with the head of the pivot screw engaged under the sliding plate 1660 and a threaded portion oriented upward into a captive nut secured within a recess in the top section of the flat double side-mount component, as like shown in the fourth side-mount track roller assembly 1640 which will be described below in reference to FIGS. 43 and 44. According to further embodiments, the recess and the nut may be excluded, and only a threaded portion of the pivot screw 1724 is entered into the mounting hole 1935 from the underside where it is threadedly engaged directly with a matching thread of the mounting hole, as like shown in the fifth embodiment of side-mount track roller assembly 1743 and the pipe fitting mount track roller assembly 1745.

According to further embodiments, the first flat double side-mount component 1825, pivot screw 1724, bushing 1945, and pivot disc(s) 1955 may be alternatively configured with the second lower roller elements subassembly 1747 or the third lower roller elements subassembly 1748 for rolling engagement with square or rectangular rail elements or rail elements having at least three flat sides, as will be described below in reference to FIGS. 48 to 50.

As illustrated in FIG. 41, the embodiments of a track roller assembly may further include a third side-mount track roller assembly 1635 which may be configured as the track roller elements of the rotating hub dolly base 1750 in FIGS. 53 and 54, or a dolly base similar to any one of the turntable dolly bases 25/645/1035/1410, or a dolly base assembled using two or more of the square framing component 1882 or two or more of the rectangular framing component 1883 or combination as shown in FIGS. 46 and 48, or any other type of dolly base or platform or equipment or device comprising a compatible round or flat surface and a threadedly engageable element at which embodiments of the third side-mount track roller assembly 1635 may be engaged.

According to some embodiments, the third side-mount track roller assembly 1635 may comprise a flat dual-mount side-mount component 1965 having a flat bottom surface and a flat top surface 1970 at which it may be demountably engaged with a cylindrical structural component 1840 via a concave base component 136 of which the flat side rests against the flat top surface 1970 of the side-mount component and the concave side engages with the underside of the cylindrical structural component 1840. The threaded portion of a screw 1785 is passed through a through-hole 1975 in the underside of the side-mount component and out through the flat top surface 1970 and through the concave base component 136 where it may be threadedly engaged with a nut 8 in the nut channel of the underside of the cylindrical structural component 1840. According to a preferred embodiment, there is a recessed area around the through-hole 1975 in which the head of the screw 1785 sits.

According to some embodiments, the third side-mount track roller assembly 1635 may comprise the first lower roller elements subassembly 1440, as previously described in reference to FIGS. 33 and 34, configured for rolling engagement with a cylindrical track assembly such as the adjustable-level track assemblies 165/1420, or standard straight or curved track assemblies 168/1430, and according to further embodiments configured for other types of round track elements, or square and rectangular rail elements where the sides are oriented on an incline matching the incline of the rollers 1685.

The flat dual-mount side-mount component 1965 may additionally comprise a threaded hole 1978 whereby a threaded-stem caster 375/1175 or threaded-stem foot component 385 may be optionally threadedly engaged when the track roller elements are not in use and optionally the dolly base can be rolled or stood on the ground without damaging or removing the track roller elements.

According to some embodiments, elements and features of the first lower roller elements subassembly 1440 are the same as previously described in reference to FIGS. 33 and 34, whereby in this assembly 1635 the flat dual-mount side-mount component 1965 may be slidably and pivotably engaged with the top of the sliding plate 1660 by pivot screw 1726. At least a threaded portion of the pivot screw 1726 is passed through a mounting hole 1980 near one end of the component 1965, and there passed through the slot 1710 where it is threadedly engaged with the nut 1712, as previously described. According to some embodiments, the pivot screw 1726 is a shoulder screw. According to some embodiments, a recess 1985 surrounds the mounting hole 1980 within which the head of the pivot screw may be partially or fully contained lower than the top surface of the component. According to some embodiments, a low-friction bushing 1990 may be included between the head of the pivot screw 1726 and the mount component 1965 thereby providing a low-friction material against which the pivot screw may more easily rotate. The mount component may further comprise a chamfer 1995 around the mounting hole 1980 wherein an edge of the bushing 1990 may be engaged and aligned to center. According to a preferred embodiment, bushing 1990 is a flanged bushing with a flange diameter at least slightly less than the diameter of the recess 1985 in embodiments where present.

By tightening and loosening the pivot screw 1726, tension may be applied to the components between the pivot screw and the nut 1712 and may be adjusted from between firm to loose to adjust the fluidity and firmness with which the track roller assembly 1635 pivots and slides, or may be optionally locked. According to some embodiments, one or more of a pivot disc 2000 having a central through-hole 2005 and made of a low-friction material may be included between the flat bottom of the side-mount component 1965 and the top of the sliding plate 1660 to facilitate the pivoting and sliding of the mount component above the sliding plate. According to some embodiments, the pivot disc 2000 is a flat and circular shape. According to some embodiments, the pivot disc is a plastic washer. According to a preferred embodiment as illustrated in FIG. 41, the third side-mount track roller assembly 1635 includes two of the pivot discs 2000 each with the central through-hole 2005 with a diameter slightly wider than the lower bushing 1718 in embodiments where present around the pivot screw 1726, or a diameter slightly wider than the pivot screw where without the bushing, wherein the inner element(s) may rotate. According to embodiments with varying number and thickness of one or more pivot disc, or excluding any pivot disc, varying lengths of bushing 1718 may be provided.

According to some embodiments, the entire head of the pivot screw 1726 may be located above the top surface 1970 of the flat dual-mount side-mount component 1965 and no recess 1985 provided and the concave base component 136 may be provided with a depth greater than the height of the pivot screw head. According to some embodiments, the entire head of the pivot screw 1726 may be located lower than the top surface 1970 of the side-mount component in a recess with a depth greater than the height of the pivot screw head. As illustrated in FIG. 41, according to some embodiments a portion of the head of the pivot screw 1726 may be located within the recess 1985 and the depth of the cooperating concave base component 136 may be greater than the protruding portion of the pivot screw head. According to these embodiments in conjunction with the concave base component, a track roller assembly 1635 may be positioned anywhere along the nut channel of a cylindrical structural component 1840 or threadedly engaged with an underside of any other type of dolly base or platform or equipment or device comprising a threadedly engageable element and a round surface compatible with the concave base component 136, or with a flat underside of a component where the concave base components may be excluded, such as the square and rectangular framing components 1882/1883. As shown in FIG. 41, the flat dual-mount side-mount component 1965 is demountably engaged perpendicular to the length of the component, and according to further embodiments may be demountably engaged at varying other relative angles as the angular orientation of the concave base component may be adjusted on the flat top surface 1970.

According to a preferred embodiment, the mounting hole 1980 may be threaded with the minor diameter of the threads remaining at least slightly wider than the diameter of the narrower pivot screw 1726 passing through, thereby providing a threaded hole in which the flat dual-mount side-mount component 1965 may be optionally configured with threaded-stem casters 375/1175 or threaded-stem foot components 385 in place of the first lower roller elements subassembly 1440.

According to some embodiments, the arrangement of the pivot screw 1726 and the nut 1712 may be inverted with the head of the pivot screw engaged under the sliding plate 1660 and a threaded portion oriented upward into a captive nut secured within a recess in the top section of the flat dual-mount side-mount component, as like shown in the fourth side-mount track roller assembly 1640 which will be described below in reference to FIGS. 43 and 44. According to further embodiments, the recess and the nut may be excluded, and only a threaded portion of the pivot screw 1726 is entered into the mounting hole 1980 from the underside where it is threadedly engaged directly with a matching thread of the mounting hole, as like shown in the fifth embodiment of side-mount track roller assembly 1743 and the pipe fitting mount track roller assembly 1745.

According to further embodiments, the flat dual-mount side-mount component 1965, pivot screw 1726, bushing 1990, and pivot disc(s) 2000 may be alternatively configured with the second lower roller elements subassembly 1747 or the third lower roller elements subassembly 1748 for rolling engagement with square or rectangular rail elements or rail elements having at least three flat sides, as will be described below in reference to FIGS. 48 to 50.

As illustrated in FIG. 42, the embodiments of a track roller assembly may further include a second double side-mount track roller assembly 1650 which may be configured as the track roller elements of the rotating hub dolly base 1750 in FIGS. 53 and 54, or a dolly base similar to any one of the turntable dolly bases 25/645/1035/1410, or a dolly base assembled using two or more of the square framing component 1882 or two or more of the rectangular framing component 1883 or combination as shown in FIGS. 46 and 48, or any other type of dolly base or platform or equipment or device comprising a compatible round or flat surface and threadedly engageable elements at which embodiments of the second double side-mount track roller assembly 1650 may be engaged.

According to some embodiments, the second double side-mount track roller assembly 1650 may comprise a flat dual-mount double side-mount component 2015 having a flat bottom surface and a flat top surface 2020 at which it may be demountably engaged with a cylindrical structural component 1840 via two concave base components 136 of which the flat sides rest against the flat top surface 2020 of the side-mount component and the concave sides engage with the underside of the cylindrical structural component 1840. The threaded portion of screws 1785 are passed through through-holes 2025 in the underside of the side-mount component and out through the flat top surface 2020 and through the concave base components 136 where they may be threadedly engaged with nuts 8 in the nut channel of the underside of the cylindrical structural component 1840. According to a preferred embodiment, there is a recessed area around the through-holes 2025 in which the head of the screws 1785 sit.

According to some embodiments, the second double side-mount track roller assembly 1650 may comprise the first lower roller elements subassembly 1440, as previously described in reference to FIGS. 33 and 34, configured for rolling engagement with a cylindrical track assembly such as the adjustable-level track assemblies 165/1420, or standard straight or curved track assemblies 168/1430, and according to further embodiments configured for other types of round track elements, or square and rectangular rail elements where the sides are oriented on an incline matching the incline of the rollers 1685.

The flat dual-mount double side-mount component 2015 may additionally comprise a threaded hole 2030 on an extended section of one side of the component whereby a threaded-stem caster 375/1175 or threaded-stem foot component 385 may be optionally threadedly engaged when the track roller elements are not in use and optionally the dolly base can be rolled or stood on the ground without damaging or removing the track roller elements.

According to some embodiments, elements and features of the first lower roller elements subassembly 1440 are the same as previously described in reference to FIGS. 33 and 34, whereby in this assembly 1650 the flat dual-mount double side-mount component 2015 may be slidably and pivotably engaged with the top of the sliding plate 1660 by pivot screw 1728. At least a threaded portion of the pivot screw 1728 is passed through a mounting hole 2035 in the center area of the component 2015, and there passed through the slot 1710 where it is threadedly engaged with the nut 1712, as previously described. According to some embodiments, the pivot screw 1728 is a shoulder screw. According to some embodiments, a recess 2040 surrounds the mounting hole 2035 within which the head of the pivot screw may be partially or fully contained lower than the top surface of the component. According to some embodiments, a low-friction bushing 2045 may be included between the head of the pivot screw 1728 and the mount component 2015 thereby providing a low-friction material against which the pivot screw may more easily rotate. The mount component may further comprise a chamfer 2050 around the mounting hole 2035 wherein an edge of the bushing 2045 may be engaged and aligned to center. According to a preferred embodiment, bushing 2045 is a flanged bushing with a flange diameter at least slightly less than the diameter of the recess 2040 in embodiments where present.

By tightening and loosening the pivot screw 1728, tension may be applied to the components between the pivot screw and the nut 1712 and may be adjusted from between firm to loose to adjust the fluidity and firmness with which the track roller assembly 1650 pivots and slides, or may be optionally locked. According to some embodiments, one or more of a pivot disc 2055 having a central through-hole 2060 and made of a low-friction material may be included between the flat bottom of the side-mount component 2015 and the top of the sliding plate 1660 to facilitate the pivoting and sliding of the mount component above the sliding plate. According to some embodiments, the pivot disc 2055 is a flat and circular shape. According to some embodiments, the pivot disc is a plastic washer. According to a preferred embodiment as illustrated in FIG. 42, the second double side-mount track roller assembly 1650 includes two of the pivot discs 2055 each with the central through-hole 2060 with a diameter slightly wider than the lower bushing 1718 in embodiments where present around the pivot screw 1728, or a diameter slightly wider than the pivot screw where without the bushing, wherein the inner element(s) may rotate. According to embodiments with varying number and thickness of one or more pivot disc, or excluding any pivot disc, varying lengths of bushing 1718 may be provided.

According to some embodiments, the entire head of the pivot screw 1728 may be located above the top surface 2020 of the flat dual-mount double side-mount component 2015 and no recess 2040 provided and the concave base components 136 may be provided with a depth greater than the height of the pivot screw head. According to some embodiments, the entire head of the pivot screw 1728 may be located lower than the top surface 2020 of the side-mount component in a recess with a depth greater than the height of the pivot screw head. As illustrated in FIG. 42, according to some embodiments a portion of the head of the pivot screw 1728 may be located within the recess 2040 and the depth of the cooperating concave base components 136 may be greater than the protruding portion of the pivot screw head. According to these embodiments in conjunction with the concave base components, a track roller assembly 1650 may be positioned anywhere along the nut channel of a cylindrical structural component 1840 or threadedly engaged with an underside of any other type of dolly base or platform or equipment or device comprising threadedly engageable elements and a round surface compatible with the concave base components 136, or with a flat underside of a component where the concave base components may be excluded, such as the square and rectangular framing components 1882/1883. According to further embodiments, one or two cylindrical structural components 1840 may be demountably engaged each with a single concave base component 136 at varying angles.

According to a preferred embodiment, the mounting hole 2035 may be threaded with the minor diameter of the threads remaining at least slightly wider than the diameter of the narrower pivot screw 1728 passing through, thereby providing a threaded hole in which the flat dual-mount double side-mount component 2015 may be optionally configured with threaded-stem casters 375/1175 or threaded-stem foot components 385 in place of the first lower roller elements subassembly 1440.

According to some embodiments, the arrangement of the pivot screw 1728 and the nut 1712 may be inverted with the head of the pivot screw engaged under the sliding plate 1660 and a threaded portion oriented upward into a captive nut secured within a recess in the top section of the flat dual-mount double side-mount component, as like shown in the fourth side-mount track roller assembly 1640 which will be described below in reference to FIGS. 43 and 44. According to further embodiments, the recess and the nut may be excluded, and only a threaded portion of the pivot screw 1728 is entered into the mounting hole 2035 from the underside where it is threadedly engaged directly with a matching thread of the mounting hole, as like shown in the fifth embodiment of side-mount track roller assembly 1743 and the pipe fitting mount track roller assembly 1745.

According to further embodiments, the flat dual-mount side-mount component 1965, pivot screw 1726, bushing 1990, and pivot disc(s) 2000 may be alternatively configured with the second lower roller elements subassembly 1747 or the third lower roller elements subassembly 1748 for rolling engagement with square or rectangular rail elements or rail elements having at least three flat sides, as will be described below in reference to FIGS. 48 to 50.

As illustrated in FIGS. 43 and 44, the embodiments of a track roller assembly may further include a fourth side-mount track roller assembly 1640 which may be configured as the track roller elements of the rotating hub dolly base 1750 in FIGS. 53 and 54, or a dolly base similar to any one of the turntable dolly bases 25/645/1035/1410, or any other type of dolly base or platform or equipment or device comprising a compatible round surface and a threadedly engageable element at which embodiments of the fourth side-mount track roller assembly 1640 may be engaged.

According to some embodiments, the fourth side-mount track roller assembly 1640 may comprise a second concave side-mount component 2065 having a flat bottom and an upward concave surface 2070 at which it may be demountably engaged with a cylindrical structural component 1840 by a threaded portion of two screws 2075 passed through a pair of through-holes 2080 in the profile of the mount component 2065 and out through the concave surface 2070 where they may be threadedly engaged with nuts 8 in the nut channel of the underside of the cylindrical structural component 1840. According to some embodiments, there is a recessed or countersunk area around the through-holes 2080 in which the head of the screws 2075 sit.

According to some embodiments, the fourth side-mount track roller assembly 1640 may comprise most of the features of the first lower roller elements subassembly 1440, as previously described in reference to FIGS. 33 and 34, configured for rolling engagement with a cylindrical track assembly such as the adjustable-level track assemblies 165/1420, or standard straight or curved track assemblies 168/1430, and according to further embodiments configured for other types of round track elements, or square and rectangular rail elements where the sides are oriented on an incline matching the incline of the rollers 1685.

According to some embodiments, most of the elements and features of the first lower roller elements subassembly 1440 are the same as previously described except for the pivot screw and nut which are here inverted. As illustrated in FIGS. 43 and 44, a pivot screw 1730 may be engaged with its head situated below the sliding plate 1660 and the length passed upward through the slot 1710 with at least a threaded portion of the pivot screw 1730 passed through a mounting hole 2085 near the center of the concave side-mount component 2065 and through into an upward nut recess 2090 open in the top side of the concave surface 2070 having a depth greater than the height of a captive nut 2095. According to a preferred embodiment, the nut 2095 is a locknut. The nut 2095 is therein secured by an epoxy or interference fit with the side walls of the recess 2090, and the threaded end of the pivot screw 1730 there threadedly engaged sit lower than the concave surface 2070 so not to contact a cylindrical structural component 1840 demountably engaged adjacently. According to some embodiments, the pivot screw 1730 is a shoulder screw. According to further embodiments, the recess and the nut may be excluded, and only a threaded portion of the pivot screw 1730 is entered into the mounting hole 2085 from the underside where it is threadedly engaged directly with a matching thread of the mounting hole, as like shown in the fifth embodiment of side-mount track roller assembly 1743 and the pipe fitting mount track roller assembly 1745.

According to some embodiments, a low-friction bushing 2100 may be included between the head of the pivot screw 1730 and the underside of the sliding plate 1660 thereby providing a low-friction material against which the pivot screw may more easily slide and rotate. According to a preferred embodiment, bushing 2100 is a flanged bushing with a flange diameter greater than the width of the slot 1710, and an elongate section with a diameter slightly narrower than the slot for a close but slidable fit.

By tightening and loosening the pivot screw 1730, tension may be applied to the components between the pivot screw and the captive nut 2095 and may be adjusted from between firm to loose to adjust the fluidity and firmness with which the track roller assembly 1640 pivots and slides, or may be optionally locked. According to some embodiments, one or more of a pivot disc 2105 having a central through-hole 2110 and made of a low-friction material may be included between the flat bottom of the second concave side-mount component 2065 and the top of the sliding plate 1660 to facilitate the pivoting and sliding of the mount component above the sliding plate. According to some embodiments, the pivot disc 2105 is a flat and circular shape. According to some embodiments, the pivot disc is a plastic washer. According to a preferred embodiment as illustrated in FIGS. 43 and 44, the fourth side-mount track roller assembly 1640 includes two of the pivot discs 2105 each with the central through-hole 2110 with a diameter slightly wider than the bushing 2100 in embodiments where present around the pivot screw 1730, or a diameter slightly wider than the pivot screw where without the bushing, wherein the inner element(s) may rotate. According to embodiments with varying number and thickness of one or more pivot disc, or excluding any pivot disc, varying lengths of bushing 2100 may be provided.

The fourth side-mount track roller assembly 1640 may be positioned anywhere along the nut channel of a cylindrical structural component 1840 or threadedly engaged with an underside of any other type of dolly base or platform or equipment or device comprising threadedly engageable elements and a round surface compatible with the concave surface 2070.

According to a preferred embodiment, the mounting hole 2085 may be threaded with the minor diameter of the threads remaining at least slightly wider than the diameter of the pivot screw 1730, thereby providing a threaded hole in which the second concave side-mount component 2065 may be optionally configured with threaded-stem casters 375/1175 or threaded-stem foot components 385 in place of the track roller elements.

According to further embodiments, the second concave side-mount component 2065, pivot screw 1730, bushing 2100, and pivot disc(s) 2105 may be alternatively configured with the second lower roller elements subassembly 1747 or the third lower roller elements subassembly 1748 for rolling engagement with square or rectangular rail elements or rail elements having at least three flat sides, as will be described below in reference to FIGS. 48 to 50.

As illustrated in FIG. 45, the embodiments of a track roller assembly may further include a tube end-mount track roller assembly 1655 which may be configured as the track roller elements of any dolly base comprising three or more cylindrical structural components 1840 as vertical legs of the dolly base configured for rolling engagement with a cylindrical track assembly such as the adjustable-level track assemblies 165/1420, or standard straight or curved track assemblies 168/1430, and according to further embodiments configured for other types of round track elements, or square and rectangular rail elements where the sides are oriented on an incline matching the incline of the rollers 1685.

According to some embodiments, the tube end-mount track roller assembly 1655 may comprise a tube-end pivot screw connector 2115 which may be fastened to the end of various lengths of cylindrical structural component 1840 by screws 16 of which at least a threaded portion are passed through through-holes 2120 in the connector 2115 and threadedly engaged with screw slots 11 in the cylindrical structural component 1840. The tube-end pivot screw connector 2115 may additionally comprise one or more nut channel opening 2122 in the outer profile of the component which align with the one or more nut channel 2123 of the cylindrical structural component to allow the passage of one or more nuts 8 into the channel(s). The track roller assembly 1655 may additionally comprise the first lower roller elements subassembly 1440 as previously described in reference to FIGS. 33 and 34, with an inverted pivot screw 1732 with the head engaged below the sliding plate 1660 and the length passed upward through the slot 1710 with at least a threaded portion of the pivot screw 1732 passed through a mounting hole 2125 in the center of the tube-end pivot screw connector 2115 and through into a nut recess 2130 in the interior side of the connector 2115. A captive nut 2135 is therein secured by an epoxy or interference fit with the side walls of the recess 2130 prior to the connector's installation into the end of the cylindrical structural component, and a threaded portion of the pivot screw 1732 there threadedly engaged. According to some embodiments, the nut 2135 is a locknut. According to some embodiments, the pivot screw 1732 is a shoulder screw.

According to some embodiments, a low-friction bushing 2140 may be included between the head of the pivot screw 1732 and the underside of the sliding plate 1660 thereby providing a low-friction material against which the pivot screw may more easily slide and rotate. According to a preferred embodiment, bushing 2140 is a flanged bushing with a flange diameter greater than the width of the slot 1710, and an elongate section with a diameter slightly narrower than the slot for a close but slidable fit.

By tightening and loosening the pivot screw 1732, tension may be applied to the components between the pivot screw and the captive nut 2135 and may be adjusted from between firm to loose to adjust the fluidity and firmness with which the track roller assembly 1655 pivots and slides, or may be optionally locked. According to some embodiments, one or more of a pivot disc 2145 having a central through-hole 2150 and made of a low-friction material may be included between the flat contact surface of the tube-end pivot screw connector 2115 and the top of the sliding plate 1660 to facilitate the pivoting and sliding of the mount component above the sliding plate. According to some embodiments, the pivot disc 2145 is a flat and circular shape. According to some embodiments, the pivot disc is a plastic washer. According to a preferred embodiment as illustrated in FIG. 45, tube end-mount track roller assembly 1655 includes two of the pivot discs 2145 each with the central through-hole 2150 with a diameter slightly wider than the bushing 2140 in embodiments where present around the pivot screw 1732, or a diameter slightly wider than the pivot screw where without the bushing, wherein the inner element(s) may rotate. According to embodiments with varying number and thickness of one or more pivot disc, or excluding any pivot disc, varying lengths of bushing 2140 may be provided.

According to a preferred embodiment, the mounting hole 2125 may be threaded with the minor diameter of the threads remaining at least slightly wider than the diameter of the narrower pivot screw 1732 passing through, thereby providing a threaded hole in which the tube-end pivot screw connector 2115 may be optionally configured with threaded-stem casters 375/1175 or threaded-stem foot components 385 in place of the track roller elements. According to further embodiments, the recess and the nut may be excluded, and only a threaded portion of the pivot screw 1732 is entered into the mounting hole 2125 from the underside where it is threadedly engaged directly with a matching thread of the mounting hole, as like shown in the fifth embodiment of side-mount track roller assembly 1743 and the pipe fitting mount track roller assembly 1745.

According to further embodiments, the second concave side-mount component 2115, pivot screw 1732, bushing 2140, and pivot disc(s) 2145 may be alternatively configured with the second lower roller elements subassembly 1747 or the third lower roller elements subassembly 1748 for rolling engagement with square or rectangular rail elements or rail elements having at least three flat sides, as will be described below in reference to FIGS. 48 to 50.

As illustrated in FIGS. 46 and 47, the embodiments of a track roller assembly may further include a fifth embodiment of a side-mount track roller assembly 1743 which may be configured as the track roller elements of a dolly base or platform or equipment or device comprising a compatible flat surface and a threadedly engageable element to which they may be demountably engaged by screws 1785. Alternatively, a concave base component 136 may be included for demountably engaging the fifth side-mount track roller assembly 1743 with the underside of a cylindrical structural component 1840 or other compatible round surface comprising a threadedly engageable element, as previously described.

According to some embodiments, the fifth side-mount track roller assembly 1743 may comprise a second flat side-mount component 2155 having a flat bottom surface and a flat top surface 2160. As shown in FIG. 46, a threaded portion of a screw 1785 may be passed through a through-hole 2165 in the underside of the side-mount component 2155 and out through the flat top surface 2160 and there threadedly engaged with a nut 2170 secured in a nut channel along the rectangular framing component 1883. According to a preferred embodiment, there is a recessed area around the through-hole 2165 in which the head of the screw 1785 sits.

According to further embodiments, it may instead be demountably engaged to the underside of a square framing component 1882 of which one is shown underneath the roller elements with its sides oriented on an incline whereby it may also embody a square rail element on which the first lower roller elements subassembly 1440, as previously described, may be configured for rolling engagement. As shown in FIGS. 46 and 47, the roller mounts 1670 have been positioned on the inner set of threaded holes 1665 in the sliding plate 1660 to be best configured for the width of the square rail element. Alternatively, the first lower roller elements subassembly 1440 of the track roller assembly 1743 may be configured for rolling engagement with a rectangular rail element comprising one or a series of the rectangular framing components 1883 also oriented on the incline, or according to further embodiments with the cylindrical or round rail elements as previously described.

According to some embodiments, the second flat side-mount component 2155 may be slidably and pivotably engaged with the top of the sliding plate 1660 by pivot screw 1734 from the underside, of which at least a threaded portion is passed through the slot 1710 and threadedly engaged with a threaded mounting hole 2185 in the flat bottom of the side-mount component 2155. According to some embodiments, the pivot screw 1734 is a shoulder screw. According to a preferred embodiment, a low-friction bushing 2190 may be included between the head of the pivot screw 1734 and the underside of the sliding plate 1660 thereby providing a low-friction material against which the pivot screw may more easily slide and rotate. According to a preferred embodiment, bushing 2190 is a flanged bushing with a flange diameter greater than the width of the slot 1710, and an elongate section with a diameter slightly narrower than the slot for a close but slidable fit.

By tightening and loosening the pivot screw 1734, tension may be applied to the components between the pivot screw 1734 and the threaded side-mount component 2155 to adjust the fluidity and firmness with which the track roller assembly 1743 pivots and slides or may be optionally locked. According to some embodiments, one or more of a pivot disc 2192 having a central through-hole 2193 and made of a low-friction material may be included between the flat bottom of the side-mount component 2155 and the top of the sliding plate 1660 to facilitate the pivoting and sliding of the mount component above the sliding plate. According to some embodiments, the pivot disc 2192 is a flat and circular shape. According to some embodiments, the pivot disc is a plastic washer. According to a preferred embodiment as illustrated in FIGS. 46 and 47, the fifth side-mount track roller assembly 1743 includes two of the pivot discs 2192 each with the central through-hole 2193 with a diameter slightly wider than the bushing 2190 in embodiments where present around the pivot screw 1734, or a diameter slightly wider than the pivot screw where without the bushing, wherein the inner element(s) may rotate. According to embodiments with varying number and thickness of one or more pivot disc, or excluding any pivot disc, varying lengths of bushing 2190 may be provided.

As previously noted, according to some embodiments of the cylindrical mount component 1435, and the first flat side-mount component 1795, and the first flat double side-mount component 1825, and the first concave side-mount component 1830, and the flat dual-mount side-mount component 1965, and the flat dual-mount double side-mount component 2015, and the second concave side-mount component 2065, their mounting holes may be replaced by a threaded mounting hole as like the threaded mounting hole 2185 shown in the second flat side-mount component 2155, with their pivot screws engaged from the underside of the first lower roller elements subassembly 1440, or the second lower roller elements subassembly 1747, or the third lower roller elements subassembly 1748.

According to further embodiments, the second flat side-mount component 2155, pivot screw 1734, bushing 2190, and pivot disc(s) 2192 may be alternatively configured with the second lower roller elements subassembly 1747 or the third lower roller elements subassembly 1748 for rolling engagement with square or rectangular rail elements or rail elements having at least three flat sides configured with the sides parallel and perpendicular to horizontal, as will be described below in reference to FIGS. 48 to 50.

As illustrated in FIGS. 48 to 50, the embodiments of a track roller assembly may further include a sixth embodiment of a side-mount track roller assembly 2195 and a seventh embodiment of a side-mount track roller assembly 2200 of which both may be configured as the track roller elements of a dolly base or platform or equipment or device comprising a compatible flat surface and a threadedly engageable element to which they may be demountably engaged by screws 1785. Alternatively, a concave base component 136 may be included for demountably engaging the sixth and the seventh side-mount track roller assemblies 2195 and 2200 with the underside of a cylindrical structural component 1840 or other compatible round surface comprising a threadedly engageable element, as previously described.

According to some embodiments, the track roller assemblies 2195 and 2200 may be configured for rolling engagement along components as like the straight or curved square and rectangular framing components 610, 1882, 1883 forming square and rectangular rail elements in assemblies such as the rectangular rail track assembly 595 shown in FIG. 8, or other square or rectangular rail elements or rail elements having at least three flat sides on which the roller elements of the assemblies may be configured as described below.

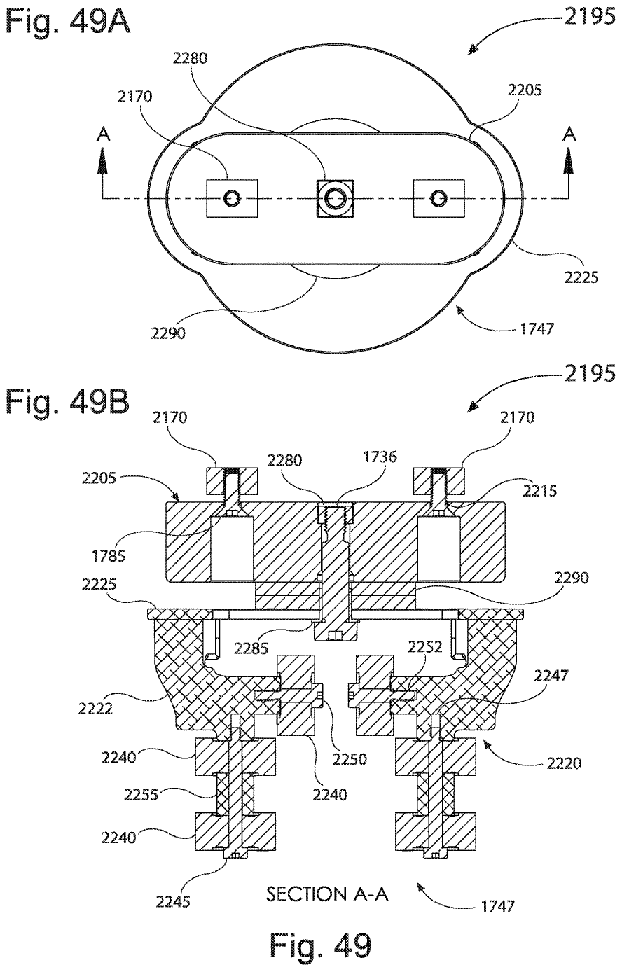

According to some embodiments, the sixth and seventh side-mount track roller assemblies 2195 and 2200 may comprise a second flat double side-mount component 2205 having a flat bottom surface and a flat top surface 2210. As shown in FIGS. 48 and 49, a threaded portion of two screws 1785 may be passed through a pair of through-holes 2215 in the underside of the side-mount component 2205 and out through the flat top surface 2210 and there threadedly engaged with a pair of nuts 2170 which fasten in a nut channel along a square framing component 1882 or alternatively a rectangular framing component 1883. According to a preferred embodiment, there is a recessed area around the through-holes 2215 in which the head of the screws 1785 sit.

According to some embodiments, the second flat double side-mount component 2205 of the track roller assemblies 2195 and 2200 may be slidably and pivotably engaged with the top of a second lower roller elements subassembly 1747 and a third lower roller elements subassembly 1748, respectively.

The second lower roller elements subassembly 1747 may comprise two of a perpendicular roller mount assembly 2220 having a two-way roller mount component 2222 fastened to the bottom of a first perpendicular roller sliding plate 2225 by a threaded portion of screws 2230 passed through holes 2232 and threadedly engaged with threaded holes 2235 in the sliding plate. The first perpendicular roller sliding plate 2225 additionally may comprise a sliding slot 2238. According to a preferred embodiment, the first perpendicular roller sliding plate 2225 may comprise four threaded holes 2235. According to some embodiments, two rollers 2240 may be attached downwardly by a vertical axle screw 2245 at a threaded hole 2247 in the bottom of the mount component 2222, in addition to one roller 2240 attached horizontally and inwardly by a horizontal axle screw 2250 at a threaded hole 2252. The two outer downward rollers 2240 may be separated by a roller spacer 2255 having a through-hole corresponding with the vertical axle screw 2245 and axle holes of the rollers 2240, which may align the rollers for a best contact area with the side of the rail component. According to a preferred embodiment, the vertical and horizontal axle screws are shoulder screws. The three-sided enclosure of the rail element within the rollers 2240 of the pair of perpendicular roller mount assemblies 2220 therefore maintains the directional alignment of the sixth side-mount track roller assembly 2195 along the rail element.

The third lower roller elements subassembly 1748 of the seventh side-mount track roller assembly 2200 may comprise four of the same perpendicular roller mount assemblies 2220, as described, fastened to threaded holes 2258 in a second perpendicular roller sliding plate 2260 having a sliding slot 2265. According to a preferred embodiment, the second perpendicular roller sliding plate 2260 may comprise eight threaded holes 2258. The additional pair of the roller mount assemblies adds additional stability for a corresponding dolly base and supported load, and according to some embodiments the track roller assembly 2200 may be used in isolation as a compact dolly assembly for small loads and equipment and devices that may be mounted to the top of the second flat double side-mount component 2205 directly or via various threadedly engageable mounting plates or a compact assembly of the structural components previously described.

According to some embodiments, the second and third lower roller elements subassemblies 1747 and 1748 may be pivotably and slidably engaged by further embodiments of the second flat double side-mount component 2205 with any of the previously described arrangements of pivot screw and nut, or pivot screw without a nut as described in reference to the fifth side-mount track roller assembly 1743. As shown in FIGS. 48 to 50, a pivot screw 1736 may be engaged with its head situated below the sliding plate 2225/2260 and the length passed upward through the sliding slot 2238/2265 with at least a threaded portion of the pivot screw 1736 passed through a mounting hole 2270 near the center of the second flat double side-mount component 2205 and through into an upward nut recess 2275 open in the flat top surface 2210 having a depth greater than the height of a captive nut 2280. According to a preferred embodiment, the nut 2280 is a locknut. The nut 2280 may be secured in the recess by an epoxy or interference fit with the side walls of the recess 2275, and the threaded end of the pivot screw 1736 may be there threadedly engaged and sit lower than the flat top surface 2210 to not contact a structural component engaged adjacently. According to some embodiments, the pivot screw 1736 is a shoulder screw. As previously noted, according to further embodiments the recess and the nut may be excluded, and only a threaded portion of the pivot screw 1736 is entered into the mounting hole 2270 from the underside where it is threadedly engaged directly with a matching thread of the mounting hole, as like shown in the fifth side-mount track roller assembly 1743, and the pipe fitting mount track roller assembly 1745 as will be described below in reference to FIGS. 51 and 52.

According to some embodiments, a low-friction bushing 2285 may be included between the head of the pivot screw 1736 and the underside of the sliding plate 2225/2260 thereby providing a low-friction material against which the pivot screw may more easily slide and rotate. According to a preferred embodiment, bushing 2285 is a flanged bushing with a flange diameter greater than the width of the sliding slot 2238/2265, and an elongate section with a diameter slightly narrower than the sliding slot for a close but slidable fit.

By tightening and loosening the pivot screw 1736, tension may be applied to the components between the pivot screw 1736 and the second flat double side-mount component 2205 to adjust the fluidity and firmness with which the track roller assembly 2195/2200 pivots and slides or may be optionally locked. According to some embodiments, one or more of a pivot disc 2290 having a central through-hole 2295 and made of a low-friction material may be included between the flat bottom of the side-mount component 2205 and the top of the sliding plate 2225/2260 to facilitate the pivoting and sliding of the mount component above the sliding plate. According to some embodiments, the pivot disc 2290 is a flat and circular shape. According to some embodiments, the pivot disc is a plastic washer. According to a preferred embodiment as illustrated in FIGS. 48 to 50, the track roller assemblies 2195/2200 may include two of the pivot discs 2290 each with the central through-hole 2295 with a diameter slightly wider than the bushing 2285 in embodiments where present around the pivot screw 1736, or a diameter slightly wider than the pivot screw where without the bushing, wherein the inner element(s) may rotate. According to embodiments with varying number and thickness of one or more pivot disc, or excluding any pivot disc, varying lengths of bushing 2285 may be provided.

The position of the sixth and seventh side-mount track roller assemblies 2195/2200 may be adjusted to anywhere along the nut channel of a rectangular or square framing component 1882/1883 by unfastening and refastening the screws 1785 with the nuts 2170, or with nuts 8 in embodiments where demountably engaged with a cylindrical structural component 1840 via two concave base components 136. Optionally, two structural components of either type may be demountably engaged each with one mounting position to configure varying dolly base and rolling platform assemblies.

According to some embodiments where the recess 2275 and nut 2280 are provided, the mounting hole 2270 may be threaded with the minor diameter of the threads remaining at least slightly wider than the diameter of the pivot screw 1736, thereby providing a threaded hole in which the second flat double side-mount component 2205 may be optionally configured with threaded-stem casters 375/1175 or threaded-stem foot components 385 in place of the track roller elements.

According to further embodiments, the second flat double side-mount component 2205, pivot screw 1736, bushing 2285, and pivot disc(s) 2290 may be alternatively configured with the first lower roller elements subassembly 1440 for rolling engagement with cylindrical or round rail and track assemblies, as previously described.

As illustrated in FIGS. 51 and 52, the embodiments of a track roller assembly may further include a pipe fitting mount track roller assembly 1745 of which may be configured as the track roller elements of a dolly base or dolly chassis or platform or equipment where assembled with two or more standard pipe components 2300 and/or standard tube components of various length. According to some embodiments, the elements of the track roller assembly 1745 may be configured and sized for assembly with various diameters of hollow and/or solid pipe components 2300 and/or tube components.

According to some embodiments, the pipe fitting mount track roller assembly 1745 may comprise a pipe fitting mount component 2305 having a flat bottom surface 2310 below a round or circular passage 2315 into which from one or both sides and/or the top there may be one or more of a threaded hole 2320. As shown in FIG. 51, a section of a pipe component 2300 may be inserted partially or fully through the circular passage 2315 where one or more of a set screw 2325 is threadedly engaged with one of the threaded hole 2320 into the circular passage until firmly pressed against the pipe component 2300, thereby securing the pipe component within the passage 2315. According to some embodiments, the outer surface of the pipe fitting mount component 2305 may further comprise one or more of a raised section 2330 around the one or more threaded hole(s) 2320 to increase the available depth of the threaded hole(s) alongside thinner sections of the pipe fitting mount component 2305. According to some embodiments, the mount component 2305 comprises one threaded hole 2320. According to some embodiments, the mount component 2305 comprises two threaded holes 2320. According to some embodiments, the mount component 2305 comprises any number between 3 and 12 threaded holes 2320. According to some embodiments, the pipe fitting mount component 2305 further comprises one or more additional circular passages at various angular orientations intersecting directly with the first circular passage 2315 or adjacent above on a taller body of the component 2305, whereby two or more pipe components may be assembled to form corner and/or cross structural elements mounted above the track roller elements for varied dolly base or dolly chassis or platform or equipment rolling configurations.

According to various embodiments, the pipe fitting mount track roller assembly 1745 may be configured with the second lower roller elements subassembly 1747 or the third lower roller elements subassembly 1748 for rolling engagement with a square or rectangular rail element or rail element having at least three flat sides, as described in reference to FIGS. 48 to 50. As shown in FIGS. 51 and 52, in other embodiments the pipe fitting mount track roller assembly 1745 may be configured with the first lower roller elements subassembly 1440 for rolling engagement with a pipe component as a pipe rail element 2335 as shown in FIG. 51A or with a rail assembly comprising a cylindrical structural component such as the adjustable-level track assemblies 165/1420, or with a standard rail assembly 168/1430 or other rail or track assemblies having a cylindrical or round rail element.

According to some embodiments, the pipe fitting mount component 2305 may be slidably and pivotably engaged with the top of the sliding plate 1660 as shown, or one of the perpendicular roller sliding plates 2225/2260 of the second or third lower roller elements. A pivot screw 1738 from the underside, of which at least a threaded portion is passed through the slot 1710/2238/2265 and threadedly engaged with a threaded mounting hole 2340 in the flat bottom surface 2310 of the pipe fitting mount component 2305. According to some embodiments, the pivot screw 1738 is a shoulder screw. According to a preferred embodiment, a low-friction bushing 2345 may be included between the head of the pivot screw 1738 and the underside of the sliding plate 1660/2225/2260 thereby providing a low-friction material against which the pivot screw may more easily slide and rotate. According to a preferred embodiment, bushing 2345 is a flanged bushing with a flange diameter greater than the width of the slot 1710/2238/2265, and an elongate section with a diameter slightly narrower than the slot for a close but slidable fit.

By tightening and loosening the pivot screw 1738, tension may be applied to the components between the pivot screw and the pipe fitting mount component 2305 to adjust the fluidity and firmness with which the track roller assembly 1745 pivots and slides or may be optionally locked. According to some embodiments, one or more of a pivot disc 2350 having a central through-hole 2355 and made of a low-friction material may be included between the flat bottom 2310 of the mount component 2305 and the top of the sliding plate 1660/2225/2260 to facilitate the pivoting and sliding of the mount component above the sliding plate. According to some embodiments, the pivot disc 2350 is a flat and circular shape. According to some embodiments, the pivot disc is a plastic washer. According to a preferred embodiment as illustrated in FIGS. 51 and 52, the pipe fitting mount track roller assembly 1745 includes two of the pivot discs 2350 each with the central through-hole 2355 with a diameter slightly wider than the bushing 2345 in embodiments where present around the pivot screw 1738, or a diameter slightly wider than the pivot screw where without the bushing, wherein the inner element(s) may rotate. According to embodiments with varying number and thickness of one or more pivot disc, or excluding any pivot disc, varying lengths of bushing 2350 may be provided.

According to further embodiments, the threaded mounting hole 2340 may be configured as like the mounting hole 2270 as previously described wherein the head of the pivot screw may remain under the sliding plate 2225/2260 and oriented upwardly through the slot 2238/2265 and a threaded portion threadedly engaged with a nut in a recess in the bottom area of the circular passage 2315.

According to some embodiments, in addition to or instead of the mounting hole 2340, the pipe fitting mount component 2305 may comprise one or more threaded holes 2360 in the flat bottom surface 2310, as indicated in FIG. 52B, whereby it may be engaged with the lower roller elements subassemblies via one of the previously described flat side-mount components 1795/1825/1965/2015 thereon engaged by one or two screws 1785 threadedly engaged with the one or more threaded holes 2360.

Further embodiments of the present disclosure may include a rotating hub dolly base forming the lower support and rolling elements of a rotating hub dolly configured for rolling engagement along a rail or track assembly. A rotating hub dolly base may be provided with three or four track roller assemblies of the various types previously described whereby the dolly base may be configured for rolling engagement along one of the adjustable-level track assemblies 165/1420, or standard straight or curved track assemblies 168/1430, or a rail or track assembly configured using standard pipe components 2300 or other of a rail pipe element 2335, or other types of cylindrical or round rail or track assemblies, or a rail or track assembly configured using square or rectangular framing components 1882/1883 or rail elements having at least three flat sides.

As shown in FIGS. 53 to 57, according to some embodiments a rotating hub dolly 2365 may comprise the rotating hub dolly base 1750 supporting a height-adjustable device mount rod assembly 2370 with a bowl/ball mount assembly 2375. According to some embodiments, the rotating dolly base 1750 may near its center comprise a rotating hub assembly 2380 from which three or four of a cylindrical structural assembly 2385 are outwardly extended whereby at their outer ends three or four of the first side-mount track roller assembly 1625 are provided for rolling engagement on the standard track assembly 1430 as shown or an adjustable-level track assembly 165/1420 or other cylindrical or round rail or track assembly.

According to some embodiments, the cylindrical structural assemblies 2385 may comprise at one end the cylinder gooseneck end connector 390, as previously described fastened by screws 16 to the inner screw slots of a cylindrical structural component 2390. Optionally at the opposite end above the track roller assembly, a threaded end component 148 may be provided as an enclosure of the cylindrical structural component there fastened by screws 16 to the screw slots. The three or four track roller assemblies 1625 may be at that outer end demountably engaged by a screw 1785 threadedly engaged with a nut 8 in the lower nut channel of the cylindrical structural component 2390. At the opposite inner ends, the three or four gooseneck end connectors 390 may be demountably engaged with the rotating hub assembly 2380, as described further below.

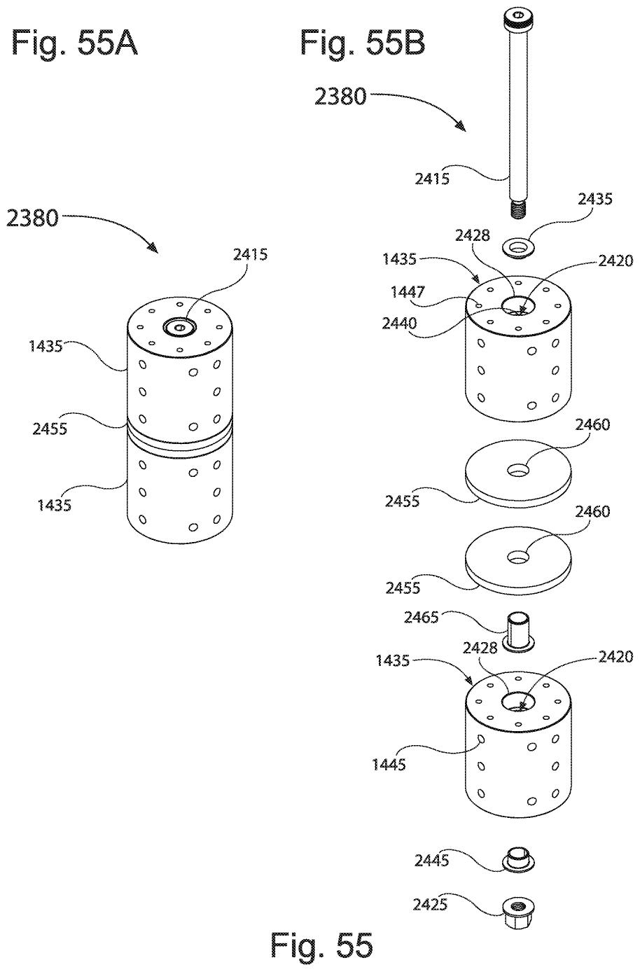

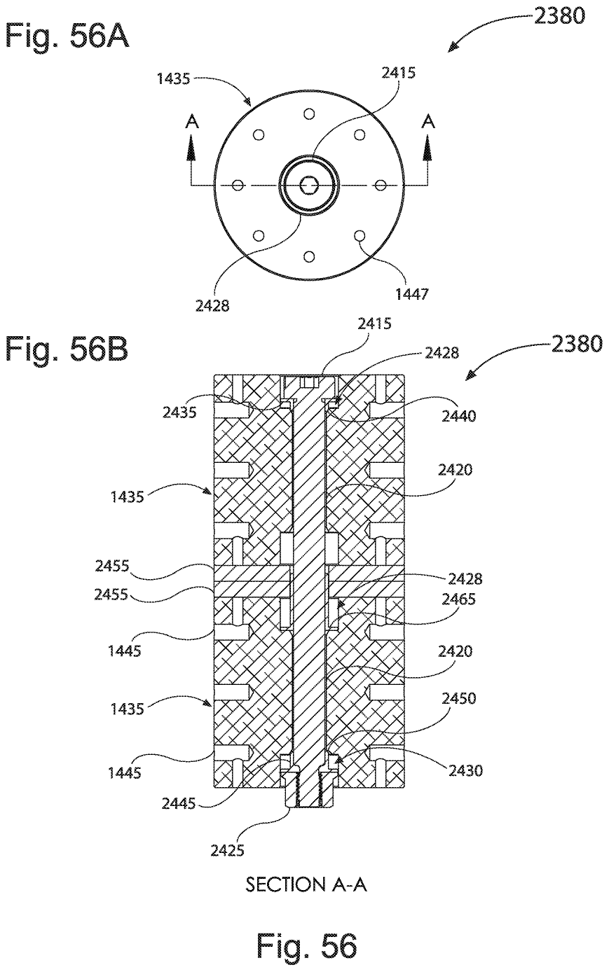

As shown in FIGS. 55 and 56, according to some embodiments the rotating hub assembly 2380 may comprise a lower cylindrical mount component 1435 whereby the three or four cylindrical structural assemblies 2385 may be demountably engaged by one or more screws 10 of which a threaded portion is passed through a through-hole 2395 in the gooseneck end connectors 390 and threadedly engaged with one or more threaded holes 1445 in the circumferential surface of the lower cylindrical mount component 1435. The rotating hub assembly 2380 may further comprise an upper cylindrical mount component 1435 on top of which a hub mount plate 2400 may be secured. According to a preferred embodiment, the hub mount plate is demountably engaged with the top surface of the upper cylindrical mount component by two or more screws 2405 of which a threaded portion may be passed through through-holes 2410 and threadedly engaged with two or more threaded holes 1447. According to some embodiments, the height-adjustable device mount rod assembly 2370 or other component or assembly, or a device or equipment mounted directly, may be demountably engaged with the top of the hub mount plate 2400 as will be described in further detail below.

According to some embodiments, the two cylindrical mount components 1435 may be rotationally engaged with one another by a pivot screw 2415 of which at least a threaded portion is passed through a mounting hole 2420 in the center of the upper cylindrical mount component 1435 and through a mounting hole 2420 in the lower cylindrical mount component 1435 where it is threadedly engaged with a nut 2425 on the underside of the lower component. According to some embodiments, the pivot screw 2415 is a shoulder screw. According to a preferred embodiment, the nut 2425 is a locknut. According to some embodiments, an upper recess 2428 surrounds the central mounting hole 2420 at the top surface of the upper cylindrical mount component 1435 within which the head of the pivot screw may sit partially or fully beneath the top surface. According to some embodiments, a lower recess 2430, as indicated in FIG. 56B, surrounds the central mounting hole 2420 at the bottom surface of the lower cylindrical mount component 1435 within which the nut 2425 may sit partially or fully.

According to some embodiments, an upper low-friction bushing 2435 may be included between the head of the pivot screw 2415 and the upper cylindrical mount component 1435 thereby providing a low-friction material against which the pivot screw may more easily rotate. The upper cylindrical mount component may further comprise an upper chamfer 2440 around the central mounting hole 2420 wherein an edge of the upper bushing 2435 may be engaged and aligned to center. According to a preferred embodiment, the upper bushing 2435 is a flanged bushing with a flange diameter at least slightly less than the diameter of the upper recess 2428, in embodiments where present. According to some embodiments, a lower low-friction bushing 2445 may be provided between the nut 2425 and the bottom of the lower cylindrical mount component 1435. The lower cylindrical mount component 1435 may further comprise a lower chamfer 2450, as indicated in FIG. 56B, around the central mounting hole 2420 wherein an edge of the bushing 2445 may be engaged and aligned to center. According to a preferred embodiment, the lower bushing 2445 is a flanged bushing with a flange diameter of approximately the width of the nut 2425 and slightly less than the diameter of the lower recess 2430, in embodiments where present.

By tightening and loosening the pivot screw 2415, tension may be applied to the components between the pivot screw and the nut 2425 and may be adjusted from between firm to loose to adjust the fluidity and firmness with which the rotating hub assembly 2380 rotates or may be optionally locked. According to some embodiments, one or more of a pivot disc 2455 having a central through-hole 2460 and made of a low-friction material may be included between the flat bottom surface of the upper cylindrical mount component 1435 and the flat top surface of the lower cylindrical mount component 1435 to facilitate the pivoting and sliding of the cylindrical mount components relative to one another. According to some embodiments, the pivot disc 2455 is a flat and circular shape. According to some embodiments, the pivot disc is a plastic washer. According to some embodiments, a middle low-friction bushing 2465 may be provided with a flanged section resting within an upper recess 2428 of the lower cylindrical mount component 1435 and with a narrower elongate section passed into the central through-hole(s) of the pivot disc(s) to maintain the alignment of the pivot disc(s) and the pivot screw 2415 passing through and provide an interfacing low-friction material between the pivot screw and the pivot discs. According to a preferred embodiment as illustrated in FIGS. 55 and 56, the rotating hub assembly 2380 includes two pivot discs 2455 each with the central through-hole 2460 having a diameter slightly wider than the elongate section of the middle bushing 2465.

According to some embodiments, the arrangement of the pivot screw 2415 and the nut 2425 may be inverted with the head of the pivot screw engaged under the lower cylindrical mount component 1435 and the threaded portion oriented upward into a nut resting against the top surface or within the upper recess of the upper cylindrical mount component 1435.

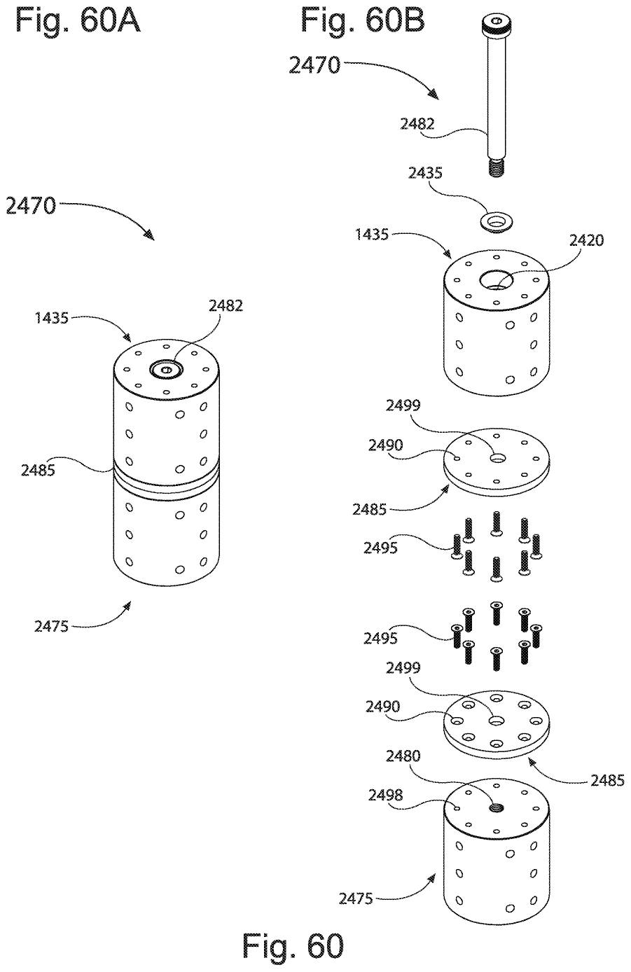

A further embodiment of a rotating hub assembly 2470 is shown in FIG. 60 comprising a second embodiment of lower cylindrical mount component 2475 having a threaded mounting hole 2480 at its center and where the nut 2425 and lower bushing 2445 may be excluded. A shorter pivot screw 2482 of which at least a threaded portion is passed through the mounting hole 2420 of the upper cylindrical mount component 1435, and through the one or more pivot discs in embodiments where present, and threadedly engaged with the threaded mounting hole 2480 in the lower second cylindrical mount component 2475. According to some embodiments, the pivot screw 2482 is a shoulder screw. According to some embodiments, the orientation of the pivot screw may be inverted and a threaded portion of the pivot screw passed through a through-hole mounting hole of the lower cylindrical mount component to be threadedly engaged with a threaded mounting hole in the upper cylindrical mount component.

According to embodiments with a single pivot disc, the pivot disc of the assemblies 2380/2470 may be glued or fastened by screws to one of the adjacent cylindrical mount components. According to embodiments with two pivot discs, the two pivot discs may be glued or fastened by screws each to one of the cylindrical mount components. As illustrated in FIG. 60, the second rotating hub assembly 2470 comprises two pivot discs 2485 having two or more countersunk through-holes 2490 through which a threaded portion of screws 2495 are passed and threadedly engaged with the threaded holes 1447 in the underside of the upper mount component 1435 and threaded holes 2498 in the top side of the second lower mount component 2475.

According to some embodiments, the rotating hub assemblies 2380/2470 may exclude the middle bushing 2465 and instead the diameter of the central through-hole(s) of the pivot disc(s) 2455/2485 sized to slightly wider than the diameter of the pivot screw 2415/2482, as like the central through-hole 2499 shown in FIG. 60.

According to further embodiments, the rotating hub assembly may alternatively comprise two cube shaped mount components or rectangular prism shaped mount components, at which the three or four gooseneck end connectors 390 thereon demountably engaged may comprise a flat mounting surface instead of the concave mounting surface.

According to some embodiments, a rotating hub dolly 2365 may comprise a hub mount plate 2400 demountably engaged with the top of the upper cylindrical mount component 1435, as described above, whereby the height-adjustable device mount rod assembly 2370 or other component or assembly, or a device or equipment mounted directly, may be demountably engaged. As shown in FIGS. 53, 54, and 57, the height-adjustable device mount rod assembly 2370 may comprise one or more sets of three threaded standoff rods 2500 with male threaded ends 2505 at the bottom and female threaded ends 2510 at the top, both ends having the same thread specification. According to some embodiments, a single set of standoff rods may be attached by the male threaded ends 2505 threadedly engaged with three threaded holes 2515 in the hub mount plate 2400, and the bowl/ball mount assembly 2375 secured to the top female threaded ends 2510 by screws 2520 whereby a camera or other device or equipment may be supported.

According to some embodiments, two or more sets of threaded standoff rods 2500 may be engaged between the hub mount plate 2400 and the bowl/ball mount assembly 2375. Two or more sets of threaded rods 2500 may be threadedly engaged to the hub mount plate and with each other for a predetermined height extension of the device mount components at the upper end. Alternatively, as shown, the two or more sets of threaded rods 2500 are adjustably engaged by a rod slide brace 2525 between each set. According to some embodiments, the male threaded ends 2505 of the lower set of rods may be threadedly engaged with the hub mount plate 2400, and the male threaded ends of the one or more additional sets may be threadedly engaged with threaded holes 2530 in the rod slide brace 2525 which may be provided at the bottom of each set of rods.

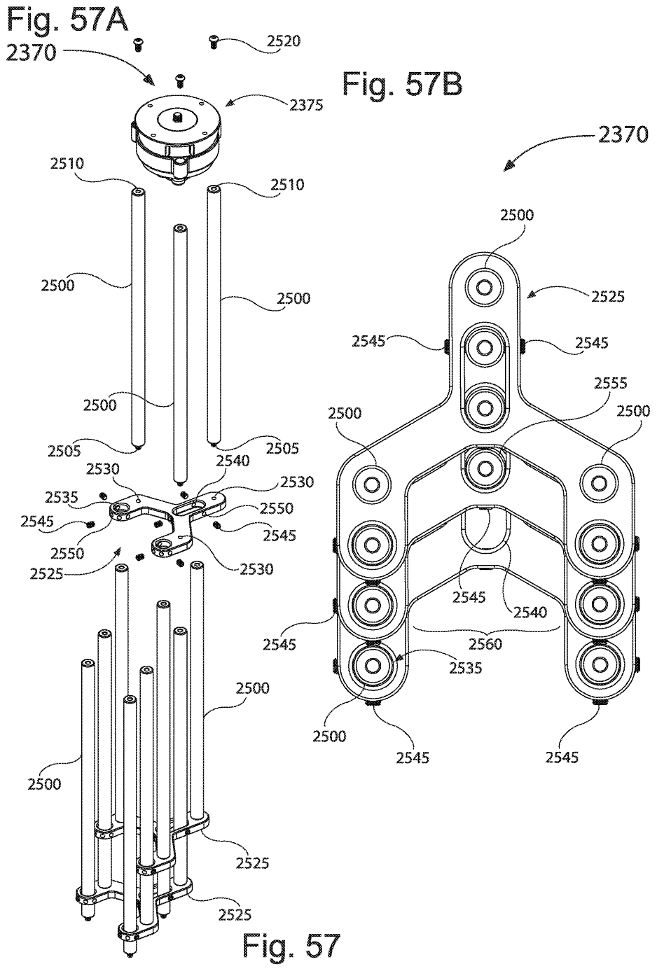

According to a preferred embodiment, the rod slide brace 2525 comprises, in addition to threaded holes 2530, the two slidable rod holes 2535 and the one slidable rod slot 2540 through which the lower supporting set(s) of rods 2500 slide so that the upper adjustable set(s) can be repositioned anywhere along the open length of the supporting set(s). As illustrated in FIGS. 53 and 54, four sets are shown extended partway to full extension, and as illustrated in FIG. 57A shown near to their lowest positions with one set shown removed from its rod slide brace along with the bowl/ball mount assembly 2375. According to a preferred embodiment, the position of the rod slide brace(s) and supported rods are reversibly locked by one or more set screws 2545 at each rod hole 2535 and rod slot 2540 threadedly engaged with the same number of perpendicular threaded holes 2550 through the edge of the brace 2525 and into the holes/slot whereby they may be tensioned against the rods to secure the rods temporarily in place.

According to a preferred embodiment, the slidable rod slot 2540 may comprise an opening of a horizontal length that provides the clearance required for the cooperating first lower middle rod 2555 to be condensed into the second up of the rod slide brace(s) 2525, if present, and then fitting in front of the forward gap 2560 of the third rod slide brace, if present, and then the same repeated for each subsequent set, if present, as each set may be condensed in to the next.

According to some embodiments, the bowl/ball mount assembly 2375 may be excluded and a basic mount plate provided instead for secure attachment of a camera or device or other equipment at the upper ends of the extendable rod assembly. According to further embodiments, in addition to engagement on the rotating hub dolly 2365 and rotating hub assemblies 2380/2470, the one or more threaded standoff rods 2500 alone or in combination with the one or more rod slide brace(s) 2525 may additionally be configured on the turntable dolly bases 25/585/645/1035/1410 previously described. According to further embodiments, a rotating hub dolly may in place of the height-adjustable device mount's extendable rod assembly may comprise a height-adjustable device mount arm assembly, as described below.

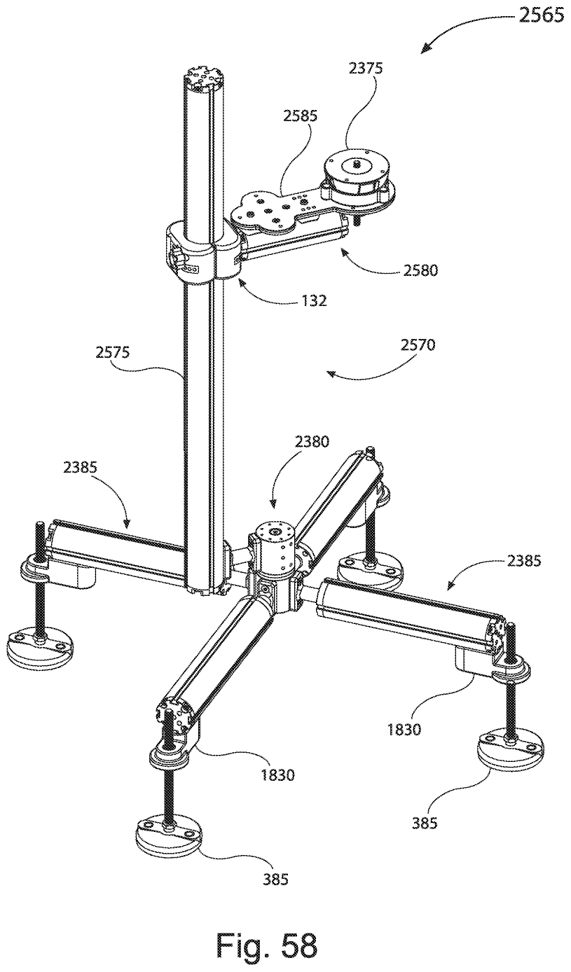

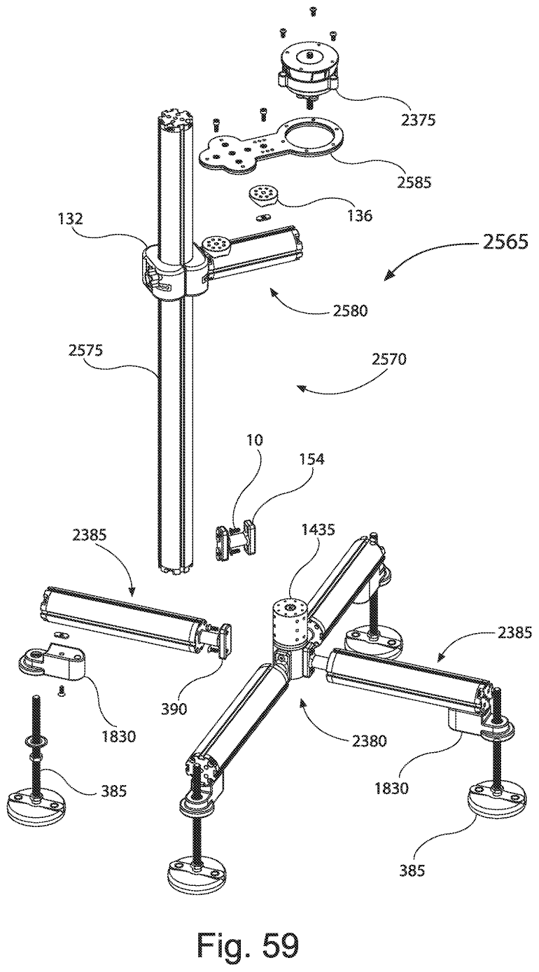

As shown in FIGS. 58 and 59, according to some embodiments, a rotating hub stand 2565 may be configured with the height-adjustable device mount rod assembly 2370 as previously described, or with a height-adjustable device mount arm assembly 2570, as shown, supported by a rotating hub assembly 2380/2470 and four cylindrical structural assemblies 2385 fastened to the lower cylindrical mount component of the rotating assembly at the inward ends, and provided with four first concave side-mount components 1830 at the outer ends whereby four threaded-stem foot components 385 are demountably engaged on which the rotating hub stand may be levelled.

According to some embodiments, the rotating hub stand 2565 may comprise the height-adjustable device mount arm assembly 2570, as shown, which may be demountably engaged with the upper cylindrical mount component 1435 of the rotating hub assembly 2380/2470 with which it is rotatable 360 degrees on top of the fixed lower cylindrical mount component 1435/2475. According to a preferred embodiment, an elongate cylindrical structural assembly 2575 configured as a vertically oriented arm element may be demountably engaged by a parallel gooseneck connector 154, as previously described, fastened to the vertical assembly by screws 10 threadedly engaged with nuts 8, and fastened to the upper cylindrical mount component 1435 by screws 10 threadedly engaged with threaded holes 1445.

According to a preferred embodiment, a repositionable cylindrical structural assembly 2580 configured as a horizontally oriented arm element may be demountably and adjustably engaged along the vertical arm assembly by a clamp bracket assembly 132, as previously described. The horizontal arm assembly may there be provided with a further embodiment of a device mount plate 2585 demountably engaged with the arm assembly on two concave base components 136 fastened by two screws with two nuts in the arm assembly's nut channel, and on which the bowl/ball mount assembly 2375 and supported camera, device or other equipment may be mounted.

According to further embodiments, the rotating hub dolly 2365 and rotating hub stand 2565 may be additionally configured with threaded-stem casters 375 in place of the first, second, or third lower roller elements subassembly 1440/1747/1748 of the track roller assemblies, or in place of the threaded-stem foot components 385.

### NUMBERING KEY

NUMBERING KEY

| | |
|---|---|
| 3 - cylindrical structural component | 92 - pulley axle holes |
| 5 - nut channel | 95 - binding barrel |
| 8 - nut | 97 - binding barrel screw |
| 10 - screw | 100 - bushing |
| 11 - screw slots | 102 - cable retainer |
| 14 - threaded end connector | 105 - screw |
| 16 - screw | 107 - threaded holes |
| 18 - threaded end connector | 110 - roller carriage bridge component |
| 20 - tube module | 111 - threaded hole |
| 22 - vertical track dolly | 112 - eyebolt |
| 25 - turntable dolly base | 114 - screw |
| 28 - 3-rail vertical track assembly | 115 - threaded hole |
| 30 - device mount assembly | 116 - tube module |
| 32 - vertical rail assembly | 118 - device mount plate |
| 35 - pulley assembly | 119 - bowl/ball mount assembly |
| 38 - three-sided roller carriage | 120 - ball adapter threaded hole |
| assembly | 121 - screw |
| 40 - cable | 122 - bowl mount component |
| 42 - counterweight carriage assembly | 125 - mount plate threaded hole |
| 45 - weight component | 126 - ball adapter |
| 47 - adjustable clamping mechanism | 128 - screw/bolt |
| 50 - mounting plate | 130 - locking handle |
| 52 - screw | 131 - ball-and-socket joint mount |
| 53 - end connector threaded hole | 132 - clamp bracket assembly |
| 55 - through-hole | 134 - nut channel |
| 58 - washer component | 135 - cylindrical structural component |
| 60 - through-holes | 136 - concave base component |
| 65 - corner brace connector | 138 - screw |
| 70 - screw | 140 - bumper component |
| 72 - first through-hole | 142 - eyebolt |
| 73 - second through-hole | 144 - tube module |
| 75 - threaded hole | 146 - screw |
| 80 - corner brace flat insert | 148 - soft threaded end component |
| 85 - pulley bracket | 150 - cylindrical structural component |
| 90 - pulley | |
| 152 - bumper component | 246 - threaded holes |
| 154 - parallel gooseneck connector | 250 - circular recess |
| 156 - channel brace | 255 - rotation tension screw/bolt |
| 158 - set screw | 260 - center through-hole |
| 160 - cylinder external brace | 265 - low-friction rotation disc |
| 162 - threaded knob | 270 - washer |
| 165 - adjustable-level track assembly | 275 - rotation lock-nut |
| 168 - standard curved track assembly | 280 - rotation bushing |
| 170 - cylindrical track roller module | 285 - roller element |
| 175 - brace plate | 290 - screw |
| 177 - screw | 292 - threaded holes |
| 178 - threaded hole | 295 - roller track inlay |
| 180 - cylindrical mount component | 300 - screw |
| 185 - tube modules | 302 - threaded hole |
| 190 - screw | 305 - roller |
| 195 - lockable turntable assembly | 310 - axle screw |
| 197 - rotation plate | 315 - threaded hole |
| 198 - through-hole | 320 - roller mount |
| 200 - turntable extension plate | 325 - non-metallic insert |
| 205 - screw | 330 - threaded locking knob |
| 210 - screw | 335 - threaded stem |
| 211 - screw | 340 - radial threaded holes |
| 213 - through-hole | 355 - horizontal rail assembly |
| 214 - through-hole | 360 - cylindrical structural component |
| 215 - threaded hole | 365 - height-adjustable track end |
| 216 - threaded hole | assembly |
| 220 - washer plate | 370 - vertical post tube module |
| 221 - tube module | 372 - central tube module |
| 222 - through-holes | 375 - long threaded-stem caster |
| 224 - through-holes | 377 - threaded stem |
| 230 - rotational bearing | 380 - cylindrical structural component |
| 232 - bearing screws | 385 - long threaded-stem foot |
| 234 - outer bearing ring | components |
| 236 - threaded holes | 387 - stem lock-nut |
| 240 - bearing retainer | 388 - stem washer |
| 242 - central threaded hole | 390 - cylinder gooseneck end |
| | connector |
| 243 - bearing inner ring | 395 - height-adjustable cross-support |
| 245 - retainer screws | assembly |
| 400 - vertical post tube module | 565 - roller |
| 405 - cylindrical structural component | 570 - axle screw |
| 410 - cylindrical structural component | 575 - threaded hole |
| 415 - perpendicular gooseneck | 580 - vertical track dolly |
| connector | 585 - turntable dolly base |
| 420 - push handle assembly | 590 - square track roller module |
| 425 - tube module | 595 - rectangular rail track assembly |
| 430 - threaded hole | 600 - cylindrical structural component |
| 435 - upper body component | 605 - through-holes |
| 440 - lower body component | 610 - curved square rail component |
| 445 - screw | 615 - square rail roller mount |
| 450 - hole | 616 - roller mount plate |
| 455 - threaded hole | 618 - screw |
| 460 - vibration/noise reduction | 620 - roller |
| gasket | |
| 465 - recess | 625 - vertical shoulder screw |
| 470 - noise reduction inserts | 630 - horizontal shoulder screw |
| 475 - upper pivot shoulder screw | 635 - vertical roller spacer |
| 480 - low-friction upper pivot disc | 640 - height-adjustable dolly |
| 485 - upper bushing | 645 - turntable dolly base |
| 490 - through-hole | 650 - tube module |
| 492 - through-hole | 655 - lockable turntable assembly |
| 495 - threaded hole | 660 - through-hole |
| 500 - lower pivot shoulder screw | 665 - turntable rotation plate |
| 505 - lower bushing | 670 - upper low-friction disc |
| 510 - lower bushing slot | 675 - lower low-friction disc |
| 515 - through-hole | 680 - rotation tension screw/bolt |
| 520 - low-friction lower pivot disc | 682 - upper disc through-hole |
| 525 - lock-nut | 685 - plate central through-hole |
| 530 - recessed through-hole | 688 - lower disc through-hole |
| 535 - screw | 690 - rotation lock-nut |
| 540 - threaded hole | 695 - rotation bushing |
| 545 - roller mount plate | 697 - threaded locking knob |
| 547 - lock-nut hole | 698 - threaded stem |
| 550 - diameter-adjustment roller mount | 699 - threaded holes |
| holes | 700 - vertical adjustment assembly |
| 555 - roller mount | 705 - device mount assembly |
| 560 - screw | 710 - vertical post |
| 713 - cylindrical structural component | 855 - horizontal chassis tube module |
| 715 - mounting plate | 860 - diagonal support tube module |
| 720 - through-holes | 865 - bearing threaded holes |
| 722 - threaded hole | 870 - bearing retainer |
| 725 - through-hole | 875 - retainer threaded hole |
| 730 - turntable extension plate | 880 - retainer screws |
| 735 - through-hole | 885 - rotation tension screw/bolt |
| 740 - threaded hole | 890 - lock-nut |
| 745 - through-hole | 895 - bushing |
| 750 - screw | 900 - plate through-hole |
| 752 - screw | 905 - short tube module |
| 755 - through-hole | 910 - wheel |
| 757 - through-hole | 915 - axle screw/bolt |
| 760 - threaded hole | 920 - narrow corner brace component |
| 762 - threaded hole | 925 - front axle tube module |
| 765 - washer plate | 930 - short chassis tube module |
| 770 - tube module | 935 - handle tube module |
| 775 - through-holes | 940 - foot tube module |
| 780 - adjustable-level tripod stand | 945 - adjustable angled connector |
| 785 - lockable turntable assembly | 950 - cylindrical structural component |
| 790 - tube modules | 955 - threaded-hole toothed plate |
| 795 - threaded stem | 960 - radial teeth |
| 797 - threaded stem lock-nut | 965 - threaded hole |
| 798 - threaded stem washer | 970 - through-hole toothed plate |
| 799 - foot ball-and-socket joint | 975 - through-hole |
| 800 - upper low-friction disc | 980 - screw |
| 805 - lower low-friction disc | 985 - threaded hole |
| 810 - rotation tension screw/bolt | 990 - cylinder side mount component |
| 815 - upper disc through-hole | 995 - screw |
| 820 - lower disc through-hole | 1000 - recessed through-hole |
| 825 - rotation lock-nut | 1005 - recessed through-hole |
| 828 - rotation bushing | 1010 - cylinder end mount component |
| 830 - steerable vertical track dolly | 1015 - screw |
| 835 - lockable turntable assembly | 1020 - recessed through-hole |
| 840 - rotating rear axle assembly | 1025 - recessed through-hole |
| 845 - front axle assembly | 1028 - central through-hole |
| 850 - steering handle/foot assembly | 1030 - rotating jib dolly |
| 1035 - turntable dolly base | 1195 - recessed through-hole |
| 1040 - lockable turntable assembly | 1200 - recessed through-hole |
| 1045 - vertical support structure | 1205 - connector screw |
| 1050 - pivotable jib arm assembly | 1210 - central threaded hole |
| 1055 - self-levelling device mount | 1212 - nut channel opening |
| assembly | 1215 - circular recess |
| 1060 - cylindrical structural component | 1220 - circular recess |
| 1065 - through-hole | 1225 - circular insert |
| 1070 - elongate bushing | 1230 - circular insert |
| 1075 - through-hole | 1235 - spacer |
| 1080 - cylindrical structural component | 1240 - thumb-screw |
| 1085 - cylindrical structural component | 1250 - half-clamp component |
| 1090 - cylindrical structural component | 1255 - screw |
| 1095 - arm module assembly | 1260 - through-hole |
| 1100 - cylindrical structural component | 1265 - threaded hole |
| 1105 - cylindrical structural component | 1270 - threaded knob |
| 1109 - cylindrical structural component | 1275 - central recessed through-hole |
| 1111 - cylindrical structural component | 1280 - screw |
| 1113 - cylindrical structural component | 1282 - cylindrical structural component |
| 1115 - portable device stand | 1285 - angled threaded inserts |
| 1118 - portable table stand | 1290 - cup holder |
| 1122 - base assembly | 1295 - outward screw |
| 1125 - upright support assembly | 1300 - outward screw |
| 1130 - device mount assembly | 1305 - mount screw |
| 1132 - table assembly | 1310 - threaded hole |
| 1135 - arm assembly | 1312 - mount plate |
| 1140 - cylindrical structural component | 1315 - laptop computer bracket |
| 1145 - cylindrical structural component | 1316 - table component |
| 1150 - nut channel | 1320 - screw |
| 1155 - nut channel | 1322 - through-hole |
| 1160 - threaded side mount | 1323 - threaded hole |
| component | |
| 1165 - screw | 1325 - threaded hole |
| 1170 - through-holes | 1400 - vertical track dolly |
| 1175 - threaded-stem caster | 1405 - 3-rail vertical track assembly |
| 1180 - threaded hole | 1410 - turntable dolly base |
| 1185 - internal weight component | 1415 - cylinder-mount track roller |
| | assembly |
| 1190 - cylindrical structural component | |
| 1420 - adjustable-level track assembly | 1585 - screw |
| 1425 - device mount assembly | 1587 - through-hole |
| 1430 - standard track assembly | 1590 - threaded hole |
| 1435 - cylindrical mount component | 1595 - roller |
| 1440 - first lower roller elements | 1600 - axle screw |
| subassembly | 1605 - threaded hole |
| 1445 - threaded hole | 1610 - non-metallic washer |
| 1447 - threaded hole | 1615 - threaded locking knob |
| 1450 - lockable turntable assembly | 1620 - threaded stem |
| 1455 - rotation plate | 1625 - first side-mount track roller |
| 1460 - through-hole | assembly |
| 1465 - tube module | 1630 - second side-mount track roller |
| 1470 - through-hole | assembly |
| 1475 - though-hole | 1635 - third side-mount track roller |
| | assembly |
| 1480 - rotational bearing | 1640 - fourth side-mount track roller |
| 1485 - bearing screws | assembly |
| 1490 - outer bearing ring | 1645 - first double side-mount track |
| 1495 - threaded hole | roller |
| | assembly |
| 1500 - bearing retainer | 1650 - second double side-mount track |
| 1505 - central through-hole | roller assembly |
| 1510 - inner bearing ring | 1655 - tube end-mount track roller |
| 1515 - retainer screws | assembly |
| 1520 - through-hole | 1660 - sliding plate |
| 1525 - threaded hole | 1665 - threaded holes |
| 1530 - circular recess | 1670 - roller mount |
| 1535 - adjustable tension components | 1675 - screw |
| 1540 - tension screw | 1680 - through-hole |
| 1545 - central through-hole | 1685 - roller |
| 1550 - central through-hole | 1690 - axle screw |
| 1555 - circular clasp component | 1695 - threaded hole |
| 1557 - nut | 1700 - pivot screw |
| 1558 - nut recess | 1705 - central mounting hole |
| 1560 - bushing | 1710 - sliding plate slot |
| 1565 - retainer chamfer | 1712 - nut |
| 1570 - clasp rim | 1714 - recess |
| 1575 - rotation plate chamfer | 1715 - upper low-friction mount bushing |
| 1580 - roller element | 1716 - chamfer |
| 1582 - roller mount | 1718 - lower low-friction plate bushing |
| 1720 - pivot screw | 1820 - threaded hole |
| 1722 - pivot screw | 1825 - first flat double side-mount |
| 1724 - pivot screw | component |
| 1726 - pivot screw | 1830 - first concave side-mount |
| | component |
| 1728 - pivot screw | 1835 - concave surface |
| 1730 - pivot screw | 1840 - cylindrical structural component |
| 1732 - pivot screw | 1845 - through-hole |
| 1734 - pivot screw | 1850 - mounting hole |
| 1736 - pivot screw | 1855 - recess |
| 1738 - pivot screw | 1860 - low-friction bushing |
| 1740 - low-friction pivot disc | 1865 - chamfer |
| 1742 - central through-hole | 1870 - low-friction pivot disc |
| 1743 - fifth side-mount track roller | 1875 - central through-hole |
| assembly | |
| 1745 - pipe fitting mount track roller | 1880 - threaded hole |
| assembly | 1882 - square framing component |
| 1747 - second lower roller elements | 1883 - rectangular framing component |
| subassembly | 1885 - flat top surface |
| 1748 - third lower roller elements | 1890 - through-hole |
| subassembly | |
| 1750 - rotating hub dolly base | 1895 - mounting hole |
| 1753 - horizontal rail assembly | 1900 - recess |
| 1755 - cylindrical structural component | 1905 - low-friction bushing |
| 1760 - side-mount plate | 1910 - chamfer |
| 1762 - screw | 1915 - pivot disc |
| 1765 - through-hole | 1920 - central through-hole |
| 1767 - cylindrical structural component | 1925 - flat top surface |
| 1770 - rail-end support assembly | 1930 - through-holes |
| 1775 - threaded mount component | 1935 - mounting hole |
| 1780 - through-hole | 1940 - recess |
| 1785 - screw | 1945 - low-friction bushing |
| 1790 - threaded hole | 1950 - chamfer |
| 1795 - first flat side-mount | 1955 - pivot disc |
| component | 1960 - central through-hole |
| 1800 - rail cross-support assembly | 1965 - flat dual-mount side- |
| 1805 - cylindrical structural component | mount component |
| 1810 - threaded double mount | 1970 - flat top surface |
| component | 1975 - through-hole |
| 1815 - through-holes | 1978 - threaded hole |
| 1980 - mounting hole | 2155 - second flat side-mount |
| 1985 - recess | component |
| 1990 - low-friction bushing | 2160 - flat top surface |
| 1995 - chamfer | 2165 - through-hole |
| 2000 - pivot disc | 2170 - nut |
| 2005 - central through-hole | 2185 - threaded mounting hole |
| 2015 - flat dual-mount double side- | 2190 - low-friction bushing |
| mount component | 2192 - pivot disc |
| 2020 - flat top surface | 2193 - central through-hole |
| 2025 - through-holes | 2195 - sixth side-mount track roller |
| 2030 - threaded hole | assembly |
| 2035 - mounting hole | 2200 - seventh side-mount track roller |
| | assembly |
| 2040 - recess | 2205 - second flat double side-mount |
| 2045 - low-friction bushing | component |
| 2050 - chamfer | 2210 - flat top surface |
| 2055 - pivot disc | 2215 - through-holes |
| 2060 - central through-hole | 2220 - perpendicular roller mount |
| 2065 - second concave side-mount | assembly |
| component | 2222 - two-way roller mount component |
| 2070 - concave surface | 2225 - first perpendicular roller sliding |
| 2075 - screw | plate |
| 2080 - through-holes | 2230 - screw |
| 2085 - mounting hole | 2232 - through-hole |
| 2090 - nut recess | 2235 - threaded holes |
| 2095 - captive nut | 2238 - sliding slot |
| 2100 - low-friction bushing | 2240 - roller |
| 2105 - pivot disc | 2245 - vertical axle screw |
| 2110 - central through-hole | 2247 - threaded hole |
| 2115 - tube-end pivot screw connector | 2250 - horizontal axle screw |
| 2120 - through-holes | 2252 - threaded hole |
| 2122 - nut channel opening | 2255 - roller spacer |
| 2123 - nut channel | 2258 - threaded holes |
| 2125 - central mounting hole | 2260 - second perpendicular roller |
| | sliding |
| 2130 - nut recess | plate |
| 2135 - captive nut | 2265 - sliding slot |
| 2140 - low-friction bushing | 2270 - mounting hole |
| 2145 - pivot disc | 2275 - nut recess |
| 2150 - central through-hole | 2280 - captive nut |
| 2285 - low-friction bushing | 2465 - middle low-friction bushing |
| 2290 - pivot disc | 2470 - second rotating hub assembly |
| 2295 - central through-hole | 2475 - second cylindrical mount |
| 2300 - standard pipe component | component |
| 2305 - pipe fitting mount component | 2480 - threaded mounting hole |
| 2310 - flat bottom surface | 2482 - pivot screw |
| 2315 - circular passage | 2485 - pivot disc |
| 2320 - threaded hole | 2490 - countersunk through-holes |
| 2325 - set screw | 2495 - screws |
| 2330 - raised section | 2498 - threaded holes |
| 2335 - pipe rail element | 2499 - central through-hole |
| 2340 - threaded mounting hole | 2500 - threaded standoff rods |
| 2345 - low-friction bushing | 2505 - male threaded ends |
| 2350 - pivot disc | 2510 - female threaded ends |
| 2355 - central through-hole | 2515 - threaded holes |
| 2360 - threaded hole | 2520 - screws |
| 2365 - rotating hub dolly | 2525 - rod slide brace |
| 2370 - height-adjustable device mount | 2530 - threaded holes |
| rod assembly | 2535 - slidable rod holes |
| 2375 - bowl/ball mount assembly | 2540 - slidable rod slot |
| 2380 - rotating hub assembly | 2545 - set screw |
| 2385 - cylindrical structural assembly | 2550 - threaded hole |
| 2390 - cylindrical structural component | 2555 - first lower middle rod |
| 2395 - through-hole | 2560 - forward gap |
| 2400 - hub mount plate | 2565 - rotating hub stand |
| 2405 - screws | 2570 - height-adjustable device mount |
| 2410 - through-holes | arm assembly |
| 2415 - pivot screw | 2575 - vertical cylindrical structural |
| | assembly |
| 2420 - mounting hole | 2580 - repositionable cylindrical |
| 2425 - nut | structural |
| 2428 - upper recess | assembly |
| 2430 - lower recess | 2585 - device mount plate |
| 2435 - upper low-friction bushing | |
| 2440 - upper chamfer | |
| 2445 - lower low-friction bushing | |
| 2450 - lower chamfer | |
| 2455 - pivot disc | |
| 2460 - central through-hole | |

1. An assembly comprising:
a vertical adjustment assembly comprising:
one or more vertical posts; and
a device mount assembly comprising one or more arms fastened to the one or more vertical posts and for mounting a device to the vertical adjustment assembly; and
a turntable, at least a portion of which is rotatable relative to the vertical adjustment assembly,
and wherein the one or more arms are height-adjustable relative to the ground to allow the device mount assembly to be vertically repositioned.

2. The assembly of claim 1, wherein:
the assembly further comprises a horizontal base extending from a front of the assembly to a rear of the assembly; and
the vertical adjustment assembly is attached to the horizontal base at the front of the assembly.

3. The assembly of claim 2, wherein:
one or more diagonal supporting members extend from proximally the rear of the assembly to proximally a top of the vertical adjustment assembly.

4. The assembly of claim 3, wherein:
the vertical adjustment assembly comprises a pair of vertical posts along which the device mount assembly is vertically adjustable; and
the one or more diagonal supporting members are attached to the pair of vertical posts.

5. The assembly of claim 1, wherein:
the assembly further comprises wheels, including at least one rear wheel, for allowing the assembly to be moved over the ground; and
the turntable is coupled to the at least one rear wheel such that a user of the assembly may rotate the turntable and thereby pivot the at least one rear wheel to steer the assembly.

6. The assembly of claim 1, wherein:
each of the one or more arms is attached to one of the one or more posts using at least one connector; and
the height of each arm relative to the ground is adjustable by unfastening the at least one connector, adjusting the location at which the arm is fastened to the vertical post, and fastening the at least one connector to the vertical post and the arm.

7. The assembly of claim 6, wherein the at least one connector is at least one corner brace connector.

8. The assembly of claim 1, wherein:
the turntable defines a first axis of rotation; and
the device mount assembly comprises a device mount plate for mounting the device at a mounting location on the device mount plate; and
the mounting location is aligned with the first axis of rotation.

9. The assembly of claim 8, wherein:
the vertical adjustment assembly comprises one or more vertical posts along at least one of which the device mount assembly is height-adjustable; and
the one or more vertical posts are offset from a center of the turntable by one or more extension members to align the first axis of rotation with the mounting location.

10. The assembly of claim 1, further comprising:
legs extending from a cylindrical mount component; and
feet connected to ends of the legs,
wherein the turntable is rotatable relative to the legs and connected to the cylindrical mount component by a threaded fastener extending through the turntable and into the cylindrical mount component, and for allowing a user to control the resistance to rotation of the turntable by selectively tightening or loosening the fastener.

11. The assembly of claim 10, wherein the threaded fastener further extends through the cylindrical mount component and a locking nut is engaged with the threaded fastener to lock the turntable.

12. The assembly of claim 10, wherein three or four legs extend from the cylindrical mount component.

13. The assembly of claim 10, wherein the legs are height-adjustable relative to the feet.

14. The assembly of claim 10, wherein the feet are threadably engaged to cylindrical mount portions at ends of the legs.

15. The assembly of claim 14, wherein the legs are height-adjustable relative to the feet by threadably adjusting positions of the feet relative to the cylindrical mount portions.

16. The assembly of claim 10, wherein the feet comprise caster wheels.

17. A roller assembly for moving along a rail, comprising:
an upper mount component;
an upper body component pivotable relative to the upper mount component;
a lower body component fixed to the upper body component; and
a roller element mount plate to which are secured roller elements for allowing the assembly to be moved by rolling the roller elements along the rail, wherein the roller element mount plate is:
pivotable relative to the lower body component; and
translatable along a slot formed in the lower body component.
